(19) United States
(12) Patent Application Publication
(10) Pub. No.: US 2025/0264742 A1
(43) Pub. Date: Aug. 21, 2025

(54) Ring Modulator with Rib Ring Optical Waveguide and Interdigitated PN Junction Diode

(71) Applicant: Ayar Labs, Inc., San Jose, CA (US)

(72) Inventor: Derek Van Orden, Santa Clara, CA (US)

(21) Appl. No.: 19/054,079

(22) Filed: Feb. 14, 2025

Related U.S. Application Data
(60) Provisional application No. 63/554,935, filed on Feb. 16, 2024.

(51) Int. Cl. G02F 1/025

(52) U.S. Cl. CPC G02F 1/025; G02F 2201/063; G02F 2201/124; G02F 2202/06

(57) ABSTRACT

A photonic integrated circuit includes a first ring-shaped optical waveguide optically coupled to both a second optical waveguide and a third optical waveguide within a first optical coupling region and a second optical coupling region, respectively. An inner silicon region is formed along an inner side of the first ring-shaped optical waveguide. Tab-shaped N-type doping regions and tab-shaped P-type doping regions are formed in alternating positions within the first ring-shaped optical waveguide and the inner silicon region within the first optical coupling region to form a first interdigitated PN diode configuration within the first optical coupling region. Tab-shaped N-type doping regions and tab-shaped P-type doping regions are also formed in alternating positions within the first ring-shaped optical waveguide and the inner silicon region within the second optical coupling region to form a second interdigitated PN diode configuration within the second optical coupling region.

### CROSS-REFERENCE TO RELATED APPLICATIONS

This application claims priority under 35 U.S.C. 119 (e) to U.S. Provisional Patent Application No. 63/554,935, filed on Feb. 16, 2024, the disclosure of which is incorporated herein by reference in its entirety for all purposes.

### BACKGROUND OF THE INVENTION

Optical data communication systems operate by modulating laser light to encode digital data patterns within optical signals. The modulated laser light is transmitted through an optical data network from a sending node to a receiving node. The modulated laser light having arrived at the receiving node is de-modulated to obtain the original digital data patterns from the optical signals. The transmission of light through the optical data network includes transmission of light through optical fibers and transmission of light between optical fibers and photonic integrated circuits. In some embodiments, a photodiode is used to detect light of an optical data signal and convert the detected light into a photocurrent that can be processed through electrical circuitry to demodulate the optical data signal to obtain the original digital data pattern from the optical data signal. It is within this context that the present invention arises.

### SUMMARY OF THE INVENTION

In an example embodiment, a photonic integrated circuit is disclosed. The photonic integrated circuit includes a first optical waveguide that has a ring shape. The first optical waveguide is formed of silicon and has a first vertical height. The photonic integrated circuit also includes an inner silicon region formed circumferentially along an inner side of the first optical waveguide. The inner silicon region has a second vertical height that is less than the first vertical height. The photonic integrated circuit also includes a second optical waveguide that is configured to semi-tangentially approach an outer side of the first optical waveguide and extend past the first optical waveguide at a first location, such that a first optical coupling region exists between a portion of the second optical waveguide and a first portion of the first optical waveguide about the first location. The photonic integrated circuit also includes a third optical waveguide that is configured to semi-tangentially approach the outer side of the first optical waveguide and extend past the first optical waveguide at a second location that is diametrically opposed to the first location with regard to the ring shape of the first optical waveguide, such that a second optical coupling region exists between a portion of the third optical waveguide and a second portion of the first optical waveguide about the second location. The photonic integrated circuit also includes an N-type doping region formed within the first optical waveguide and the inner silicon region. The N-type doping region includes a first set of multiple tab-shaped N-type doping regions formed within the first optical coupling region. The N-type doping region includes a second set of multiple tab-shaped N-type doping regions formed within the second optical coupling region. Each of the tab-shaped N-type doping regions in the first and second sets of multiple tab-shaped N-type doping regions is formed to project inward toward a center of the ring shape of the first optical waveguide. The photonic integrated circuit also includes a P-type doping region formed within the first optical waveguide and the inner silicon region. The P-type doping region includes a first set of multiple tab-shaped P-type doping regions formed within the first optical coupling region. The P-type doping region includes a second set of multiple tab-shaped P-type doping regions formed within the second optical coupling region. Each of the tab-shaped P-type doping regions in the first and second sets of multiple tab-shaped P-type doping regions is formed to project inward toward the center of the ring shape of the first optical waveguide. Positions of the first set of multiple tab-shaped N-type doping regions alternate with positions of the first set of multiple tab-shaped P-type doping regions along the first portion of the first optical waveguide, such that the first set of multiple tab-shaped N-type doping regions and the first set of multiple tab-shaped P-type doping regions collectively form a first interdigitated PN diode configuration within the first optical waveguide within the first optical coupling region. Positions of the second set of multiple tab-shaped N-type doping regions alternate with positions of the second set of multiple tab-shaped P-type doping regions along the second portion of the first optical waveguide, such that the second set of multiple tab-shaped N-type doping regions and the second set of multiple tab-shaped P-type doping regions collectively form a second interdigitated PN diode configuration within the first optical waveguide within the second optical coupling region.

In an example embodiment, a photonic integrated circuit is disclosed. The photonic integrated circuit includes a first optical waveguide that has a ring shape. The first optical waveguide is formed of silicon and has a first vertical height. The photonic integrated circuit also includes an inner silicon region formed circumferentially along an inner side of the first optical waveguide. The inner silicon region has a second vertical height that is less than the first vertical height. The photonic integrated circuit also includes a second optical waveguide that is configured to semi-tangentially approach an outer side of the first optical waveguide and extend past the first optical waveguide, such that an optical coupling region exists between a portion of the second optical waveguide and a portion of the first optical waveguide. The photonic integrated circuit also includes an N-type doping region formed within the first optical waveguide and the inner silicon region. The N-type doping region includes multiple tab-shaped N-type doping regions formed within the optical coupling region. Each of the multiple tab-shaped N-type doping regions is formed to project inward toward a center of the ring shape of the first optical waveguide. The photonic integrated circuit also includes a P-type doping region formed within the first optical waveguide and the inner silicon region. The P-type doping region includes multiple tab-shaped P-type doping regions formed within the optical coupling region. Each of the multiple tab-shaped P-type doping regions is formed to project inward toward the center of the ring shape of the first optical waveguide. Positions of the multiple tab-shaped N-type doping regions alternate with positions of the multiple tab-shaped P-type doping regions along the portion of the first optical waveguide within the optical coupling region, such that the multiple tab-shaped N-type doping regions and the multiple tab-shaped P-type doping regions collectively form an interdigitated PN diode configuration within the first optical waveguide within the optical coupling region.

In an example embodiment, a photonic integrated circuit is disclosed. The photonic integrated circuit includes a first optical waveguide that has a ring shape. The first optical waveguide is formed of silicon and has a first vertical height. The photonic integrated circuit also includes an inner silicon region formed circumferentially along an inner side of the first optical waveguide. The inner silicon region has a second vertical height that is less than the first vertical height. The photonic integrated circuit also includes a second optical waveguide that is configured to semi-tangentially approach an outer side of the first optical waveguide and extend past the first optical waveguide at a first location, such that a first optical coupling region exists between a portion of the second optical waveguide and a first portion of the first optical waveguide about the first location. The photonic integrated circuit also includes a third optical waveguide that is configured to semi-tangentially approach the outer side of the first optical waveguide and extend past the first optical waveguide at a second location that is diametrically opposed to the first location with regard to the ring shape of the first optical waveguide, such that a second optical coupling region exists between a portion of the third optical waveguide and a second portion of the first optical waveguide about the second location. The photonic integrated circuit also includes an N-type doping region formed within the first optical waveguide and the inner silicon region. The N-type doping region includes multiple tab-shaped N-type doping regions formed within the first optical waveguide and the inner silicon region. The multiple tab-shaped N-type doping regions are positioned in a spaced apart manner along a full circumferential path of the ring shape of the first optical waveguide. Each of the multiple tab-shaped N-type doping regions is formed to project inward toward a center of the ring shape of the first optical waveguide. The photonic integrated circuit also includes a P-type doping region formed within the first optical waveguide and the inner silicon region. The P-type doping region includes multiple tab-shaped P-type doping regions formed within the first optical waveguide and the inner silicon region. Each of the multiple tab-shaped P-type doping regions is positioned between a different pair of the multiple tab-shaped N-type doping regions along the full circumferential path of the ring shape of the first optical waveguide. Each of the multiple tab-shaped P-type doping regions is formed to project inward toward the center of the ring shape of the first optical waveguide. The multiple tab-shaped N-type doping regions and the multiple tab-shaped P-type doping regions collectively form an interdigitated PN diode configuration within the first optical waveguide along the full circumferential path of the ring shape of the first optical waveguide. A first portion of the interdigitated PN diode configuration is positioned within the first optical coupling region. A second portion of the interdigitated PN diode configuration is positioned within the second optical coupling region. A third portion of the interdigitated PN diode configuration is positioned between the first optical coupling region and the second optical coupling region on a first side of the center of the ring shape of the first optical waveguide. A fourth portion of the interdigitated PN diode configuration is positioned between the first optical coupling region and the second optical coupling region on a second side of the center of the ring shape of the first optical waveguide.

### BRIEF DESCRIPTION OF THE DRAWINGS

FIG. 1A shows a top view of an example ring modulator that implements a rib ring, in accordance with some embodiments.

FIG. 1B shows a vertical cross-section through the rib ring and the optical waveguide at a location of their closest approach to each other, referenced as View A-A in FIG. 1A, in accordance with some embodiments.

FIG. 1C shows a vertical cross-section through the rib ring and the full-height (full-thickness) silicon regions, referenced as View B-B in FIG. 1A, in accordance with some embodiments.

FIG. 1D shows a top view of a configuration of full-height (full-thickness) silicon formed within the cladding material, in accordance with some embodiments.

FIG. 1E shows a top view of the configuration of full-height (full-thickness) silicon with portions of the full-height (full-thickness) silicon etched away to form the partial-height (partial-thickness) silicon regions, in accordance with some embodiments.

FIG. 1F shows a top view of the partially formed ring modulator of FIG. 1E with formation of the inner electrical contacts and the outer electrical contacts, in accordance with some embodiments.

FIG. 1G shows a top view of the partially formed ring modulator of FIG. 1F with the N-type doping region formed, in accordance with some embodiments.

FIG. 2A shows the top view of the partially formed ring modulator of FIG. 1F with annotations for computation of the optical coupling length of the rib ring along which the lateral PN junction diode is excluded, in accordance with some embodiments.

FIG. 2B shows a top view of a partially formed ring modulator that has a second optical waveguide and a second optical coupling region, in accordance with some embodiments.

FIG. 3A shows a top view of a ring modulator that implements an interdigitated diode configuration within an optical coupling region between an optical waveguide and a rib ring of the ring modulator in order to optimize modulation efficiency while minimizing optical loss in the optical waveguide, in accordance with some embodiments.

FIG. 3B shows a vertical cross-section through the rib ring and the optical waveguide at a location of their closest approach to each other, referenced as View A-A in FIG. 3A, in accordance with some embodiments.

FIG. 3C shows a vertical cross-section through the rib ring and the full-height (full-thickness) silicon regions, referenced as View B-B in FIG. 3A, in accordance with some embodiments.

FIG. 3D shows a top view of a configuration of full-height (full-thickness) silicon formed within the cladding material, in accordance with some embodiments.

FIG. 3E shows a top view of the configuration of full-height (full-thickness) silicon of FIG. 3D with portions of the full-height (full-thickness) silicon etched away to form the partial-height (partial-thickness) silicon regions, in accordance with some embodiments.

FIG. 3F shows a top view of the partially formed ring modulator of FIG. 3E with formation of the inner electrical contacts, the inner electrical contacts, and the outer electrical contacts, in accordance with some embodiments.

FIG. 3G shows a top view of the partially formed ring modulator of FIG. 3F with formation of the N-type doping region and the tab-shaped N-type doping regions, in accordance with some embodiments.

FIG. 3H shows an isolated top view of the N-type doping region and the tab-shaped N-type doping regions, in accordance with some embodiments.

FIG. 3I shows an isolated top view of the P-type doping region and the tab-shaped P-type doping regions, in accordance with some embodiments.

FIG. 3J shows an isolated top view of the P-type doping region and the tab-shaped P-type doping regions positioned in relation with the N-type doping region and the tab-shaped N-type doping regions, in accordance with some embodiments.

FIG. 4A shows a top view of a ring modulator that implements a first interdigitated diode configuration within a first optical coupling region and that implements a second interdigitated diode configuration within a second optical coupling region, in accordance with some embodiments.

FIG. 4B shows a top view of a configuration of full-height (full-thickness) silicon formed within the cladding material, in accordance with some embodiments.

FIG. 4C shows a top view of the configuration of full-height (full-thickness) silicon with portions of the full-height (full-thickness) silicon etched away to form the partial-height (partial-thickness) silicon regions, in accordance with some embodiments.

FIG. 4D shows a top view of the partially formed ring modulator of FIG. 4C with formation of the inner electrical contacts, the inner electrical contacts, the inner electrical contacts, and the outer electrical contacts, in accordance with some embodiments.

FIG. 4E shows a top view of the partially formed ring modulator of FIG. 4D with formation of the N-type doping regions and the tab-shaped N-type doping regions, in accordance with some embodiments.

FIG. 4F shows an isolated top view of the N-type doping regions and the tab-shaped N-type doping regions, in accordance with some embodiments.

FIG. 4G shows an isolated top view of the P-type doping regions and the tab-shaped P-type doping regions, in accordance with some embodiments.

FIG. 4H shows an isolated top view of the P-type doping regions and the tab-shaped P-type doping regions positioned in relation with the N-type doping regions and the tab-shaped N-type doping regions, in accordance with some embodiments.

FIG. 4I shows a top view of the ring modulator with the N-type doping regions and the tab-shaped N-type doping regions electrically connected to a first electrical node by way of an electrical conductor, in accordance with some embodiments.

FIG. 4J shows a top view of the ring modulator of FIG. 4I with the P-type doping regions and the tab-shaped P-type doping regions electrically connected to a second electrical node by way of an electrical conductor, in accordance with some embodiments.

FIG. 5A shows a top view of a ring modulator that implements a circuitous interdigitated diode configuration that extends through both a first optical coupling region and a second optical coupling region, in accordance with some embodiments.

FIG. 5B shows a top view of a configuration of full-height (full-thickness) silicon formed within the cladding material, in accordance with some embodiments.

FIG. 5C shows a top view of the configuration of full-height (full-thickness) silicon with portions of the full-height (full-thickness) silicon etched away to form the partial-height (partial-thickness) silicon regions, in accordance with some embodiments.

FIG. 5D shows a top view of the partially formed ring modulator of FIG. 5C having the N-type doping region and the P-type doping region formed thereon, in accordance with some embodiments.

FIG. 5E shows an isolated top view of the N-type doping regions, in accordance with some embodiments.

FIG. 5F shows an isolated top view of the P-type doping region, including the P-type doped outer rim region and multiple P-type doped spoke regions, in accordance with some embodiments.

FIG. 5G shows an isolated view of the N-type doping regions and the P-type doping region positioned relative to each other as in the ring modulator, in accordance with some embodiments.

FIG. 5H shows the top view of the ring modulator of FIG. 5D with the N-type doping regions electrically connected to a first electrical node by way of an electrical conductor, in accordance with some embodiments.

### DETAILED DESCRIPTION

In the following description, numerous specific details are set forth in order to provide an understanding of the embodiments disclosed herein. It will be apparent, however, to one skilled in the art that the embodiments disclosed herein may be practiced without some or all of these specific details. In other instances, well known process operations have not been described in detail in order not to unnecessarily obscure the disclosed embodiments.

The embodiments disclosed herein relate to optical data communication. Optical data communication systems operate by modulating laser light to encode digital data patterns within optical signals. In some embodiments, a ring modulator is used to modulate continuous wave laser light to generate the modulated laser light that conveys the encoding of digital data patterns. In some embodiments, the ring modulator is positioned within an evanescent optically coupling distance from a bus optical waveguide and operates to modulate light that is propagating through the bus optical waveguide. The modulated laser light is transmitted through an optical data network from a sending node to a receiving node. The modulated laser light having arrived at the receiving node is de-modulated to obtain the original digital data patterns from the optical signals. The transmission of light through the optical data network includes transmission of light through optical fibers and transmission of light between optical fibers and photonic integrated circuits. In some embodiments, a photodiode is used to detect light of an optical data signal and convert the detected light into a photocurrent that can be processed through electrical circuitry to demodulate the optical data signal to obtain the original digital data pattern from the optical data signal.

Optical cavities are used in a variety of applications in optical data communication systems, such as in lasers, optical modulators, optical splitters, optical routers, optical switches, and optical detectors, among other applications. In various applications and configurations, optical cavities may show strong wavelength selectivity. For this reason, optical cavities are useful in systems that rely on multiple optical signals transmitting information at different wavelengths. In some embodiments, optical cavities are configured as ring resonators and/or disk resonators to enable applications in which light that is coupled from an input optical waveguide into the optical cavity of the ring/disk resonator is either efficiently routed to a separate output optical waveguide, or absorbed within the optical cavity of the ring/disk resonator at specific wavelengths. Also, optical cavities, such as ring/disk resonators, are useful in sensing applications, such as in biological or chemical sensing applications in which a high concentration of optical power is needed in a small area.

The term “waveguide” as used herein refers to an optical waveguide structure through which light is guided. The term “ring resonator” as used herein refers to a circuitous (ring) shaped optical waveguide structure through which light is guided. The term “ring modulator” as used herein refers to a circuitous (ring) shaped optical waveguide structure through which light is guided and within which a light signal is modulated, such as to encode digital data within the modulated light signal. The term “bus waveguide” as used herein refers to an optical waveguide structure through which light is guided that is positioned next to (within an evanescent optical coupling distance of) another waveguide, such as a ring resonator or ring modulator. In some embodiments, the bus waveguide is configured to convey input light to a ring resonator/modulator and convey transmitted/modulated light away from the ring resonator/modulator. The term “drop waveguide” as used herein refers to an optical waveguide structure through which light is guided that is positioned next to (within an evanescent optical coupling distance of) another waveguide, such as a ring resonator or ring modulator. In some embodiments, the drop waveguide is configured to convey transmitted/modulated light away from a ring resonator/modulator.

Since the bandgap energy of silicon is larger than that of photons at telecom frequencies, optical (light) absorption loss within a silicon waveguide is typically negligible. However, the energy of two telecom/datacom-band photons does exceed the bandgap energy of silicon. When the energy of two photons within the silicon waveguide exceeds the bandgap energy of silicon, two-photon absorption (TPA) can occur within the silicon waveguide, thus incurring corresponding optical loss within the silicon waveguide. The likelihood of two photons being absorbed in the silicon waveguide increases quadratically with the intensity of light propagating though the silicon waveguide. Therefore, TPA in the silicon waveguide is a second order optical absorption effect that becomes more pronounced at higher optical power.

While TPA introduces an additional optical loss term, the absorption of the photons in TPA also frees charge carriers (electrons and holes) by promoting them from bound states in the valence band to the conduction band, which produces a carrier plasma that leads to further optical losses that are linear in optical intensity for a fixed plasma density. Because a substantial free-carrier density is produced by TPA, increased free-carrier density generation within the silicon waveguide can be an even more significant contributor to linear optical loss within the silicon waveguide at higher optical powers. The free-carriers (electrons and holes) generated within the silicon waveguide produce high free-carrier absorption (FCA) optical losses. The FCA optical loss is linear with the optical intensity for a given carrier density, with the free-carriers in turn being created by a second-order process, thus being a third-order effect. The optical absorption loss (dI/dz) in the silicon waveguide due to TPA and free-carrier optical absorption is represented in Equation 1, where (I) is the light intensity, (z) is the light propagation distance along the silicon waveguide, (α′) is the linear optical loss coefficient due to free-carriers within the silicon waveguide, (τ) is the free-carrier lifetime within the silicon waveguide, and (β′) is the TPA absorption coefficient.

$$( dI / dz ) = - {α}^{′} \cdot τ \cdot {β}^{′} {I}^{3} . \qquad Equation 1$$

With regard to Equation 1, in order to reduce the third-order optical losses, the coefficient (α′·τ·β′) in front of the cubic term of intensity (I3) needs to be minimized. One way to do this is to reduce the free-carrier lifetime (τ). The free-carrier lifetime (τ) is determined by free-carrier diffusion and the free-carrier recombination rate. There is also a modified free-carrier recombination rate near waveguide boundaries, depending on the surface quality (roughness) and chemistry, which affects the free-carrier lifetime (τ), and is described by a surface recombination velocity coefficient. The free-carrier lifetime (τ) within the silicon waveguide is a key parameter, which can be reduced in various ways. For example, in some embodiments, the silicon waveguide fabrication is adjusted to increase the free-carrier recombination rate in silicon and/or at waveguide interfaces so as to correspondingly reduce the free-carrier lifetime (τ) within the silicon waveguide. In some embodiments, free-carriers are removed from the silicon waveguide by applying an electric field in the region of the silicon waveguide in which the free-carriers are generated. More specifically, an electric field is formed across a core region of the silicon waveguide. This electric field pulls the charged free-carriers (electrons and holes) away from the core region of the silicon waveguide through which the primary optical mode propagates, so that the probability of charged free-carriers causing optical absorption loss within the core region is substantially reduced. This process is known as carrier sweep out and can significantly reduce optical losses that scale with free-carrier concentration, such as the third-order optical absorption losses discussed above with regard to Equation 1. In some embodiments, in order to generate the electric field across the core region of the silicon waveguide for free-carrier sweep out, diodes (such as PN diode configurations) are formed across/along the silicon waveguide and are operated in reverse bias mode.

It should be understood and appreciated that non-linear optical losses due to TPA and free-carrier absorption are relevant in many types and/or configurations of optical waveguides, including, but not limited to, bus waveguides, drop waveguides, ring resonators, ring modulators, and microring resonators/modulators (such as annular-shaped, disk-shaped, racetrack-shaped, and other similar circuitously shaped resonators/modulators), which are collectively referred to as traveling-wave resonators (TWRs). Also, it should be understood and appreciated that non-linear optical losses are relevant in many types and/or configurations of photonic crystals and other standing wave resonators (SWRs).

As discussed above, at high optical power, TPA within the silicon waveguide becomes more likely, which increases the probability of free-carrier generation within the silicon waveguide. The resulting free-carrier absorption within the silicon waveguide leads to high optical losses within the silicon waveguide. In many applications that require optical coupling from a bus waveguide to a ring resonator or other (e.g., output) waveguide, the optical power in the bus waveguide may be high enough that TPA is a serious problem. In optical data communication systems, a bus waveguide may carry many wavelengths of light, corresponding to different communication channels. The combination of these multiple wavelengths of light corresponds to a high optical power density within the bus waveguide. Therefore, it is of interest to improve optical data communication systems to mitigate the adverse optical losses caused by TPA and free-carrier absorption within silicon waveguides of various photonic components.

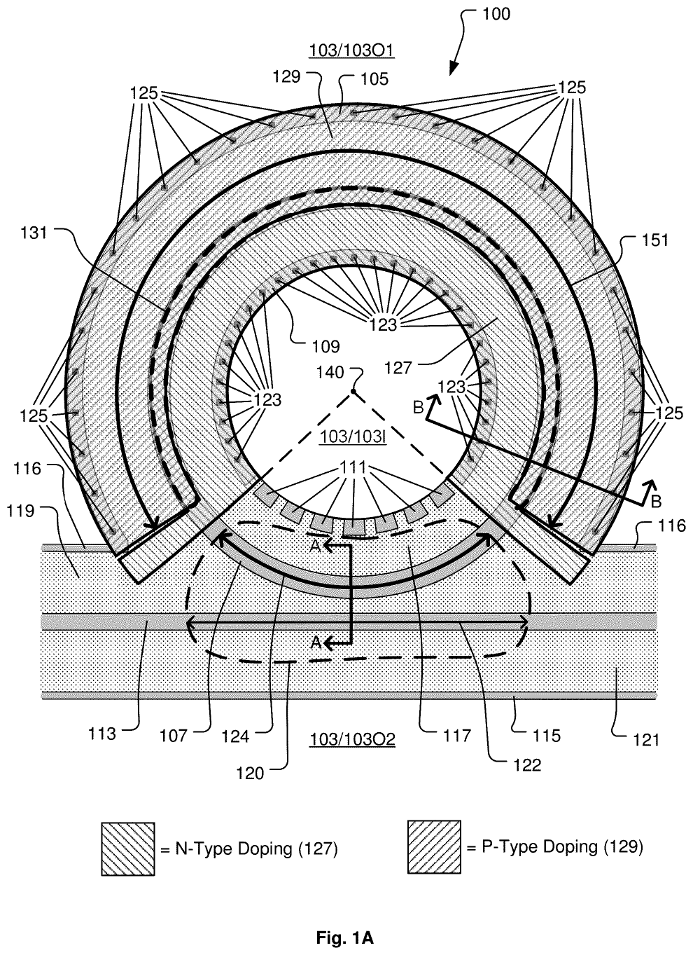

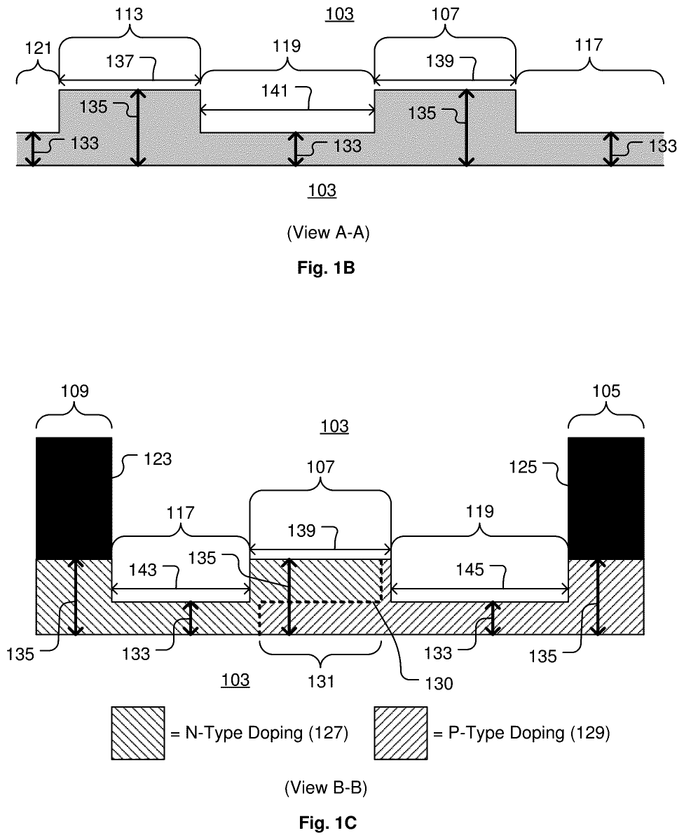

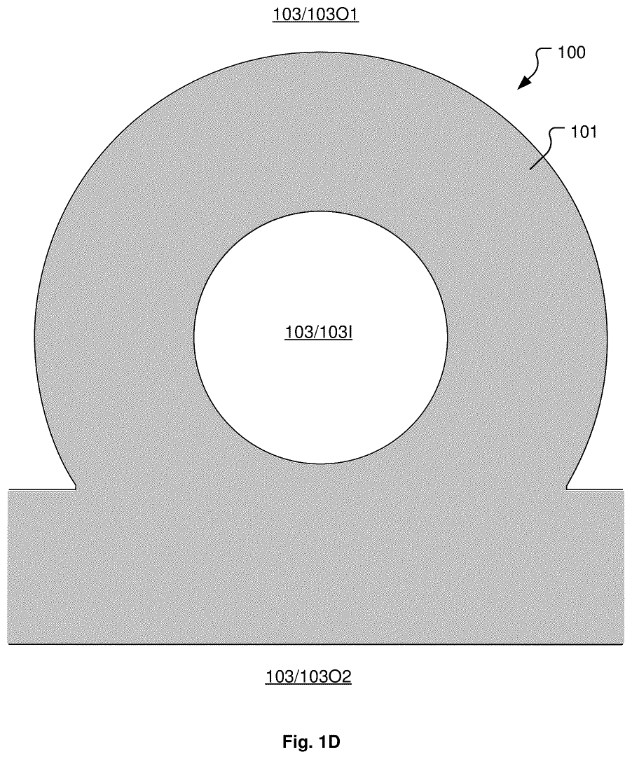

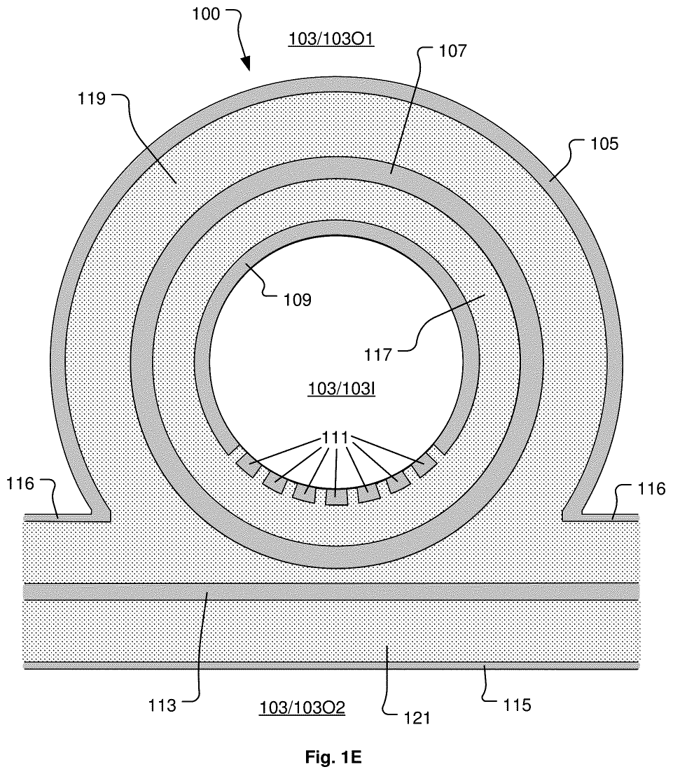

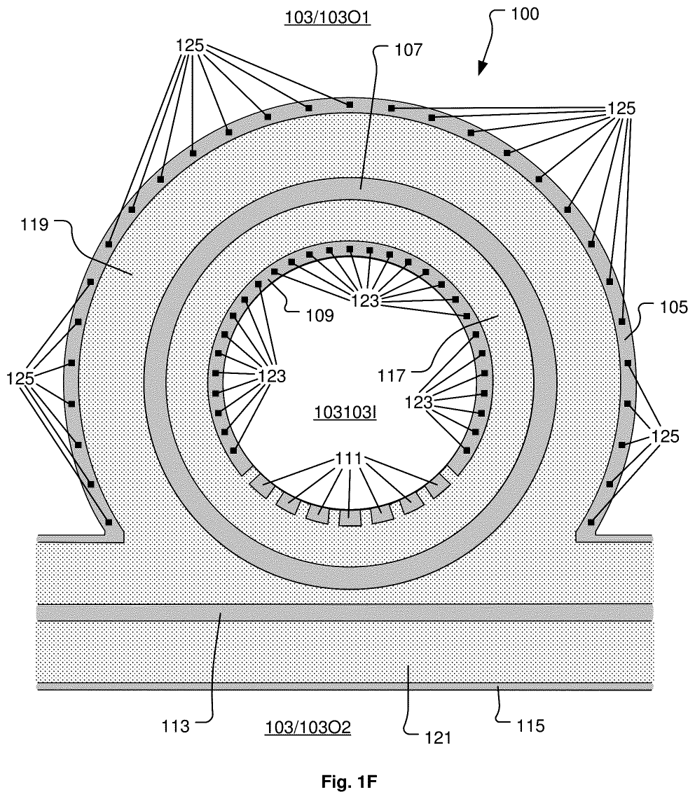

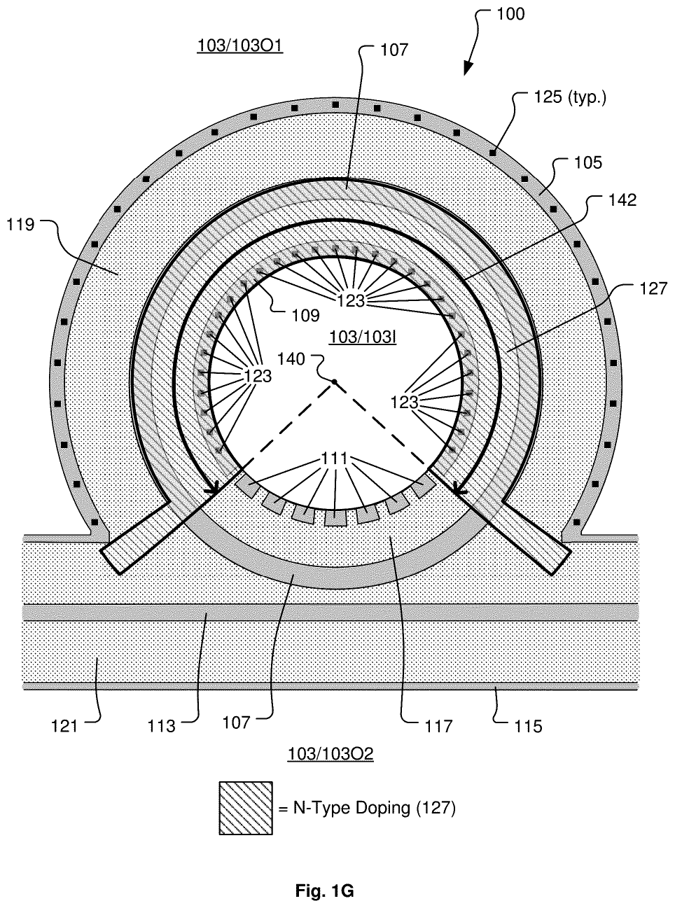

FIG. 1A shows a top view of an example ring modulator 100 that implements a rib ring 107, in accordance with some embodiments. The ring modulator 100 is positioned so that the rib ring 107 is located within an evanescent optical coupling distance from an optical waveguide 113, e.g., a bus optical waveguide. The rib ring 107 and the optical waveguide 113 are formed as respective full-height (full-thickness) silicon regions. The rib ring 107 and the optical waveguide 113 are surrounded by partial-height (partial-thickness) silicon regions 117, 119, and 121. The partial-height silicon region 117 extends around an inside wall of the rib ring 107. The partial-height silicon region 119 extends around an outside wall of the rib ring 107. The partial-height silicon region 119 also extends between the rib ring 107 and the optical waveguide 113. The partial-height silicon region 119 also extends along a first wall of the optical waveguide 113 that faces toward the ring modulator 100. The partial-height silicon region 121 extends along a second wall of the optical waveguide 113 that is on an opposite side of the optical waveguide 113 from the first wall of the optical waveguide 113.

A full-height (full-thickness) silicon region 105 extends along an outer radial periphery of the portion of the partial-height silicon region 119 that extends radially around the rib ring 107. A full-height (full-thickness) silicon region 116 extends along the partial-height silicon region 119 on a side of the partial-height silicon region 119 that is located away from the optical waveguide 113. A full-height (full-thickness) silicon region 115 extends along the partial-height silicon region 121 on a side of the partial-height silicon region 121 that is located away from the optical waveguide 113. Full-height (full-thickness) silicon regions 109 and 111 are formed along an inner side of the partial-height silicon region 117 that is located away from the rib ring 107.

The ring modulator 100 is formed within an optical cladding material 103 that includes an inner optical cladding material 1031, a first outer optical cladding material 10301, and a second outer optical cladding material 10302. More specifically, in some embodiments, the inner optical cladding material 1031 is circumscribed by a combination of the full-height (full-thickness) silicon regions 109 and 111 and the partial-height silicon region 117. Also, the ring modulator 100 is circumscribed by the first outer optical cladding material 10301. Also, the second outer optical cladding material 10302 is present along a side of the full-height (full-thickness) silicon region 115 that is located away from the ring modulator 100.

A number of inner electrical contacts 123 (shown as black dots) are formed in electrical connection with the full-height (full-thickness) silicon region 109 along the inner side of the partial-height silicon region 117 that is located away from the rib ring 107. Also, a number outer electrical contacts 125 (shown as black dots) are formed in electrical connection with the full-height (full-thickness) silicon region 105 that extends along the outer radial periphery of the portion of the partial-height silicon region 119 that extends radially around the rib ring 107.

The ring modulator 100 has an N-type doping region 127 that includes a portion of the rib ring 107, a portion of the partial-height silicon region 117, the full-height (full-thickness) silicon region 109, and two narrow end strips of the partial-height silicon region 119. The ring modulator 100 also has a P-type doping region 129 that includes a portion of the rib ring 107, a portion of the partial-height silicon region 119 that extends radially around the rib ring 107, and the full-height (full-thickness) silicon region 105. The N-type doping region 127 and the P-type doping region 129 interface with each other within the rib ring 107 to form a PN junction diode within the rib ring 107.

FIG. 1B shows a vertical cross-section through the rib ring 107 and the optical waveguide 113 at a location of their closest approach to each other, referenced as View A-A in FIG. 1A, in accordance with some embodiments. The rib ring 107 and the optical waveguide 113 have a thickness 135, which corresponds to a full-thickness of silicon. Each of the partial-height (partial-thickness) silicon regions 117, 119, and 121 have a thickness 133, which is less than the thickness 135. The optical waveguide 113 has a width 137. The rib ring 107 has a radial width 139. The optical waveguide 113 approaches the rib ring 107 such that a minimum (non-zero) separation distance 141 exists between the optical waveguide 113 and the rib ring 107. An optical coupling region 120 (indicated by dashed line in FIG. 1A) exists in which the optical waveguide 113 is located within an evanescent optical coupling distance of the rib ring 107. Because the optical waveguide 113 semi-tangentially approaches the rib ring 107 (without contacting the rib ring 107), the optical coupling region 120 exists along an optical coupling length 122 of the optical waveguide 113 and along an optical coupling length 124 of the rib ring 107, as shown in FIG. 1A.

FIG. 1C shows a vertical cross-section through the rib ring 107 and the full-height (full-thickness) silicon regions 109 and 105, referenced as View B-B in FIG. 1A, in accordance with some embodiments. Each of the rib ring 107, the inner silicon region 109, and the outer silicon region 105 has the thickness 135, which corresponds to the full-thickness of silicon. The rib ring 107 is separated from the inner silicon region 109 by a radial distance 143 over which the partial-height (partial-thickness) silicon region 117 is formed to have the thickness 133. The rib ring 107 is separated from the outer silicon region 105 by a radial distance 145 over which the partial-height (partial-thickness) silicon region 119 is formed to have the thickness 133. The rib ring 107 has the radial width 139, which is substantially consistent around the circumference of the rib ring 107. The vertical cross-section of FIG. 1C also extends through one of the inner electrical contacts 123 positioned in electrical connection with the inner silicon region 109. The vertical cross-section of FIG. 1C also extends through one of the outer electrical contacts 125 positioned in electrical connection with the outer silicon region 105. FIG. 1C shows an interface 130 (dashed line) between the N-type doping region 127 and the P-type doping region 129 within the rib ring 107 to form the PN junction diode along the interface 130. In some embodiments, the N-type doping region 127 overlaps the P-type doping region 129 within the rib ring 107 over an area 131. Alternatively, in some embodiments, the P-type doping region 129 overlaps the N-type doping region 127 within the rib ring 107 over the area 131. It should be understood that the area 131 of overlap between the N-type doping region 127 and the P-type doping region 129 extends azimuthally about a center 140 of the ring modulator 100 and around a portion of the rib ring 107 where the P-type doping region 129 is formed, as shown in FIG. 1A.

FIGS. 1D through 1G show a succession of fabrication processes performed to arrive at the example ring modulator 100 of FIGS. 1A through IC, in accordance with some embodiments. FIG. 1D shows a top view of a configuration of full-height (full-thickness) silicon 101 formed within the cladding material 103, in accordance with some embodiments. The configuration of full-height (full-thickness) silicon 101 has the thickness 135 as shown in FIGS. 1B and 1C. A portion of the configuration of full-height (full-thickness) silicon 101 is used to form the ring modulator 100. Another portion of the configuration of full-height (full-thickness) silicon 101 is used to form part of the optical waveguide 113 that extends past the ring modulator 100.

FIG. 1E shows a top view of the configuration of full-height (full-thickness) silicon 101 with portions of the full-height (full-thickness) silicon 101 etched away to form the partial-height (partial-thickness) silicon regions 117, 119, and 121, in accordance with some embodiments. The partial-height (partial-thickness) silicon regions 117, 119, and 121 have the thickness 133, as shown in FIGS. 1B and 1C, which is less than the thickness 135. The partial-height (partial-thickness) silicon regions 117, 119, and 121 are configured and positioned such that a first remaining portion of the full-height (full-thickness) silicon 101 forms the rib ring 107, and such that a second remaining portion of the full-height (full-thickness) silicon 101 forms the outer silicon region 105, and such that a third remaining portion of the full-height (full-thickness) silicon 101 forms the inner silicon regions 109 and 111, and such that a fourth remaining portion of the full-height (full-thickness) silicon 101 forms the optical waveguide 113, and such that a fifth remaining portion of the full-height (full-thickness) silicon 101 forms the full-height (full-thickness) silicon region 116, and such that a sixth remaining portion of the full-height (full-thickness) silicon 101 forms the full-height (full-thickness) silicon region 115.

FIG. 1F shows a top view of the partially formed ring modulator 100 of FIG. 1E with formation of the inner electrical contacts 123 and the outer electrical contacts 125, in accordance with some embodiments. The inner electrical contacts 123 are formed in electrical connection with the inner full-height (full-thickness) silicon region 109. The outer electrical contacts 125 are formed in electrical connection with the outer full-height (full-thickness) silicon region 105. In some embodiments, the inner electrical contacts 123 are substantially uniformly azimuthally spaced along the inner full-height (full-thickness) silicon region 109. In some embodiments, the outer electrical contacts 125 are substantially uniformly azimuthally spaced along the outer full-height (full-thickness) silicon region 105.

FIG. 1G shows a top view of the partially formed ring modulator 100 of FIG. 1F with the N-type doping region 127 formed, in accordance with some embodiments. The N-type doping region 127 is formed within the silicon of the inner full-height (full-thickness) silicon region 109, and within the partial-height (partial-thickness) silicon region 117 that extends along the inner full-height (full-thickness) silicon region 109, and within a portion of the rib ring 107 that extends along a same azimuthal angular span 142 as the inner full-height (full-thickness) silicon region 109 about the center 140 of the ring modulator 100. The azimuthal angular span 142 is defined such that the N-type doping region 127 is not formed over the inner full-height (full-thickness) silicon regions 111. The N-type doping region 127 electrically interfaces with the inner electrical contacts 123.

FIG. 1A shows the top view of the ring modulator 100 of FIG. 1G with the P-type doping region 129 formed, in accordance with some embodiments. The P-type doping region 129 is formed within the silicon of the outer full-height (full-thickness) silicon region 105, and within the partial-height (partial-thickness) silicon region 119 that extends along the outer full-height (full-thickness) silicon region 105, and within a portion of the rib ring 107 that extends along a same azimuthal angular span 151 as the outer full-height (full-thickness) silicon region 105 about the center 140 of the ring modulator 100. The P-type doping region 129 electrically interfaces with the outer electrical contacts 125.

The rib ring 107 is formed as a rib optical waveguide that loops back into itself. A portion of the rib ring 107 extends through the optical coupling region 120 in which there is no doping region formed. Each of the P-type doping region 129 and the N-type doping region 127 is doped with impurity ions to form a lateral PN junction diode. More specifically, the P-type doping region 129 forms the laterally outer portion of the lateral PN junction diode that is doped with acceptor impurity atoms. Conversely, the N-type doping region 127 forms the laterally inner portion of the lateral PN junction diode that is doped with donor impurity atoms. In this manner, the N-type doping region 127 and the P-type doping region 129 are doped with opposite polarity. The interface between the N-type doping region 127 and the P-type doping region 129 within the rib ring 107 is the PN junction of the lateral PN junction diode. At the PN junction within the rib ring 107, the free electrons diffuse into the P-type doping region 129 and the holes (electron vacancies) diffuse into the N-type doping region 127, which causes a depletion region to form along the PN junction within the rib ring 107. The portion of the N-type doping region 127 formed within the partial-height (partial-thickness) silicon region 117 provides an electrically conductive path between the inner electrical contacts 123 and the depletion region formed along the PN junction within the rib ring 107. Also, the portion of the P-type doping region 129 formed within the partial-height (partial-thickness) silicon region 119 provides an electrically conductive path between the outer electrical contacts 125 and the depletion region formed along the PN junction within the rib ring 107.

The outer electrical contacts 125 are electrically connected to the P-type doping region 129. The inner electrical contacts 123 are electrically connected to the N-type doping region 127. Therefore, with the lateral PN junction diode electrically connected in a reverse-biased manner to an electrical voltage source, the inner electrical contacts 123 of the N-type doping region 127 are electrically connected to the anode of the electrical voltage source, and the outer electrical contacts 125 of the P-type doping region 129 are electrically connected to the cathode of the electrical voltage source. The outer electrical contacts 125 are positioned far enough from the rib ring 107 to reduce optical absorption of the light traveling through the rib ring 107 by metal and silicided regions that form the outer electrical contacts 125. Also, the inner electrical contacts 123 are positioned far enough from the rib ring 107 to reduce optical absorption of the light traveling through the rib ring 107 by metal and silicided regions that form the inner electrical contacts 123.

The lateral PN junction diode configuration of the ring modulator 100, with the inner electrical contacts 123 positioned on the inner radii and the outer electrical contacts 125 positioned on the outer radii, provides several advantages, such as low junction series electrical resistance to the PN junction diode and low parasitic electrical capacitance between doped regions located away/apart from the rib ring 107 through which light travels within the ring modulator 100. Also, in the ring modulator 100, the lateral PN junction diode configuration does not extend into the optical coupling region 120 between the rib ring 107 and the optical waveguide 113 because positioning of outer electrical contacts 125 and implantation of dopants within the optical coupling region 120 would cause adverse optical absorption loss for light traveling through the optical waveguide 113.

In wavelength division multiplexed (WDM) configurations, the optical waveguide 113 carries/guides light of multiple wavelength channels. In the WDM configurations, optical absorption loss in the optical waveguide 113 affects all wavelength channels. Also, in systems that have multiple instances of the ring modulators optically coupled to the same optical waveguide 113, e.g., to the same bus optical waveguide, the optical absorption loss in the optical waveguide 113 accumulates from all ring modulators that are optically coupled to the optical waveguide 113. As mentioned above, the ring modulator 100 avoids causing adverse optical absorption loss in the optical waveguide 113 by not having the lateral PN junction diode within the optical coupling region 120. However, by not having the lateral PN junction diode formed within the optical coupling region 120, the optical modulator efficiency of the ring modulator 100 is reduced.

In some embodiments, the N-type doping region 127 and the P-type doping region 129 are extended through the optical coupling region 120 and electrical contacts are placed on the side of the optical waveguide 113 that is opposite from the side of the optical waveguide 113 along which the ring modulator is positioned. In these embodiments, the dopants and electrical contacts within the optical coupling region 120 can adversely contribute to optical absorption loss within the optical waveguide 113 and adversely increase electrical series resistance in the lateral PN junction diode. Therefore, it is of interest to have a ring modulator in which the lateral PN junction diode is extended into the optical coupling region of the ring modulator without adversely affecting optical absorption loss in the optical waveguide to which the ring modulator is optically coupled and without adversely increasing the electrical series resistance in the lateral PN junction diode of the ring modulator.

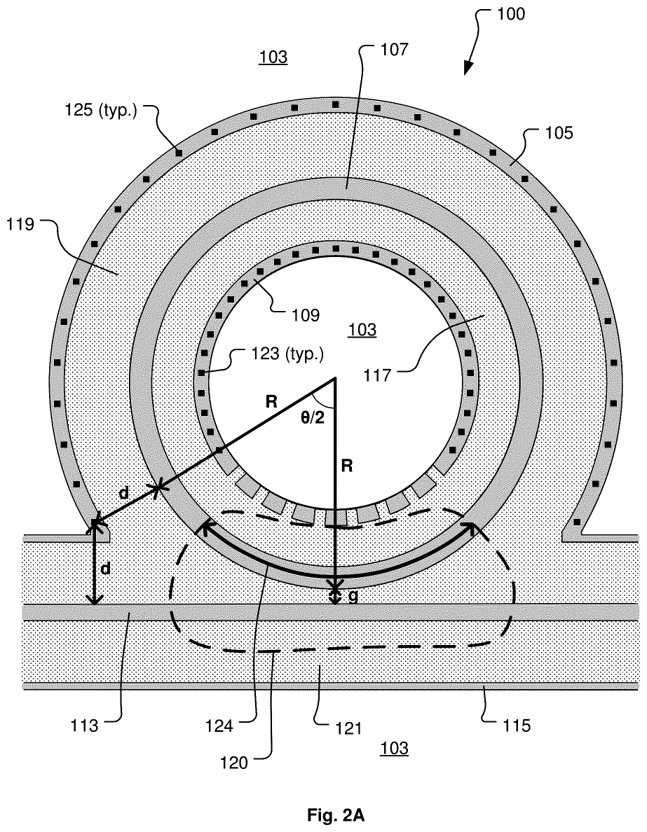

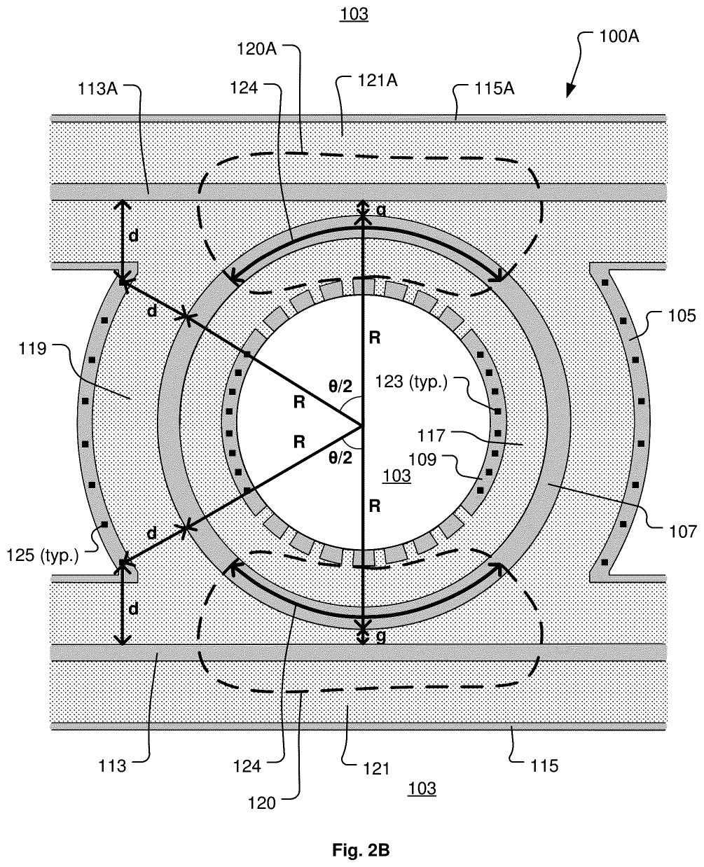

FIG. 2A shows the top view of the partially formed ring modulator 100 of FIG. 1F with annotations for computation of the optical coupling length 124 of the rib ring 107 along which the lateral PN junction diode is excluded, in accordance with some embodiments. It is considered that the outer electrical contacts 125 are placed a minimum distance (d) from each of the rib ring 107 and the optical waveguide 113 in order to reduce optical absorption loss caused by the electrical contacts 125. It is also considered that the rib ring 107 has an outer radius (R). It is also considered that a minimum ring-to-waveguide coupling gap distance (g) exists between the rib ring 107 and the optical waveguide 113. It is also considered that the portion of the optical waveguide 113 that extends past the ring modulator 100 has a substantially straight configuration. Given the above-mentioned considerations, an angular region (θ) that cannot accommodate a lateral PN junction diode within the ring modulator 100 is given by Equation 2.

$$θ = 2 {cos}^{- 1} ( \frac{R + g - d}{R + d} ) . \qquad Equation 2$$

In an example embodiment, for R=5 micrometers, d=1.5 micrometers, and g=0.25 micrometer, the angular region (θ) is 120°, which means that one-third of the ring modulator 100 cannot accommodate the lateral PN junction diode. In this example embodiment, the efficiency of the ring modulator 100 (measured as wavelength shift per volt) is reduced by one-third as compared to a having a lateral PN junction diode formed around a total circumferential length of the rib ring 107.

FIG. 2B shows a top view of a partially formed ring modulator 100A that has a second optical waveguide 113A and a second optical coupling region 120A, in accordance with some embodiments. The ring modulator 100A is a variation of the ring modulator 100 of FIG. 1A. The partial-height silicon region 119 extends between the rib ring 107 and the second optical waveguide 113A. A partial-height silicon region 121A extends along a side of the second optical waveguide 113A that is opposite from the rib ring 107. A full-height (full-thickness) silicon region 115A extends along the partial-height silicon region 121A on a side of the partial-height silicon region 121A that is located away from the second optical waveguide 113A. The second optical waveguide 113A is positioned on an opposite side of the ring modulator 100A relative to the optical waveguide 113. In some embodiments, the second optical waveguide 113A is configured in the same manner as the optical waveguide 113, and is positioned to extend parallel with the optical waveguide 113 past the ring modulator 100A. In these embodiments that have both the optical waveguide 113 and the second optical waveguide 113A, the angular region (θ) that cannot accommodate a lateral PN junction diode within the ring modulator 100A, as given by Equation 2, occurs at a first location for the optical waveguide 113 and at a second location for the optical waveguide 113A. Therefore, in the example embodiment in which R=5 micrometers, d=1.5 micrometers, and g=0.25 micrometer, the total angular region (θ) of the ring modulator 100A that cannot accommodate the lateral PN junction diode is 240°, which is two-thirds of the total circumferential length of the rib ring 107. In this example embodiment, the efficiency of the ring modulator 100A (measured as wavelength shift per volt) is reduced by two-thirds as compared to a having a lateral PN junction diode formed around a total circumferential length of the rib ring 107.

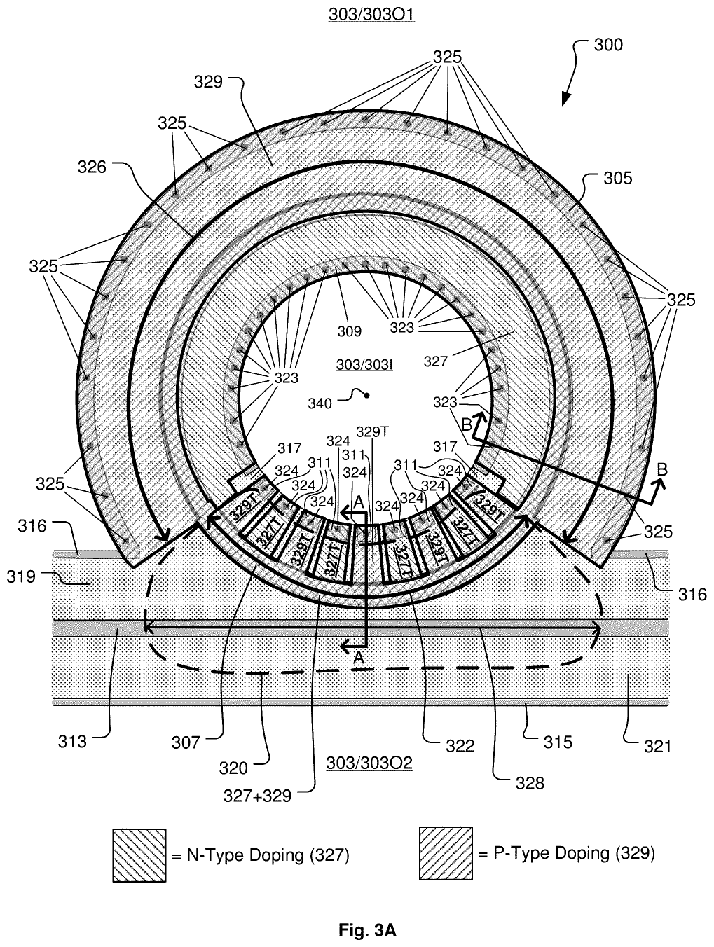

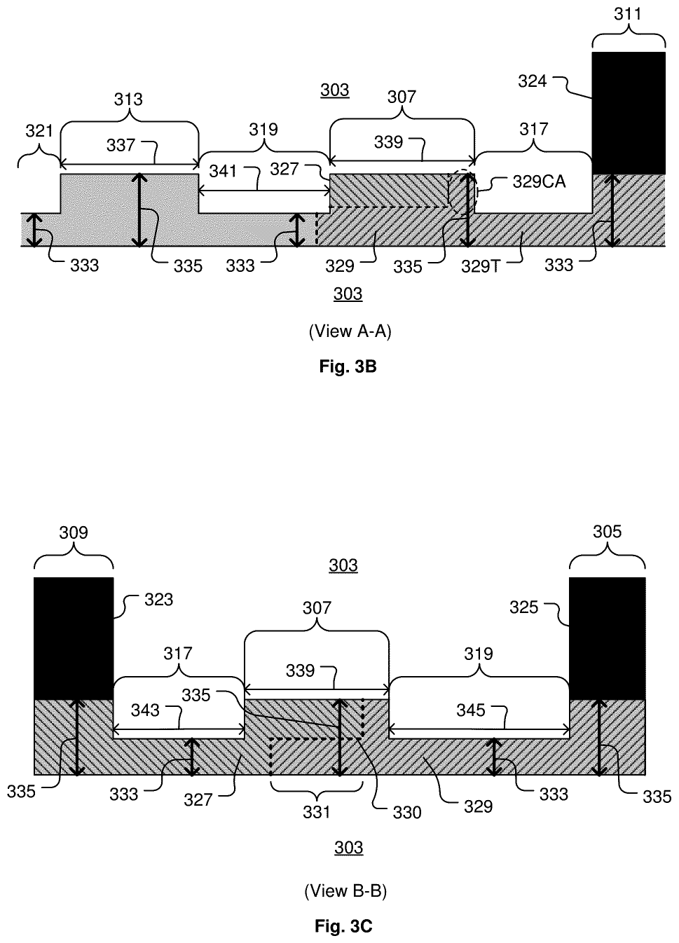

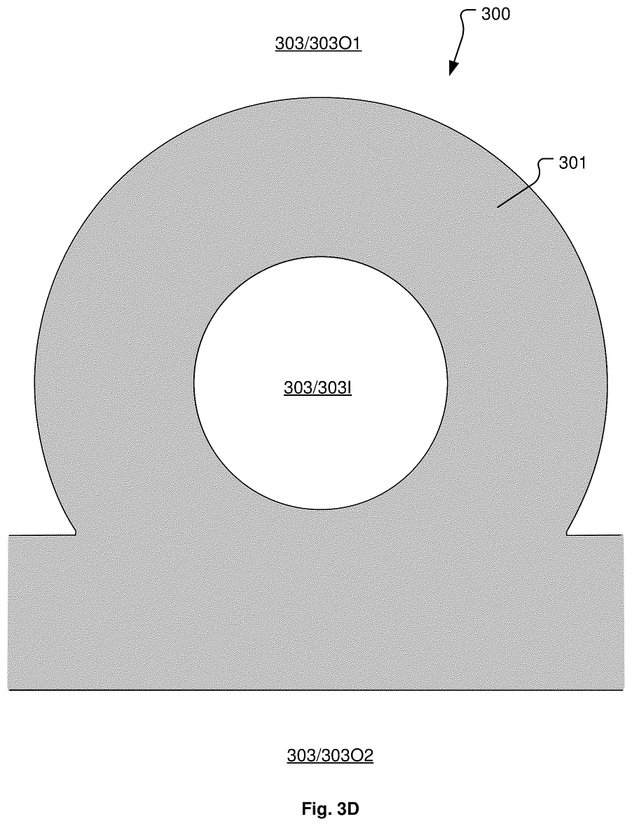

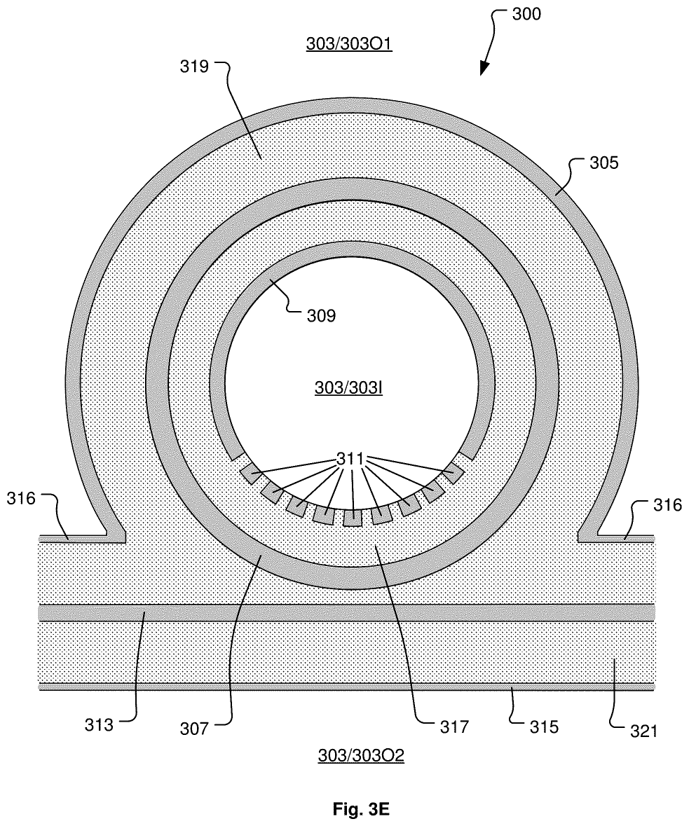

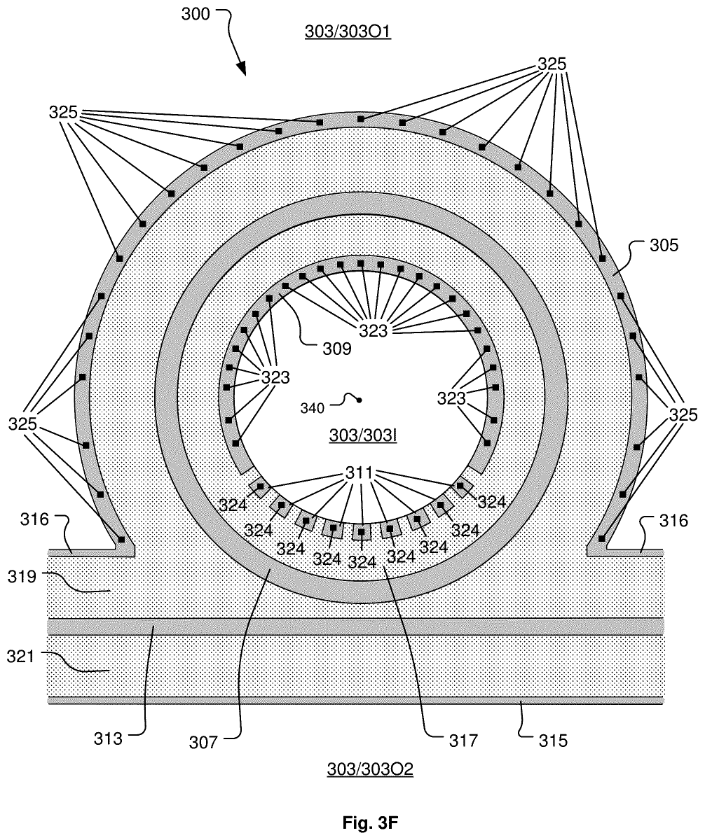

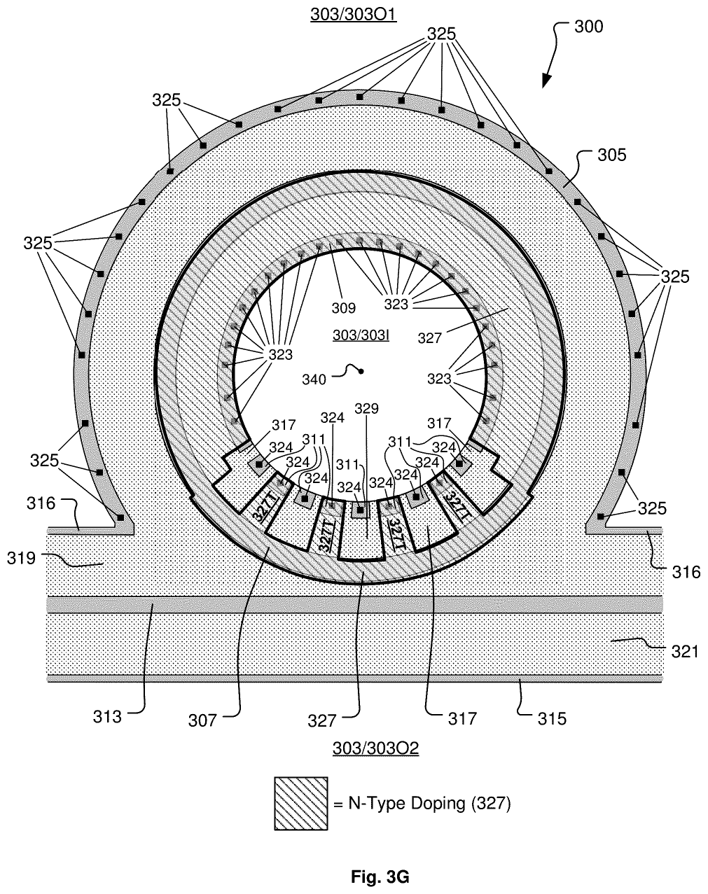

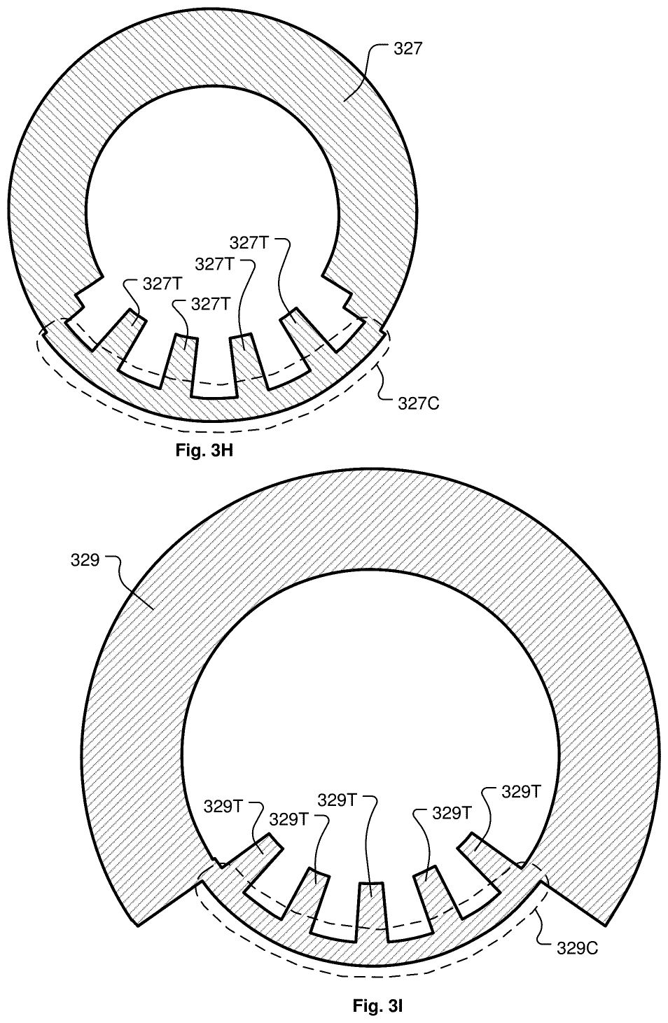

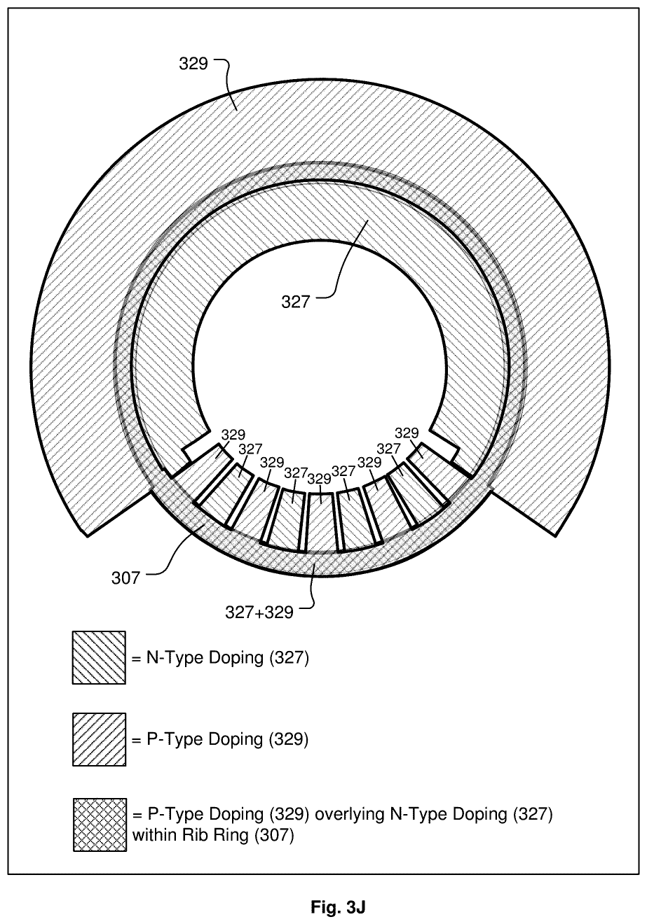

FIG. 3A shows a top view of a ring modulator 300 that implements an interdigitated diode configuration within an optical coupling region 320 between an optical waveguide 313 and a rib ring 307 of the ring modulator 300 in order to optimize modulation efficiency while minimizing optical loss in the optical waveguide 313, in accordance with some embodiments. In some embodiments, the ring modulator 300 and optical waveguide 313 configuration of FIG. 3A is implemented within a photonic integrated circuit (PIC). The rib ring 307 is a ring-shaped optical waveguide. The ring modulator 300 is positioned so that the rib ring 307 is located within an evanescent optical coupling distance from the optical waveguide 313. The rib ring 307 is formed as a rib optical waveguide that loops back into itself. A portion of the rib ring 307 extends through the optical coupling region 320. The rib ring 307 and the optical waveguide 313 are formed as respective full-height (full-thickness) silicon regions. The rib ring 307 and the optical waveguide 313 are surrounded by partial-height (partial-thickness) silicon regions 317, 319, and 321. The partial-height silicon region 317 extends around an inside wall of the rib ring 307. The partial-height silicon region 319 extends around an outside wall of the rib ring 307. The partial-height silicon region 319 also extends between the rib ring 307 and the optical waveguide 313. The partial-height silicon region 319 also extends along a first wall of the optical waveguide 313 that faces toward the ring modulator 300. The partial-height silicon region 321 extends along a second wall of the optical waveguide 313 that is on an opposite side of the optical waveguide 313 from the first wall of the optical waveguide 313.

A full-height (full-thickness) silicon region 305 extends along an outer radial periphery of the portion of the partial-height silicon region 319 that extends along an azimuthal angular span 326 about a center 340 of the ring modulator 300 radially outside of the rib ring 307. The center 340 of the ring modulator 300 is also the center 340 of the ring shape of the rib ring 307. A full-height (full-thickness) silicon region 316 extends along the partial-height silicon region 119 on a side of the partial-height silicon region 119 that is located away from the optical waveguide 313. A full-height (full-thickness) silicon region 315 extends along the partial-height silicon region 321 on a side of the partial-height silicon region 321 that is located away from the optical waveguide 313. Full-height (full-thickness) silicon regions 309 and 311 are formed along an inner side of the partial-height silicon region 317 that is located away from the rib ring 307.

The ring modulator 300 is formed within an optical cladding material 303 that includes an inner optical cladding material 3031, a first outer optical cladding material 30301, and a second outer optical cladding material 30302. More specifically, in some embodiments, the inner optical cladding material 3031 is circumscribed by a combination of the full-height (full-thickness) silicon regions 309 and 311 and the partial-height silicon region 317. Also, the ring modulator 300 is circumscribed by the first outer optical cladding material 30301. Also, the second outer optical cladding material 30302 is present along a side of the full-height (full-thickness) silicon region 315 that is located away from the ring modulator 300.

A number of inner electrical contacts 323 (shown as black dots) are formed in electrical connection with the full-height (full-thickness) silicon region 309 along the inner side of the partial-height silicon region 317 that is located away from the rib ring 307. Also, a number of inner electrical contacts 324 (shown as black dots) are formed in electrical connection with the full-height (full-thickness) silicon regions 311 along the inner side of the partial-height silicon region 317 that is located away from the rib ring 307. Also, a number outer electrical contacts 325 (shown as black dots) are formed in electrical connection with the full-height (full-thickness) silicon region 305 that extends along the outer radial periphery of the portion of the partial-height silicon region 319 that extends radially around the rib ring 307.

The ring modulator 300 has an N-type doping region 327 that is formed within a portion of the rib ring 307, a portion of the partial-height silicon region 317, and the full-height (full-thickness) silicon region 309. The N-type doping region 327 includes a number of tab-shaped N-type doping regions 327T that each project inward from the rib ring 307 toward the center 340 of the ring modulator 300 to form respective portions of the interdigitated diode configuration within the optical coupling region 320. The ring modulator 300 also has a P-type doping region 329 that is formed within a portion of the rib ring 307, a portion of the partial-height silicon region 319 that extends radially around the rib ring 307, and the full-height (full-thickness) silicon region 305.

The P-type doping region 329 also includes a number of tab-shaped P-type doping regions 329T that each project inward from the rib ring 307 toward the center 340 of the ring modulator 300 to form respective portions of the interdigitated diode configuration within the optical coupling region 320. The tab-shaped N-type doping regions 327T and the tab-shaped P-type doping regions 329T alternate in placement with respect to each other along the curvature of the rib ring 307 within the optical coupling region 320. In this manner, the tab-shaped N-type doping regions 327T and the tab-shaped P-type doping regions 329T collectively form the interdigitated diode configuration within the optical coupling region 320. In some embodiments, adjacently positioned ones of the tab-shaped N-type doping regions 327T and the tab-shaped P-type doping regions 329T are separated from each other by a non-doped portion of the partial-height silicon region 317.

The N-type doping region 327 and the P-type doping region 329 interface with each other within the rib ring 307 to form a PN junction diode within the optical coupling region 320. The tab-shaped N-type doping regions 327T and the tab-shaped P-type doping regions 329T provide respective electrically conductive pathways from the PN junction diode within the rib ring 307 to respective ones of the inner electrical contacts 324. In this manner, the N-type doping region 327 of the PN junction diode within the rib ring 307, within the optical coupling region 320, is electrically connected to a first node of an electrical circuit through each of the tab-shaped N-type doping regions 327T and corresponding inner electrical contacts 324. Also, the P-type doping region 329 of the PN junction diode within the rib ring 307, within the optical coupling region 320, is electrically connected to a second node of an electrical circuit through each of the tab-shaped P-type doping regions 329T and corresponding inner electrical contacts 324. Therefore, it should be understood that in the ring modulator 300, the PN junction diode formed within the rib ring 307 extends through the optical coupling region 320 as indicated by arrow 322.

FIG. 3B shows a vertical cross-section through the rib ring 307 and the optical waveguide 313 at a location of their closest approach to each other, referenced as View A-A in FIG. 3A, in accordance with some embodiments. The rib ring 307 and the optical waveguide 313 have a thickness 335, which corresponds to a full-thickness of silicon. Each of the partial-height (partial-thickness) silicon regions 317, 319, and 321 have a thickness 333, which is less than the thickness 335. The optical waveguide 313 has a width 337. The rib ring 307 has a radial width 339. The optical waveguide 313 approaches the rib ring 307 such that a minimum (non-zero) separation distance 341 exists between the optical waveguide 313 and the rib ring 307. The optical coupling region 320 (indicated by the dashed line in FIG. 3A) exists in which the optical waveguide 313 is located within an evanescent optical coupling distance of the rib ring 307. Because the optical waveguide 313 semi-tangentially approaches the rib ring 307 (without contacting the rib ring 307), the optical coupling region 320 exists along an optical coupling length 328 of the optical waveguide 313 and along the optical coupling length 322 of the rib ring 307, as shown in FIG. 3A.

FIG. 3C shows a vertical cross-section through the rib ring 307 and the full-height (full-thickness) silicon regions 309 and 305, referenced as View B-B in FIG. 3A, in accordance with some embodiments. Each of the rib ring 307, the inner silicon region 309, and the outer silicon region 305 has the thickness 335, which corresponds to the full-thickness of silicon. The rib ring 307 is separated from the inner silicon region 309 by a radial distance 343 over which the partial-height (partial-thickness) silicon region 317 is formed to have the thickness 333. The rib ring 307 is separated from the outer silicon region 305 by a radial distance 345 over which the partial-height (partial-thickness) silicon region 319 is formed to have the thickness 333. The rib ring 307 has the radial width 339, which is substantially consistent around the entire circumference of the rib ring 307. The vertical cross-section of FIG. 3C also extends through one of the inner electrical contacts 323 positioned in electrical connection with the inner silicon region 309. The vertical cross-section of FIG. 3C also extends through one of the outer electrical contacts 325 positioned in electrical connection with the outer silicon region 305. FIG. 3C shows an interface 330 (dashed line) between the N-type doping region 327 and the P-type doping region 329 within the rib ring 307 to form the PN junction diode along the interface 330. In some embodiments, the N-type doping region 327 overlaps the P-type doping region 329 within the rib ring 307 over an area 331. Alternatively, in some embodiments, the P-type doping region 329 overlaps the N-type doping region 327 within the rib ring 307 over the area 331. It should be understood that the area 331 of overlap between the N-type doping region 327 and the P-type doping region 329 extends around the circumference of the rib ring 307, including through the optical coupling region 320.

FIGS. 3D through 3J show a succession of fabrication processes performed to arrive at the example ring modulator 300 of FIGS. 3A through 3C, in accordance with some embodiments. FIG. 3D shows a top view of a configuration of full-height (full-thickness) silicon 301 formed within the cladding material 303, in accordance with some embodiments. The configuration of full-height (full-thickness) silicon 301 has the thickness 335 as shown in FIGS. 3B and 3C. A portion of the configuration of full-height (full-thickness) silicon 301 is used to form the ring modulator 300. Another portion of the configuration of full-height (full-thickness) silicon 301 is used to form the optical waveguide 313 that extends past the ring modulator 300.

FIG. 3E shows a top view of the configuration of full-height (full-thickness) silicon 301 of FIG. 3D with portions of the full-height (full-thickness) silicon 301 etched away to form the partial-height (partial-thickness) silicon regions 317, 319, and 321, in accordance with some embodiments. The partial-height (partial-thickness) silicon regions 317, 319, and 321 have the thickness 333, as shown in FIGS. 3B and 3C, which is less than the full-thickness 335. The partial-height (partial-thickness) silicon regions 317, 319, and 321 are configured and positioned such that a first remaining portion of the full-height (full-thickness) silicon 301 forms the rib ring 307, and such that a second remaining portion of the full-height (full-thickness) silicon 301 forms the outer silicon region 305, and such that a third remaining portion of the full-height (full-thickness) silicon 301 forms the inner silicon regions 309 and 311, and such that a fourth remaining portion of the full-height (full-thickness) silicon 301 forms the optical waveguide 313, and such that a fifth remaining portion of the full-height (full-thickness) silicon 301 forms the full-height (full-thickness) silicon region 316, and such that a sixth remaining portion of the full-height (full-thickness) silicon 301 forms the full-height (full-thickness) silicon region 315.

FIG. 3F shows a top view of the partially formed ring modulator 300 of FIG. 3E with formation of the inner electrical contacts 323, the inner electrical contacts 324, and the outer electrical contacts 325, in accordance with some embodiments. The inner electrical contacts 323 are formed in electrical connection with the inner full-height (full-thickness) silicon region 309. The inner electrical contacts 324 are formed in electrical connection with the inner full-height (full-thickness) silicon regions 311, respectively. The outer electrical contacts 325 are formed in electrical connection with the outer full-height (full-thickness) silicon region 305. In some embodiments, the inner electrical contacts 323 are substantially uniformly azimuthally spaced about the center 340 of ring modulator 300 along the inner full-height (full-thickness) silicon region 309. In some embodiments, the outer electrical contacts 325 are substantially uniformly azimuthally spaced about the center 340 of the ring modulator 300 along the outer full-height (full-thickness) silicon region 305.

FIG. 3G shows a top view of the partially formed ring modulator 300 of FIG. 3F with formation of the N-type doping region 327 and the tab-shaped N-type doping regions 327T, in accordance with some embodiments. The N-type doping region 327 is formed within the silicon of the inner full-height (full-thickness) silicon region 309, and within the partial-height (partial-thickness) silicon region 317 that extends along the inner full-height (full-thickness) silicon region 309, and within a portion of the rib ring 307 around the circumference of the rib ring 307. The tab-shaped N-type doping regions 327T are integrally formed with the N-type doping region 327, such that each of the tab-shaped N-type doping regions 327T is an inward extending portion of the N-type doping region 327.

FIG. 3H shows an isolated top view of the N-type doping region 327 and the tab-shaped N-type doping regions 327T, in accordance with some embodiments. Each of the tab-shaped N-type doping regions 327T extends inward toward the center 340 of the ring modulator 300 so as to extend over a corresponding one of the inner full-height (full-thickness) silicon regions 311, and so as to electrically interface with a corresponding one of the inner electrical contacts 324. Also, the N-type doping region 127 that extends over the inner full-height (full-thickness) silicon region 309 electrically interfaces with the inner electrical contacts 323.

FIG. 3A shows the top view of the ring modulator 300 of FIG. 3G with formation of the P-type doping region 329 and the tab-shaped P-type doping regions 329T, in accordance with some embodiments. The P-type doping region 329 is formed within the silicon of the outer full-height (full-thickness) silicon region 305, and within the partial-height (partial-thickness) silicon region 319 that extends along the outer full-height (full-thickness) silicon region 305, and within a portion of the rib ring 307 around an entire circumferential span of the rib ring 307. The tab-shaped P-type doping regions 329T are integrally formed with the P-type doping region 329, such that each of the tab-shaped P-type doping regions 329T is an inward extending portion of the P-type doping region 329.

FIG. 3I shows an isolated top view of the P-type doping region 329 and the tab-shaped P-type doping regions 329T, in accordance with some embodiments. Each of the tab-shaped P-type doping regions 329T extends inward toward the center 340 of the ring modulator 300 so as to extend over a corresponding one of the inner full-height (full-thickness) silicon regions 311, and so as to electrically interface with a corresponding one of the inner electrical contacts 324. Also, the P-type doping region 129 that extends over the outer full-height (full-thickness) silicon region 305 electrically interfaces with the outer electrical contacts 325.

FIG. 3J shows an isolated top view of the P-type doping region 329 and the tab-shaped P-type doping regions 329T positioned in relation with the N-type doping region 327 and the tab-shaped N-type doping regions 327T, in accordance with some embodiments. In some embodiments, such as shown in FIGS. 3J and 3A, adjacently formed ones of the tab-shaped P-type doping regions 329T and the tab-shaped N-type doping regions 327T are azimuthally spaced apart from each other about the center 340 of the ring modulator 300, such that they are not in direct physical contact with each other.

Each of the P-type doping region 329, the tab-shaped P-type doping regions 329T, the N-type doping region 327, and the tab-shaped N-type doping regions 327T is doped with impurity ions to form the lateral PN junction diode. In some embodiments, the P-type doping region 329 and tab-shaped P-type doping regions 329T are doped with acceptor impurity atoms, and the N-type doping region 327 and the tab-shaped N-type doping regions 327T are doped with donor impurity atoms. In these embodiments, the N-type doping region 327 and the P-type doping region 329 are doped with opposite polarity. The interface between the N-type doping region 327 and the P-type doping region 329 within the rib ring 307 is the PN junction of the lateral PN junction diode. At the PN junction within the rib ring 307, the free electrons diffuse into the P-type doping region 329 and the holes (electron vacancies) diffuse into the N-type doping region 327, which causes a depletion region to form along the PN junction within the rib ring 307.

It should be appreciated that in the ring modulator 300, the PN junction diode formed by the P-type doping region 329 and the N-type doping region 327 extends through the optical coupling region 320. Within the optical coupling region 320, the tab-shaped N-type doping regions 327T formed within the partial-height (partial-thickness) silicon region 317 provide respective electrically conductive paths between the inner electrical contacts 324 and the depletion region formed along the PN junction within the rib ring 307. Also, within the optical coupling region 320, the tab-shaped P-type doping regions 329T formed within the partial-height (partial-thickness) silicon region 317 provide respective electrically conductive paths between the inner electrical contacts 324 and the depletion region formed along the PN junction within the rib ring 307. Along the rib ring 307 outside of the optical coupling region 320, the N-type doping region 327 formed within the partial-height (partial-thickness) silicon region 317 provides an electrically conductive path between the inner electrical contacts 323 and the depletion region formed along the PN junction within the rib ring 307. Also, along the rib ring 307 outside of the optical coupling region 320, the P-type doping region 329 formed within the partial-height (partial-thickness) silicon region 319 provides an electrically conductive path between the outer electrical contacts 325 and the depletion region formed along the PN junction within the rib ring 307.

In some embodiments, with the lateral PN junction diode within the rib ring 307 electrically connected in a reverse-biased manner to an electrical voltage source, the inner electrical contacts 323 of the N-type doping region 327 and the inner electrical contacts 324 of the tab-shaped N-type doping regions 327T are electrically connected to the anode of the electrical voltage source. Also, in these embodiments, with the lateral PN junction diode within the rib ring 307 electrically connected in a reverse-biased manner to the electrical voltage source, the outer electrical contacts 325 of the P-type doping region 329 and the inner electrical contacts 324 of the tab-shaped P-type doping regions 329T are electrically connected to the cathode of the electrical voltage source. The outer electrical contacts 325 are positioned far enough from the rib ring 307 to reduce optical absorption of the light traveling through the rib ring 307 by metal and silicided regions that form the outer electrical contacts 325. Also, the inner electrical contacts 324 are positioned far enough from the rib ring 307 to reduce optical absorption of the light traveling through the rib ring 307 by metal and silicided regions that form the inner electrical contacts 324.

In the ring modulator 300, the lateral PN junction diode extends into the optical coupling region 320 of the ring modulator 300 without adversely affecting optical absorption loss in the optical waveguide 313 to which the ring modulator 300 is optically coupled. Also, positioning of the tab-shaped N-type doping regions 327T and the tab-shaped P-type doping regions 329T on the inside of the rib ring 307 so as to extend toward the center 340 of ring modulator 300 enables the lateral PN junction diode to extend through the optical coupling region 320 of the ring modulator 300 without adversely affecting optical absorption loss in the optical waveguide 313 to which the ring modulator 300 is optically coupled. Additionally, by having the multiple tab-shaped N-type doping regions 327T and tab-shaped P-type doping regions 329T alternatively positioned along the arc of the rib ring 307 within the optical coupling region 320, the electrical series resistance in the lateral PN junction diode of the ring modulator 300 is not adversely increased by having the lateral PN junction diode extend through the optical coupling region 320.

The ring modulator 300 uses the interdigitated PN junction diode design (interdigitation of the tab-shaped N-type doping regions 327T and the tab-shaped P-type doping regions 329T) in the portion of the rib ring 307 that passes through the optical coupling region 320, while using a different non-interdigitated PN junction diode design in the portion of the rib ring 307 that does not pass through the optical coupling region 320. Within the optical coupling region 320, the inner electrical contacts 324 are positioned along the inner region of the ring modulator 300, far from the rib ring 307 and even farther from the optical waveguide 313, so as to avoid optical absorption loss in the coupling optical waveguides 307 and 313. The interdigitated tab-shaped N-type doping regions 327T and tab-shaped P-type doping regions 329T alternate polarity (alternate cathode and anode) within the optical coupling region 320.

It should be understood that there is more flexibility in the design of the portions of the ring modulator 300 that are away from the optical coupling region 320. For example, in the region of the ring modulator 300 away from the optical coupling region 320, the inner electrical contacts 323 and the N-type doping region 327 are placed on the inner side of the rib ring 307, and the outer electrical contacts 325 and the P-type doping region 329 are placed on the outer side of the rib ring 307, so as to reduce and/or minimize the series electrical resistance of the ring modulator 300. All of the inner electrical contacts 323 that are electrically connected to the N-type doping region 327 and all of the inner electrical contacts 324 that are connected to a corresponding one of the tab-shaped N-type doping regions 327T are collectively electrically connected to a same first electrical node. Similarly, all of the outer electrical contacts 325 that are electrically connected to the P-type doping region 329 and all of the inner electrical contacts 324 that are connected to a corresponding one of the tab-shaped P-type doping regions 329T are collectively electrically connected to a same second electrical node that is different and electrically separated from the first electrical node. In various embodiments, electrically conductive structures, e.g., metal traces/wires, and electrically conductive via structures are formed in and/or through different levels of the semiconductor device in which the ring modulator 300 is formed in order to electrically connect all of the inner electrical contacts 323 that are electrically connected to the N-type doping region 327 and all of the inner electrical contacts 324 that are connected to a corresponding one of the tab-shaped N-type doping regions 327T to the same first electrical node. Also, in various embodiments, electrically conductive structures, e.g., metal traces/wires, and electrically conductive via structures are formed in and/or through different levels of the semiconductor device in which the ring modulator 300 is formed in order to electrically connect all of the outer electrical contacts 325 that are electrically connected to the P-type doping region 329 and all of the inner electrical contacts 324 that are connected to a corresponding one of the tab-shaped P-type doping regions 329T to the same second electrical node.

In accordance with the foregoing, the ring resonator 300 includes a built-in interdigitated PN junction diode for modulating an optical signal propagating through the optical waveguide 313. The optical mode supported by the ring resonator 300 has significant power density that overlaps the depletion region of the PN junction diode within the rib ring 307. By changing the voltage differential between the anode and cathode of the PN junction diode within the rib ring 307, charge carriers can be added to or removed from the depletion region of the PN junction within the rib ring 307 in a controlled manner, which provides for changing of the refractive index and optical absorption coefficient of the rib ring 307 in a controlled manner by way of the plasma effect, which in turn provides for changing of the amplitude and phase of the light that is transmitted on through the optical waveguide 313 past the ring modulator 300 in a controlled manner. In some embodiments, the PN junction diode within the rib ring 307 of the ring modulator 300 is operated in a reversed bias manner to enable fast charge transport and correspondingly high optical modulation data rates.

In some embodiments, the optical waveguide 313 carries multiple wavelength channels of light, with only one of the multiple wavelength channels of light being coupled into and modulated by the ring resonator 300. In some embodiments, such as in WDM systems, multiple instances of the ring resonator 300 are optically coupled to the same optical waveguide 313, with each of the ring resonators 300 tuned to modulate a different one of the multiple wavelength channels of light propagating through the optical waveguide 313. The metal of the inner electrical contacts 324 absorbs light across all wavelengths. Therefore, by having the inner electrical contacts 324 positioned away from the optical waveguide 313, e.g., by a distance greater than or equal to about one micrometer, within each instance of the ring modulator 300, it is possible to avoid introduction and accumulation of excess optical absorption loss of the light propagating through the optical waveguide 313 across every wavelength channel of light.

FIGS. 3A through 3J show a portion of a photonic integrated circuit. The photonic integrated circuit includes a first optical waveguide 307 that has a ring shape. The first optical waveguide 307 is formed of silicon and has a first vertical height 335. The photonic integrated circuit also includes an inner silicon region 317 formed circumferentially along an inner side of the first optical waveguide 307. The inner silicon region 317 has a second vertical height 333 that is less than the first vertical height 335. The photonic integrated circuit also includes a second optical waveguide 313 configured to semi-tangentially approach an outer side of the first optical waveguide 307 and extend past the first optical waveguide 307, such that an optical coupling region 320 exists between a portion of the second optical waveguide 313 and a portion of the first optical waveguide 307. The photonic integrated circuit also includes an N-type doping region 327 formed within the first optical waveguide 307 and the inner silicon region 317. The N-type doping region 327 includes multiple tab-shaped N-type doping regions 327T formed within the optical coupling region 320. Each of the multiple tab-shaped N-type doping regions 327T is formed to project inward toward a center 340 of the ring shape of the first optical waveguide 307. The photonic integrated circuit also includes a P-type doping region 329 formed within the first optical waveguide 307 and the inner silicon region 317. The P-type doping region 329 includes multiple tab-shaped P-type doping regions 329T formed within the optical coupling region 320. Each of the multiple tab-shaped P-type doping regions 329T is formed to project inward toward the center 340 of the ring shape of the first optical waveguide 307. Positions of the multiple tab-shaped N-type doping regions 327T alternate with positions of the multiple tab-shaped P-type doping regions 329T along the portion of the first optical waveguide 307 within the optical coupling region 320, such that the multiple tab-shaped N-type doping regions 327T and the multiple tab-shaped P-type doping regions 329T collectively form an interdigitated PN diode configuration within the first optical waveguide 307 within the optical coupling region 320.

The N-type doping region 327 includes a connecting portion 327C that is contiguously formed within the first optical waveguide 307 through the optical coupling region 320 and that is contiguously formed with each of the multiple tab-shaped N-type doping regions 327T. The P-type doping region 329 includes a connecting portion 329C that is contiguously formed within the first optical waveguide 307 through the optical coupling region 320 and that is contiguously formed with each of the multiple tab-shaped P-type doping regions 329T. Adjacently positioned ones of the multiple tab-shaped N-type doping regions 327T and the multiple tab-shaped P-type doping regions 329T are physically separated from each other, such as shown in FIG. 3J. The connecting portion 327C of the N-type doping region 327 is in physical contact with the connecting portion 329C of the P-type doping region 329 within the first optical waveguide 307, such as shown in FIG. 3B. The connecting portion 329C of the P-type doping region 329 extends below the connecting portion 327C of the N-type doping region 327, such as shown in FIG. 3B. The connecting portion 327C of the N-type doping region 327 is circumscribed by an annular segment 329CA of the connecting portion 329C of the P-type doping region 329.

The photonic integrated circuit also includes multiple inner electrical contacts 324 respectively physically connected to each of the multiple tab-shaped N-type doping regions 327T and each of the multiple tab-shaped P-type doping regions 329T. Each of the multiple inner electrical contacts 324 is positioned at an inner edge of the inner silicon region 317 relative to the center 340 of the ring shape of the first optical waveguide 307. In some embodiments, the multiple tab-shaped N-type doping regions 327T are electrically connected to a first electrical node by way of corresponding ones of the multiple inner electrical contacts 324. Also, the multiple tab-shaped P-type doping regions 329T are electrically connected to a second electrical node by way of corresponding ones of the multiple inner electrical contacts 324. The second electrical node is electrically separated from the first electrical node. In some embodiments, the first electrical node is electrically connected to an anode of an electrical voltage source, and the second electrical node is electrically connected to a cathode of the electrical voltage source, such that the interdigitated PN diode configuration is reverse-biased.

The photonic integrated circuit also includes an outer silicon region 319 is formed circumferentially along the outer side of the first optical waveguide 307. The outer silicon region 319 is formed between the first optical waveguide 307 and the second optical waveguide 313. The outer silicon region 319 has a third vertical height 333 that is less than the first vertical height 335 of the first optical waveguide 307. In some embodiments, the outer silicon region 319 is not doped. In some embodiments, the third vertical height 333 of the outer silicon region 319 is substantially equal to the second vertical height 333 of the inner silicon region 317. In some embodiments, a vertical height 335 of the second optical waveguide 313 is substantially equal to the first vertical height 335 of the first optical waveguide 307.

The first optical waveguide 307, the second optical waveguide 313, the outer silicon region 319, and the inner silicon region 317 are respective parts of a contiguous silicon structure. The contiguous silicon structure has a planar bottom surface that forms a respective bottom surface of each of the first optical waveguide 307, the second optical waveguide 313, the outer silicon region 319, and the inner silicon region 317. In some embodiments, the outer silicon region 319 and the inner silicon region 317 are etched regions of the contiguous silicon structure.

The N-type doping region 327 includes an azimuthal portion that is contiguously formed within the inner silicon region 317 along an azimuthal angular span 326 about the center 340 of the ring shape of the first optical waveguide 307 outside of the interdigitated PN diode configuration within the optical coupling region 320. The P-type doping region 329 includes an azimuthal portion that is contiguously formed within the outer silicon region 319 along the azimuthal angular span 326. The N-type doping region 327 and the P-type doping region 329 interface with each other to form a continuous PN diode configuration within the first optical waveguide 307 along the azimuthal angular span 326.

In some embodiments, the photonic integrated circuit includes a first set of multiple electrical contacts 324 respectively physically connected to each of the multiple tab-shaped N-type doping regions 327T and each of the multiple tab-shaped P-type doping regions 329T. Each electrical contact 324 of the first set of multiple electrical contacts 324 is positioned at an inner edge of the inner silicon region 317 relative to the center 340 of the ring shape of the first optical waveguide 307. The multiple tab-shaped N-type doping regions 327T are electrically connected to a first electrical node by way of corresponding ones of the first set of multiple electrical contacts 324. The multiple tab-shaped P-type doping regions 329T are electrically connected to a second electrical node by way of corresponding ones of the first set of multiple electrical contacts 324. The first electrical node is electrically connected to an anode of an electrical voltage source, and the second electrical node is electrically connected to a cathode of the electrical voltage source, such that the interdigitated PN diode configuration is reverse-biased. A second set of multiple electrical contacts 323 are positioned in a spaced apart configuration along an inner edge of the inner silicon region 317 along the azimuthal angular span 326 about the center 340 of the ring shape of the first optical waveguide 307 outside of the interdigitated PN diode configuration. In some embodiments, the second set of multiple electrical contacts 323 are electrically connected to optical modulation circuitry. A third set of multiple electrical contacts 325 are positioned in a spaced apart configuration along an outer edge of the outer silicon region 319 along the azimuthal angular span 326 about the center 340 of the ring shape of the first optical waveguide 307 outside of the interdigitated PN diode configuration. In some embodiments, the third set of multiple electrical contacts 325 are electrically connected to the optical modulation circuitry.

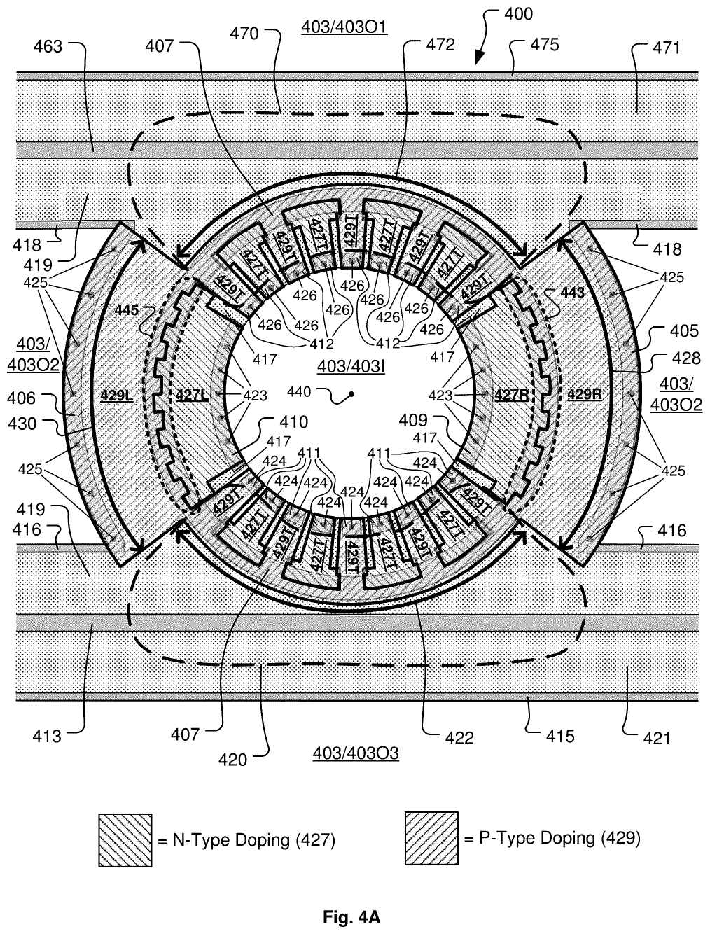

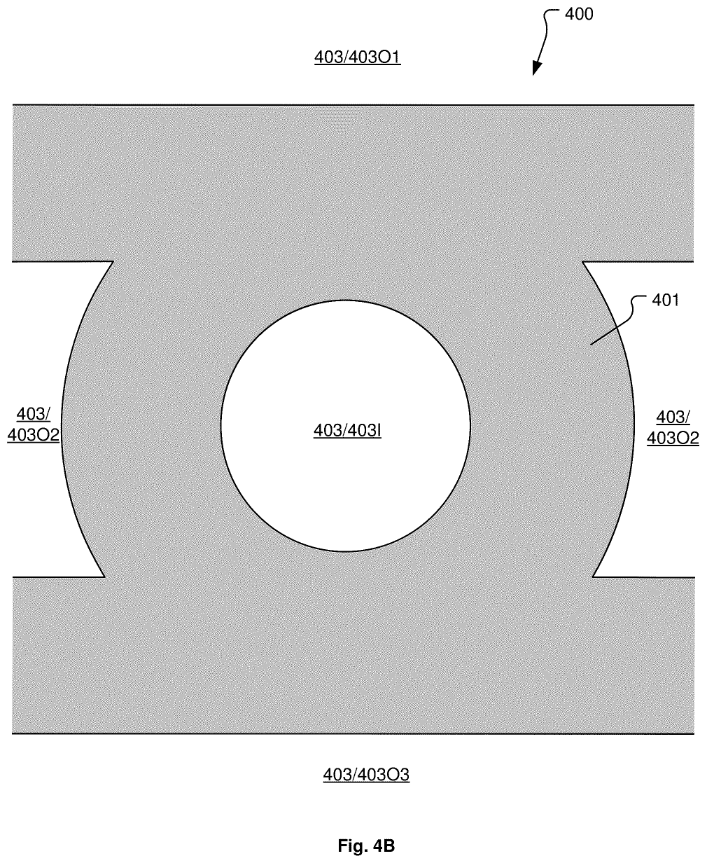

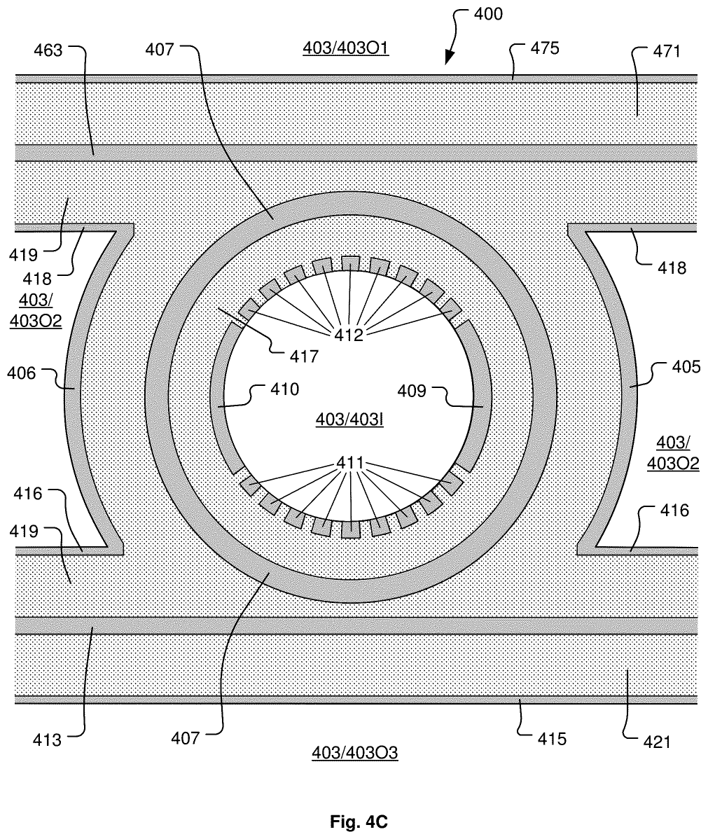

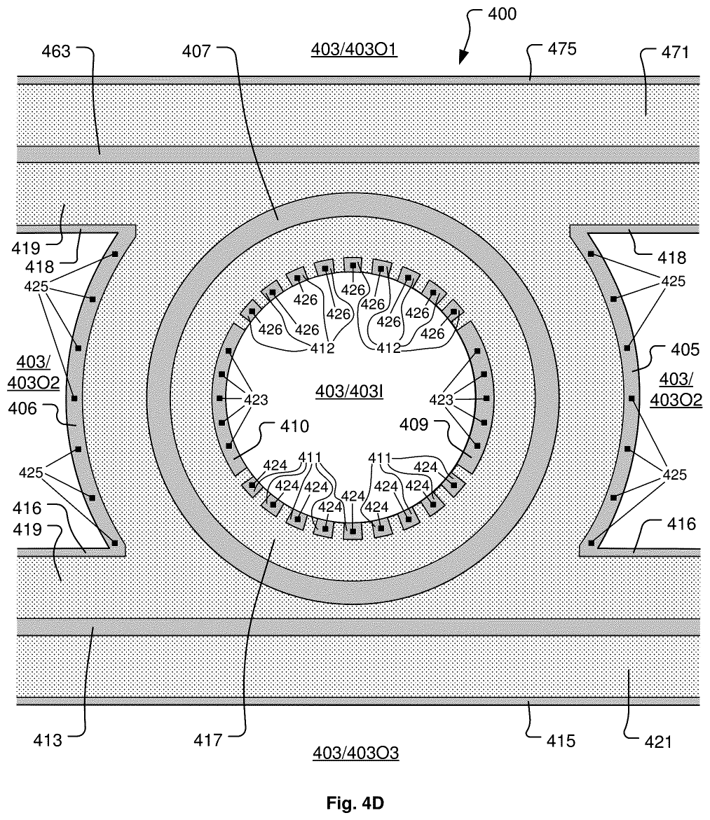

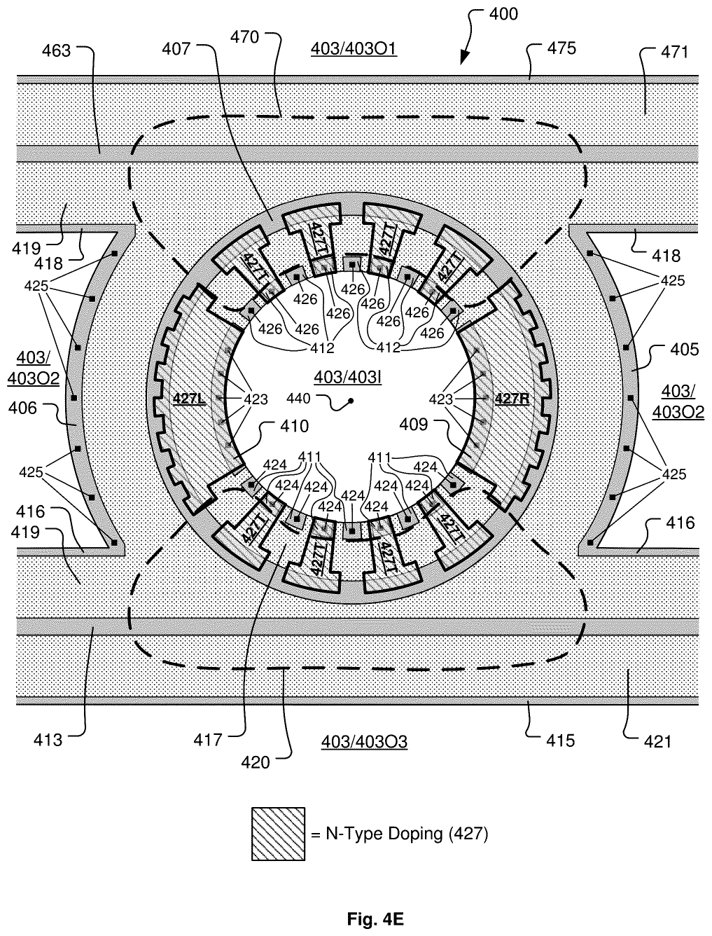

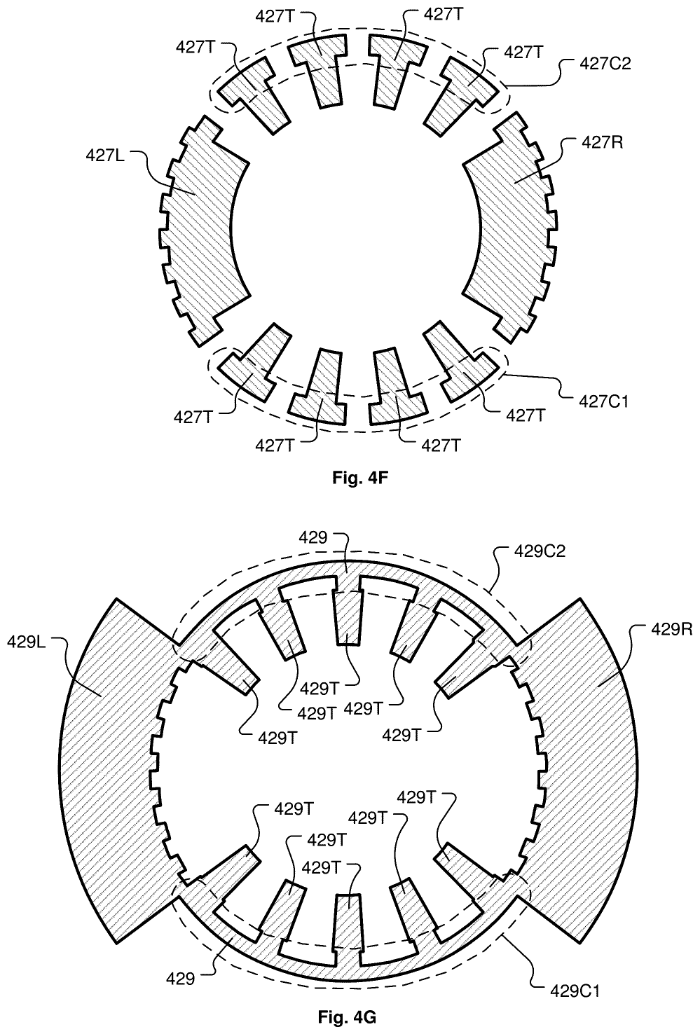

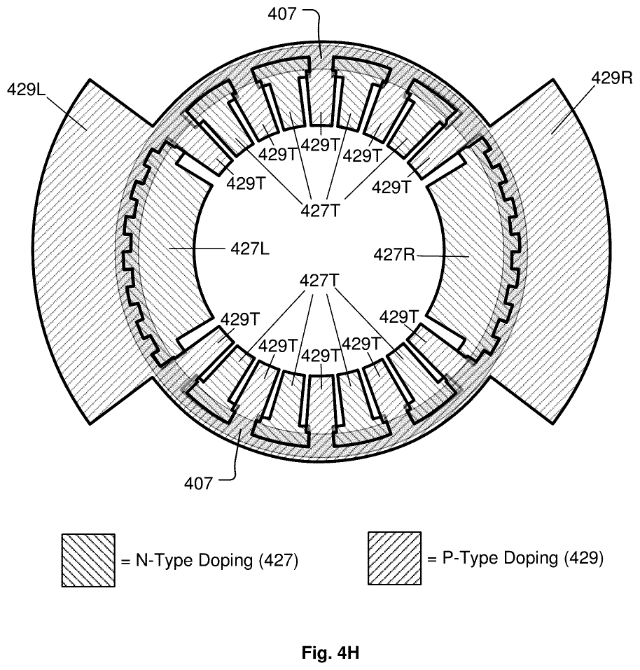

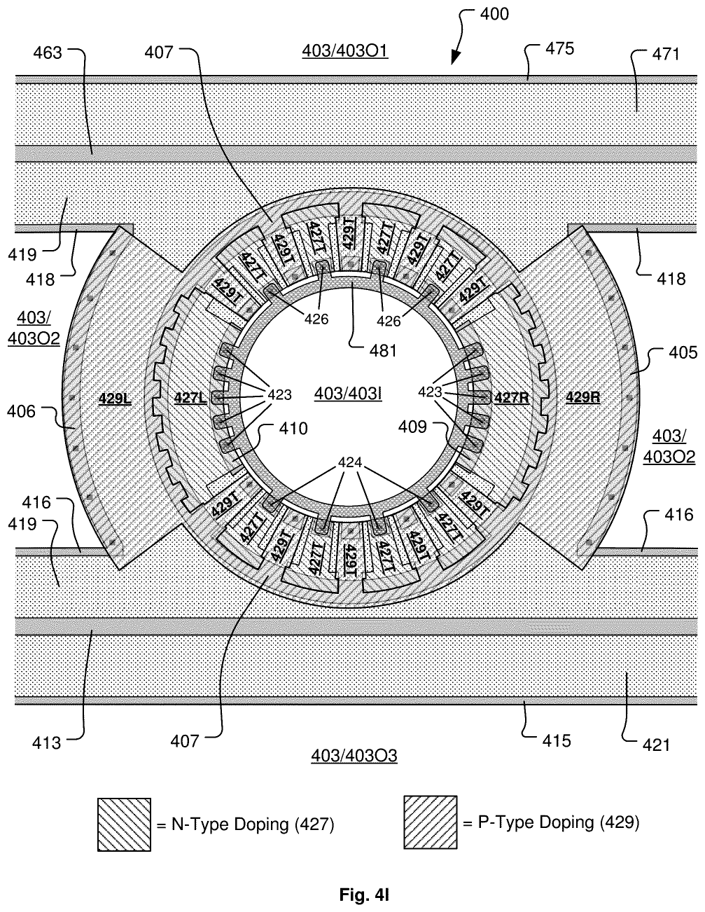

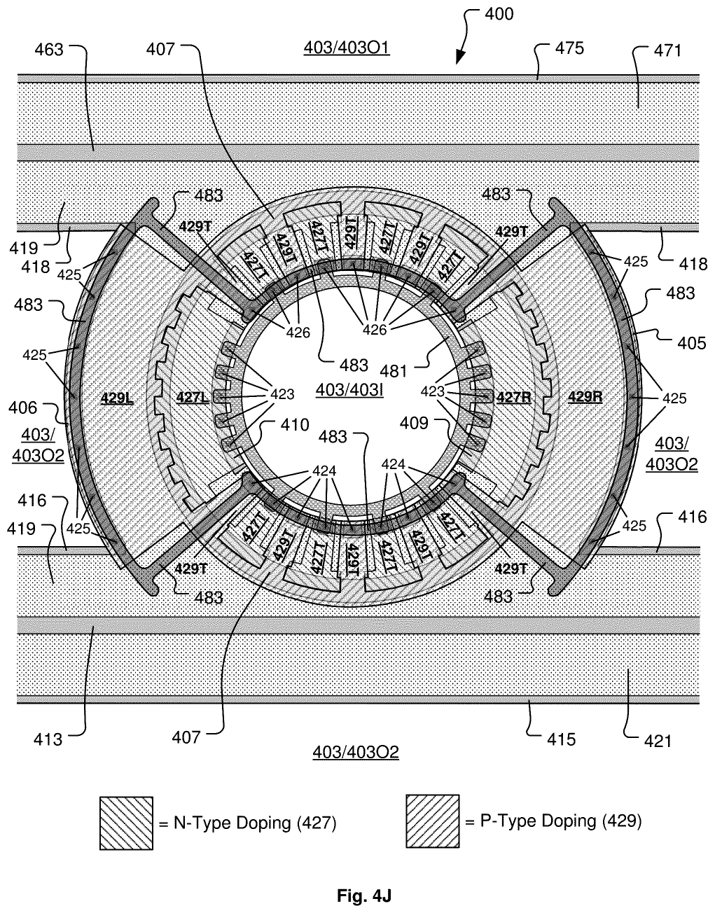

FIG. 4A shows a top view of a ring modulator 400 that implements a first interdigitated diode configuration within a first optical coupling region 420 and that implements a second interdigitated diode configuration within a second optical coupling region 470, in accordance with some embodiments. The first interdigitated diode configuration within the first optical coupling region 420 is formed by multiple tab-shaped N-type doping regions 427T and multiple tab-shaped P-type doping regions 429T, where the tab-shaped N-type doping regions 427T and the tab-shaped P-type doping regions 429T are alternately positioned with respect to each other. The first optical coupling region 420 is between a rib ring 407 of the ring modulator 400 and an optical waveguide 413. The rib ring 407 is a ring-shaped optical waveguide. The second optical coupling region 470 is between the rib ring 407 of the ring modulator 400 and an optical waveguide 463. The rib ring 407 is formed as a rib optical waveguide that loops back into itself. A portion of the rib ring 407 extends through the optical coupling region 420. Another portion of the rib ring 407 extends through the optical coupling region 470. The ring modulator 400 is configured to optimize modulation efficiency while minimizing optical loss in each of the optical waveguide 413 and the optical waveguide 463. The ring modulator 400 is positioned so that the rib ring 407 is located within an evanescent optical coupling distance from the optical waveguide 413. The ring modulator 400 is also positioned so that the rib ring 407 is located within an evanescent optical coupling distance from the optical waveguide 463. In some embodiments, the ring modulator 400, the optical waveguide 413, and the optical waveguide 463 configuration of FIG. 4A is implemented within a PIC.

The rib ring 407 and each of the optical waveguide 413 and the optical waveguide 463 are formed as respective full-height (full-thickness) silicon regions. The rib ring 407 is surrounded by a partial-height (partial-thickness) silicon region 419. More specifically, the partial-height silicon region 419 extends around an outside wall of the rib ring 407. The rib ring 407 itself surrounds a partial-height (partial-thickness) silicon region 417. More specifically, the partial-height silicon region 417 extends around an inside wall of the rib ring 407. The optical waveguide 413 is bracketed by the partial-height (partial-thickness) silicon region 419 on a side of the optical waveguide 413 that faces toward the ring modulator 400, and is bracketed by a partial-height (partial-thickness) silicon region 421 on a side of the optical waveguide 413 that faces away from the ring modulator 400. The partial-height silicon region 419 also extends between the rib ring 407 and the optical waveguide 413. The optical waveguide 463 is bracketed by the partial-height (partial-thickness) silicon region 419 on a side of the optical waveguide 463 that faces toward the ring modulator 400, and is bracketed by a partial-height (partial-thickness) silicon region 471 on a side of the optical waveguide 463 that faces away from the ring modulator 400. The partial-height silicon region 419 also extends between the rib ring 407 and the optical waveguide 463.

A full-height (full-thickness) silicon region 405 extends along an outer radial periphery of a portion of the partial-height silicon region 419 that extends along an azimuthal angular span 428 about a center 440 of the ring modulator 400 radially outside of the rib ring 407. The center 440 of the ring modulator 400 is also the center 440 of the ring shape of the rib ring 407. A full-height (full-thickness) silicon region 406 extends along an outer radial periphery of a portion of the partial-height silicon region 419 that extends along an azimuthal angular span 430 about the center 440 of the ring modulator 400 radially outside of the rib ring 407. A full-height (full-thickness) silicon region 416 extends along the partial-height silicon region 419 on a side of the partial-height silicon region 419 that is located away from the optical waveguide 413. A full-height (full-thickness) silicon region 415 extends along the partial-height silicon region 421 on a side of the partial-height silicon region 421 that is located away from the optical waveguide 413. A full-height (full-thickness) silicon region 418 extends along the partial-height silicon region 419 on a side of the partial-height silicon region 419 that is located away from the optical waveguide 463. A full-height (full-thickness) silicon region 475 extends along the partial-height silicon region 471 on a side of the partial-height silicon region 471 that is located away from the optical waveguide 463. Full-height (full-thickness) silicon regions 409, 410, 411, and 412 are formed along an inner side of the partial-height silicon region 417 that is located away from the rib ring 407.

The ring modulator 400 is formed within an optical cladding material 403 that includes an inner optical cladding material 4031, a first outer optical cladding material 40301, second outer optical cladding material 40302, and a third outer optical cladding material 40303. More specifically, in some embodiments, the inner optical cladding material 4031 is circumscribed by a combination of the full-height (full-thickness) silicon regions 409, 410, 411, and 412 and the partial-height silicon region 417. The first outer optical cladding material 40301 is present along a side of the full-height (full-thickness) silicon region 475 that is located away from the ring modulator 400. The second outer optical cladding material 40302 is present outside of the ring modulator 400 and between the full-height (full-thickness) silicon regions 416 and 418. The third outer optical cladding material 40303 is present along a side of the full-height (full-thickness) silicon region 415 that is located away from the ring modulator 400.

A number of inner electrical contacts 423 (shown as black dots) are formed in electrical connection with the full-height (full-thickness) silicon region 409 along the inner side of the partial-height silicon region 417 that is located away from the rib ring 407. A number of inner electrical contacts 423 (shown as black dots) are formed in electrical connection with the full-height (full-thickness) silicon region 410 along the inner side of the partial-height silicon region 417 that is located away from the rib ring 407. Also, a number of inner electrical contacts 424 (shown as black dots) are formed in electrical connection with the full-height (full-thickness) silicon regions 411, respectively, along the inner side of the partial-height silicon region 417 that is located away from the rib ring 407. Also, a number of inner electrical contacts 426 (shown as black dots) are formed in electrical connection with the full-height (full-thickness) silicon regions 412, respectively, along the inner side of the partial-height silicon region 417 that is located away from the rib ring 407. Also, a number outer electrical contacts 425 (shown as black dots) are formed in electrical connection with the full-height (full-thickness) silicon region 405 that extends along the outer radial periphery of the portion of the partial-height silicon region 419 that extends radially around the rib ring 407. Also, a number outer electrical contacts 425 (shown as black dots) are formed in electrical connection with the full-height (full-thickness) silicon region 406 that extends along the outer radial periphery of the portion of the partial-height silicon region 419 that extends radially around the rib ring 407.

The ring modulator 400 has an N-type doping region 427R that includes portions of the rib ring 407, portions of the partial-height silicon region 417, and the full-height (full-thickness) silicon region 409. The ring modulator 400 also has an N-type doping region 427L that includes portions of the rib ring 407, portions of the partial-height silicon region 417, and the full-height (full-thickness) silicon region 410. The ring modulator 400 also has a number of tab-shaped N-type doping regions 427T that each project inward from the rib ring 407 toward the center 440 of the ring modulator 400 to form respective portions of the interdigitated diode configuration within the optical coupling region 420. Each of the tab-shaped N-type doping regions 427T within the optical coupling region 420 includes a corresponding portion of the rib ring 407, a corresponding portion of the partial-height silicon region 417, and a corresponding one of the full-height (full-thickness) silicon regions 411. Similarly, the ring modulator 400 has a number of tab-shaped N-type doping regions 427T that each project inward from the rib ring 407 toward the center 440 of the ring modulator 400 to form respective portions of the interdigitated diode configuration within the optical coupling region 470. Each of the tab-shaped N-type doping regions 427T within the optical coupling region 470 includes a corresponding portion of the rib ring 407, a corresponding portion of the partial-height silicon region 417, and a corresponding one of the full-height (full-thickness) silicon regions 412.

The ring modulator 400 has a P-type doping region 429R that includes portions of the rib ring 407, portions of the partial-height silicon region 419, and the full-height (full-thickness) silicon region 405. The ring modulator 400 also has a P-type doping region 429L that includes portions of the rib ring 407, portions of the partial-height silicon region 419, and the full-height (full-thickness) silicon region 406. The ring modulator 400 also has a number of tab-shaped P-type doping regions 429T that each project inward from the rib ring 407 toward the center 440 of the ring modulator 400 to form respective portions of the interdigitated diode configuration within the optical coupling region 420. Each of the tab-shaped P-type doping regions 429T within the optical coupling region 420 includes a corresponding portion of the rib ring 407, a corresponding portion of the partial-height silicon region 417, and a corresponding one of the full-height (full-thickness) silicon regions 411. Similarly, the ring modulator 400 has a number of tab-shaped P-type doping regions 429T that each project inward from the rib ring 407 toward the center 440 of the ring modulator 400 to form respective portions of the interdigitated diode configuration within the optical coupling region 470. Each of the tab-shaped N-type doping regions 429T within the optical coupling region 470 includes a corresponding portion of the rib ring 407, a corresponding portion of the partial-height silicon region 417, and a corresponding one of the full-height (full-thickness) silicon regions 412.

The tab-shaped N-type doping regions 427T and the tab-shaped P-type doping regions 429T alternate in placement with respect to each other along the curvature of the rib ring 407 within the optical coupling region 420. In this manner, the tab-shaped N-type doping regions 427T and the tab-shaped P-type doping regions 429T collectively form the interdigitated diode configuration within the optical coupling region 420. Also, the tab-shaped N-type doping regions 427T and the tab-shaped P-type doping regions 429T alternate in placement with respect to each other along the curvature of the rib ring 407 within the optical coupling region 470. In this manner, the tab-shaped N-type doping regions 427T and the tab-shaped P-type doping regions 429T collectively form the interdigitated diode configuration within the optical coupling region 470. In some embodiments, adjacently positioned ones of the tab-shaped N-type doping regions 427T and the tab-shaped P-type doping regions 429T are separated from each other by a non-doped portion of the partial-height silicon region 417.

The N-type doping regions 427T and the P-type doping region 429T interface with each other within the rib ring 407 to form a portion of a PN junction diode within the optical coupling region 420. Similarly, the N-type doping regions 427T and the P-type doping region 429T interface with each other within the rib ring 407 to form a portion of the PN junction diode within the optical coupling region 470. Also, the N-type doping regions 427R and the P-type doping region 429R interface with each other within the rib ring 407 to form a portion of the PN junction diode. Similarly, the N-type doping regions 427L and the P-type doping region 429L interface with each other within the rib ring 407 to form a portion of the PN junction diode. The tab-shaped N-type doping regions 427T and the tab-shaped P-type doping regions 429T within the optical coupling region 420 provide respective electrically conductive pathways from the PN junction diode within the rib ring 407 to respective ones of the inner electrical contacts 424. In this manner, the N-type doping regions 427T of the PN junction diode within the rib ring 407, within the optical coupling region 420, are electrically connected to a first node of an electrical circuit through corresponding inner electrical contacts 424. Also, the P-type doping regions 429T of the PN junction diode within the rib ring 407, within the optical coupling region 420, are electrically connected to a second node of an electrical circuit through corresponding inner electrical contacts 424. Additionally, the tab-shaped N-type doping regions 427T and the tab-shaped P-type doping regions 429T within the optical coupling region 470 provide respective electrically conductive pathways from the PN junction diode within the rib ring 407 to respective ones of the inner electrical contacts 426. In this manner, the N-type doping regions 427T of the PN junction diode within the rib ring 407, within the optical coupling region 470, are electrically connected to the first node of the electrical circuit through corresponding inner electrical contacts 426. Also, the P-type doping regions 429T of the PN junction diode within the rib ring 407, within the optical coupling region 470, are electrically connected to the second node of the electrical circuit through corresponding inner electrical contacts 426.

In the ring modulator 400, the PN junction diode formed within the rib ring 407 extends through the optical coupling region 420 as indicated by arrow 422. Also, the PN junction diode formed within the rib ring 407 extends from the optical coupling region 420 to the optical coupling region 470 as indicated by arrow 428. Also, the PN junction diode formed within the rib ring 407 extends through the optical coupling region 470 as indicated by arrow 472. Also, the PN junction diode formed within the rib ring 407 extends from the optical coupling region 470 to the optical coupling region 420 as indicated by arrow 430. Additionally, in some embodiments, such as shown in FIG. 4A, the PN junction diode interface within the rib ring 407 between the N-type doping region 427R and the P-type doping region 429R is formed in a serpentine configuration 443, e.g., gear-tooth-shaped configuration, in order to increase the overall interface area of the PN junction diode within the rib ring 407. Also, in some embodiments, such as shown in FIG. 4A, the PN junction diode interface within the rib ring 407 between the N-type doping region 427L and the P-type doping region 429L is formed in a serpentine configuration 445, e.g., gear-tooth-shaped configuration, in order to increase the overall interface area of the PN junction diode within the rib ring 407.

FIGS. 4B through 4J show a succession of fabrication processes performed to arrive at the example ring modulator 400 of FIG. 4A, in accordance with some embodiments. FIG. 4B shows a top view of a configuration of full-height (full-thickness) silicon 401 formed within the cladding material 403, in accordance with some embodiments. A portion of the configuration of full-height (full-thickness) silicon 401 is used to form the ring modulator 400. Another portion of the configuration of full-height (full-thickness) silicon 401 is used to form the optical waveguides 413 and 463 that extend past the ring modulator 300.

FIG. 4C shows a top view of the configuration of full-height (full-thickness) silicon 401 with portions of the full-height (full-thickness) silicon 401 etched away to form the partial-height (partial-thickness) silicon regions 417, 419, 421, and 471, in accordance with some embodiments. The thickness of the partial-height (partial-thickness) silicon regions 417, 419, 421, and 471 is less than the thickness of the full-height (full-thickness) silicon 401. The partial-height (partial-thickness) silicon regions 417, 419, 421, and 471 are configured and positioned such that a first remaining portion of the full-height (full-thickness) silicon 401 forms the rib ring 407, and such that a second remaining portion of the full-height (full-thickness) silicon 401 forms the outer silicon regions 405 and 406, and such that a third remaining portion of the full-height (full-thickness) silicon 401 forms the inner silicon regions 409, 410, 411, and 412, and such that a fourth remaining portion of the full-height (full-thickness) silicon 401 forms the optical waveguide 413, and such that a fifth remaining portion of the full-height (full-thickness) silicon 401 forms the full-height (full-thickness) silicon region 416, and such that a sixth remaining portion of the full-height (full-thickness) silicon 401 forms the full-height (full-thickness) silicon region 415, and such that a seventh remaining portion of the full-height (full-thickness) silicon 401 forms the optical waveguide 463, and such that a eighth remaining portion of the full-height (full-thickness) silicon 401 forms the full-height (full-thickness) silicon region 418, and such that a ninth remaining portion of the full-height (full-thickness) silicon 401 forms the full-height (full-thickness) silicon region 475.

FIG. 4D shows a top view of the partially formed ring modulator 400 of FIG. 4C with formation of the inner electrical contacts 423, the inner electrical contacts 424, the inner electrical contacts 426, and the outer electrical contacts 425, in accordance with some embodiments. The inner electrical contacts 423 are formed in electrical connection with the inner full-height (full-thickness) silicon regions 409 and 410. The inner electrical contacts 424 are formed in electrical connection with the inner full-height (full-thickness) silicon regions 411, respectively. The inner electrical contacts 426 are formed in electrical connection with the inner full-height (full-thickness) silicon regions 412, respectively. The outer electrical contacts 425 are formed in electrical connection with the outer full-height (full-thickness) silicon regions 405 and 406. In some embodiments, the inner electrical contacts 423 are substantially uniformly azimuthally spaced about the center 440 of the ring modulator 400 along each of the inner full-height (full-thickness) silicon regions 409 and 410. In some embodiments, the outer electrical contacts 425 are substantially uniformly azimuthally spaced about the center 440 of the ring modulator 400 along each of the outer full-height (full-thickness) silicon regions 405 and 406.

FIG. 4E shows a top view of the partially formed ring modulator 400 of FIG. 4D with formation of the N-type doping regions 427L and 427R, and the tab-shaped N-type doping regions 427T, in accordance with some embodiments. The N-type doping region 427R is formed within the silicon of the inner full-height (full-thickness) silicon region 409, and within the partial-height (partial-thickness) silicon region 417 that extends along the inner full-height (full-thickness) silicon region 409, and within an adjoining portion of the rib ring 407. The N-type doping region 427R is electrically connected to the inner electrical contacts 423 by way of the inner full-height (full-thickness) silicon region 409. The N-type doping region 427L is formed within the silicon of the inner full-height (full-thickness) silicon region 410, and within the partial-height (partial-thickness) silicon region 417 that extends along the inner full-height (full-thickness) silicon region 410, and within an adjoining portion of the rib ring 407. The N-type doping region 427L is electrically connected to the inner electrical contacts 423 by way of the inner full-height (full-thickness) silicon region 410. The tab-shaped N-type doping regions 427T are formed within the optical coupling region 420, such that each of the tab-shaped N-type doping regions 427T includes a respective portion of the rib ring 407, and extends inward across the partial-height (partial-thickness) silicon region 417 toward the center 440 of the ring modulator 400, and includes a corresponding one of the full-height (full-thickness) silicon regions 411, so as to electrically connect with a corresponding one of the inner electrical contacts 424. The tab-shaped N-type doping regions 427T are also formed within the optical coupling region 470, such that each of the tab-shaped N-type doping regions 427T includes a respective portion of the rib ring 407, and extends inward across the partial-height (partial-thickness) silicon region 417 toward the center 440 of the ring modulator 400, and includes a corresponding one of the full-height (full-thickness) silicon regions 412, so as to electrically connect with a corresponding one of the inner electrical contacts 426. FIG. 4F shows an isolated top view of the N-type doping regions 427L and 427R, and the tab-shaped N-type doping regions 427T, in accordance with some embodiments.

FIG. 4A shows the top view of the ring modulator 400 of FIG. 4E with formation of the P-type doping regions 429L and 429R, and the tab-shaped P-type doping regions 429T, in accordance with some embodiments. The P-type doping region 429R is formed within the silicon of the outer full-height (full-thickness) silicon region 405, and within the partial-height (partial-thickness) silicon region 419 that extends along the outer full-height (full-thickness) silicon region 405, and within an adjoining portion of the rib ring 407. The P-type doping region 429R is electrically connected to the outer electrical contacts 425 by way of the outer full-height (full-thickness) silicon region 405. The P-type doping region 429L is formed within the silicon of the outer full-height (full-thickness) silicon region 406, and within the partial-height (partial-thickness) silicon region 419 that extends along the outer full-height (full-thickness) silicon region 406, and within an adjoining portion of the rib ring 407. The P-type doping region 429L is electrically connected to the outer electrical contacts 425 by way of the outer full-height (full-thickness) silicon region 406. The tab-shaped P-type doping regions 429T are formed within the optical coupling region 420, such that each of the tab-shaped P-type doping regions 429T includes a respective portion of the rib ring 407, and extends inward across the partial-height (partial-thickness) silicon region 417 toward the center 440 of the ring modulator 400, and includes a corresponding one of the full-height (full-thickness) silicon regions 411, so as to electrically connect with a corresponding one of the inner electrical contacts 424. The tab-shaped P-type doping regions 429T are also formed within the optical coupling region 470, such that each of the tab-shaped P-type doping regions 429T includes a respective portion of the rib ring 407, and extends inward across the partial-height (partial-thickness) silicon region 417 toward the center 440 of the ring modulator 400, and includes a corresponding one of the full-height (full-thickness) silicon regions 412, so as to electrically connect with a corresponding one of the inner electrical contacts 426. The tab-shaped P-type doping regions 429T and the P-type doping regions 429L and 429R are integrally formed with each other, so as to be electrically connected to each other. FIG. 4G shows an isolated top view of the P-type doping regions 429L and 429R, and the tab-shaped P-type doping regions 429T, in accordance with some embodiments.

FIG. 4H shows an isolated top view of the P-type doping regions 429L and 429R and the tab-shaped P-type doping regions 429T positioned in relation with the N-type doping regions 427L and 427R and the tab-shaped N-type doping regions 427T, in accordance with some embodiments. In some embodiments, such as shown in FIGS. 4H and 4A, adjacently formed ones of the tab-shaped P-type doping regions 429T and the tab-shaped N-type doping regions 427T are interfaced with each other within the rib ring 407 to for the PN junction diode interface within the rib ring 407, but are spaced apart from each other over the partial-height (partial-thickness) silicon region 417 and over the full-height (full-thickness) silicon regions 411 and 412, so as to form separate electrical conduction pathways.

FIG. 4I shows a top view of the ring modulator 400 with the N-type doping regions 427L and 427R, and the tab-shaped N-type doping regions 427T electrically connected to a first electrical node by way of an electrical conductor 481, in accordance with some embodiments. The electrical conductor 481 is electrically connected to the inner electrical contacts 423, 424, and 426 that are electrically connected to one of N-type doping regions 427R, 427L, and 427T.

FIG. 4J shows a top view of the ring modulator 400 of FIG. 4I with the P-type doping regions 429L and 429R, and the tab-shaped P-type doping regions 429T electrically connected to a second electrical node by way of an electrical conductor 483, in accordance with some embodiments. The electrical conductor 483 is electrically connected to the inner electrical contacts 424 and 426 that are electrically connected to one of N-type doping regions 429T. Also, the electrical conductor 483 is electrically connected to the outer electrical contacts 425.

Each of the P-type doping regions 429L and 429R, the tab-shaped P-type doping regions 429T, the N-type doping regions 427L and 427R, and the tab-shaped N-type doping regions 427T is doped with impurity ions to form the lateral PN junction diode. In some embodiments, the P-type doping regions 429L and 429R and tab-shaped P-type doping regions 429T are doped with acceptor impurity atoms, and the N-type doping regions 427L and 427R and the tab-shaped N-type doping regions 427T are doped with donor impurity atoms. In this manner, the N-type doping regions 427L, 427R, 427T and the P-type doping regions 429L, 429R, 429T are doped with opposite polarity. The interface between the N-type doping regions 427L, 427R, 427T and the P-type doping regions 429L, 429R, 429T within the rib ring 407 is the PN junction of the lateral PN junction diode. At the PN junction within the rib ring 407, the free electrons diffuse into the P-type doping regions 429L, 429R, 429T, and the holes (electron vacancies) diffuse into the N-type doping regions 427L, 427R, 427T, which causes a depletion region to form along the PN junction within the rib ring 407. It should be appreciated that in the ring modulator 400, the PN junction diode formed by the P-type doping regions 429L, 429R, 429T, and the N-type doping region 427L, 427R, 427T extends through both the optical coupling region 420 and the optical coupling region 470. Within the optical coupling region 420, the tab-shaped N-type doping regions 427T formed within the partial-height (partial-thickness) silicon region 417 provide respective electrically conductive paths between the inner electrical contacts 424 and the depletion region formed along the PN junction within the rib ring 407. Also, within the optical coupling region 420, the tab-shaped P-type doping regions 427T formed within the partial-height (partial-thickness) silicon region 417 provide respective electrically conductive paths between the inner electrical contacts 424 and the depletion region formed along the PN junction within the rib ring 407. Within the optical coupling region 470, the tab-shaped N-type doping regions 427T formed within the partial-height (partial-thickness) silicon region 417 provide respective electrically conductive paths between the inner electrical contacts 426 and the depletion region formed along the PN junction within the rib ring 407. Also, within the optical coupling region 470, the tab-shaped P-type doping regions 429T formed within the partial-height (partial-thickness) silicon region 417 provide respective electrically conductive paths between the inner electrical contacts 426 and the depletion region formed along the PN junction within the rib ring 407. Along the rib ring 407 between the optical coupling region 420 and the optical coupling region 470, the N-type doping regions 427L and 427R formed within the partial-height (partial-thickness) silicon region 417 provide electrically conductive paths between the inner electrical contacts 423 and the depletion region formed along the PN junction within the rib ring 407. Also, along the rib ring 407 between of the optical coupling region 420 and the optical coupling region 470, the P-type doping regions 429L and 429R formed within the partial-height (partial-thickness) silicon region 419 provide electrically conductive paths between the outer electrical contacts 425 and the depletion region formed along the PN junction within the rib ring 407.

In some embodiments, with the lateral PN junction diode within the rib ring 407 electrically connected in a reverse-biased manner to an electrical voltage source, the inner electrical contacts 423 of the N-type doping regions 427L and 427R and the inner electrical contacts 424 and 426 of the tab-shaped N-type doping regions 427T are electrically connected to the anode of the electrical voltage source. Also, in some embodiments, with the lateral PN junction diode within the rib ring 407 electrically connected in a reverse-biased manner to the electrical voltage source, the outer electrical contacts 425 of the P-type doping regions 429L and 429R and the inner electrical contacts 424 and 426 of the tab-shaped P-type doping regions 429T are electrically connected to the cathode of the electrical voltage source. The outer electrical contacts 425 are positioned far enough from the rib ring 407 to reduce optical absorption of the light traveling through the rib ring 407 by metal and silicided regions that form the outer electrical contacts 425. Also, the inner electrical contacts 424 and 426 are positioned far enough from the rib ring 407 to reduce optical absorption of the light traveling through the rib ring 407 by metal and silicided regions that form the inner electrical contacts 424 and 324.

In the ring modulator 400, the lateral PN junction diode extends into the optical coupling region 420 of the ring modulator 400 without adversely affecting optical absorption loss in the optical waveguide 413 to which the ring modulator 400 is optically coupled. Also, positioning of the tab-shaped N-type doping regions 427T and the tab-shaped P-type doping regions 429T on the inside of the rib ring 407 so as to extend toward the center 440 of ring modulator 400 enables the lateral PN junction diode to extend through the optical coupling region 420 of the ring modulator 400 without adversely affecting optical absorption loss in the optical waveguide 413 to which the ring modulator 400 is optically coupled. Additionally, by having the multiple tab-shaped N-type doping regions 427T and tab-shaped P-type doping regions 429T alternatively positioned along the arc of the rib ring 407 within the optical coupling region 420, the electrical series resistance in the lateral PN junction diode of the ring modulator 400 is not adversely increased by having the lateral PN junction diode extend through the optical coupling region 420.

In the ring modulator 400, the lateral PN junction diode extends into the optical coupling region 470 of the ring modulator 400 without adversely affecting optical absorption loss in the optical waveguide 463 to which the ring modulator 400 is optically coupled. Also, positioning of the tab-shaped N-type doping regions 427T and the tab-shaped P-type doping regions 429T on the inside of the rib ring 407 so as to extend toward the center 440 of ring modulator 400 enables the lateral PN junction diode to extend through the optical coupling region 470 of the ring modulator 400 without adversely affecting optical absorption loss in the optical waveguide 463 to which the ring modulator 400 is optically coupled. Additionally, by having the multiple tab-shaped N-type doping regions 427T and tab-shaped P-type doping regions 429T alternatively positioned along the arc of the rib ring 407 within the optical coupling region 470, the electrical series resistance in the lateral PN junction diode of the ring modulator 400 is not adversely increased by having the lateral PN junction diode extend through the optical coupling region 470.

The ring modulator 400 uses the interdigitated PN junction diode design (interdigitation of the tab-shaped N-type doping regions 427T and the tab-shaped P-type doping regions 429T) in the portions of the rib ring 407 that pass through each of the optical coupling regions 420 and 470, while using a different non-interdigitated PN junction diode design in the portion of the rib ring 407 that does not pass through the optical coupling regions 420 or 470. Within the optical coupling region 420, the inner electrical contacts 424 are positioned along the inner region of the ring modulator 400, far from the rib ring 407 and even farther from the optical waveguide 413, so as to avoid optical absorption loss in the coupling optical waveguides 407 and 413. Similarly, within the optical coupling region 470, the inner electrical contacts 426 are positioned along the inner region of the ring modulator 400, far from the rib ring 407 and even farther from the optical waveguide 463, so as to avoid optical absorption loss in the coupling optical waveguides 407 and 463. The interdigitated tab-shaped N-type doping regions 427T and tab-shaped P-type doping regions 429T alternate polarity (alternate cathode and anode) within each of the optical coupling regions 420 and 470. It should be understood that there is more flexibility in the design of the portions of the ring modulator 400 that are away from the optical coupling regions 420 and 470. For example, in the regions of the ring modulator 400 away from the optical coupling regions 420 and 470, the inner electrical contacts 423 and the N-type doping regions 427L and 427R are placed on the inner side of the rib ring 407, and the outer electrical contacts 425 and the P-type doping regions 429L and 429R are placed on the outer side of the rib ring 407, so as to reduce and/or minimize the series electrical resistance of the ring modulator 400. All of the inner electrical contacts 423 that are electrically connected to the N-type doping regions 427L and 427R and all of the inner electrical contacts 424 and 426 that are connected to a corresponding one of the tab-shaped N-type doping regions 427T are collectively electrically connected to a same first electrical node. Similarly, all of the outer electrical contacts 425 that are electrically connected to the P-type doping regions 429L and 429R and all of the inner electrical contacts 424 and 426 that are connected to a corresponding one of the tab-shaped P-type doping regions 429T are collectively electrically connected to a same second electrical node that is different and electrically separated from the first electrical node. In various embodiments, electrically conductive structures, e.g., metal traces/wires, and electrically conductive via structures are formed in and/or through different levels of the semiconductor device in which the ring modulator 400 is formed in order to electrically connect all of the inner electrical contacts 423 that are electrically connected to the N-type doping regions 427L and 427R and all of the inner electrical contacts 424 and 426 that are connected to a corresponding one of the tab-shaped N-type doping regions 427T to the same first electrical node, such as exemplified by the electrical conductor 481. In various embodiments, electrically conductive structures, e.g., metal traces/wires, and electrically conductive via structures are formed in and/or through different levels of the semiconductor device in which the ring modulator 400 is formed in order to electrically connect all of the outer electrical contacts 425 that are electrically connected to the P-type doping regions 429L and 429R and all of the inner electrical contacts 424 and 426 that are connected to a corresponding one of the tab-shaped P-type doping regions 429T to the same second electrical node, such as exemplified by the electrical conductor 483.

In accordance with the foregoing, the ring resonator 400 includes a built-in diode for modulating an optical signal propagating through the optical waveguide 413 and/or the optical waveguide 463. The optical mode supported by the ring resonator 400 has significant power density that overlaps the depletion region of the PN junction diode within the rib ring 407. By changing the voltage differential between the anode and cathode of the PN junction diode within the rib ring 407, charge carriers can be added to or removed from the depletion region of the PN junction within the rib ring 407 in a controlled manner, which provides for changing of the refractive index and optical absorption coefficient of the rib ring 407 in a controlled manner by way of the plasma effect, which in turn provides for controlled changing of the amplitude and phase of the light that is transmitted on through the optical waveguide 413 and/or the optical waveguide 463 past the ring modulator 400. In some embodiments, the PN junction diode within the rib ring 407 of the ring modulator 400 is operated in a reversed bias manner to enable fast charge transport and correspondingly high optical modulation data rates.

In some embodiments, the optical waveguide 413 and/or the optical waveguide 463 carries multiple wavelength channels of light, with only one of the multiple wavelength channels of light being coupled into and modulated by the ring resonator 400. In some embodiments, such as in WDM systems, multiple instances of the ring resonator 400 are optically coupled to the same optical waveguide 413 and/or the optical waveguide 463, with each of the ring resonators 400 tuned to modulate a different one of the multiple wavelength channels of light propagating through the optical waveguide 413 and/or the optical waveguide 463. The metal of the inner electrical contacts 424 and 426 absorbs light across all wavelengths. Therefore, by having the inner electrical contacts 424 and 426 positioned away from the optical waveguides 413 and 463, respectively, e.g., by a distance greater than or equal to about one micrometer, within each instance of the ring modulator 400, it is possible to avoid introduction and accumulation of excess absorption loss of the light propagating through the optical waveguides 413 and 463, respectively, across every wavelength channel of light.

In some embodiments, the either the optical waveguide 413 or the optical waveguide 463 is utilized as a drop port optical waveguide to tap off a small fraction of the optical power in the ring modulator 400 into a separate photodiode (photodetector) in order to monitor the optical power within the ring modulator 400. It should be appreciated that the electrical contacts 424 and 426 and associated wiring are positioned so as to avoid introducing adverse optical absorption loss into the optical waveguide 413 or 463 that is being utilized as the drop port optical waveguide, which allows for sufficient optical power to reach the photodiode to enable monitoring of optical power within the ring modulator 400.

It should be appreciated that the ring modulator 400 configuration is particularly important for applications in which the wavelength spacing requires ring modulators with relatively high free spectral range (FSR), for which the ring modulator must have a relatively small radius. In such applications the fractional angle of the optical coupling region 420 and/or 470 may be as much as half the angular region of the ring modulator 400. The interdigitated PN junction diode design of the ring modulator 400 provides for acceptable modulation efficiency even when such large angular spans are required for the optical absorption region 420 and/or 470 due to the ring modulator 400 having a relatively small radius, because the interdigitated PN junction diode extends through the optical absorption region 420 and/or 470.

FIGS. 4A through 4J show a portion of a photonic integrated circuit. The photonic integrated circuit includes a first optical waveguide 407 that has a ring shape. The first optical waveguide 407 is formed of silicon and has a first vertical height. The photonic integrated circuit also includes an inner silicon region 417 formed circumferentially along an inner side of the first optical waveguide 407. The inner silicon region 417 has a second vertical height that is less than the first vertical height of the first optical waveguide 407. The photonic integrated circuit also includes a second optical waveguide 413 configured to semi-tangentially approach an outer side of the first optical waveguide 407 and extend past the first optical waveguide 407 at a first location (of closest approach), such that a first optical coupling region 420 exists between a portion of the second optical waveguide 413 and a first portion of the first optical waveguide 407 about the first location (of closest approach). The photonic integrated circuit also includes a third optical waveguide 463 configured to semi-tangentially approach the outer side of the first optical waveguide 407 and extend past the first optical waveguide 407 at a second location (of closest approach) that is diametrically opposed to the first location (of closest approach of the second optical waveguide 413) with regard to the ring shape of the first optical waveguide 407, such that a second optical coupling region 470 exists between a portion of the third optical waveguide 463 and a second portion of the first optical waveguide 407 about the second location (of closest approach).

The photonic integrated circuit also includes an N-type doping region 427 formed within the first optical waveguide 407 and the inner silicon region 417. The N-type doping region 427 includes a first set of multiple tab-shaped N-type doping regions 427T formed within the first optical coupling region 420. The N-type doping region 427 includes a second set of multiple tab-shaped N-type doping regions 427T formed within the second optical coupling region 470. Each of the tab-shaped N-type doping regions 427T in the first and second sets of multiple tab-shaped N-type doping regions 427T is formed to project inward toward a center 440 of the ring shape of the first optical waveguide 407.

The photonic integrated circuit also includes a P-type doping region 429 formed within the first optical waveguide 407 and the inner silicon region 417. The P-type doping region 429 including a first set of multiple tab-shaped P-type doping regions 429T formed within the first optical coupling region 420. The P-type doping region 429 includes a second set of multiple tab-shaped P-type doping regions 429T formed within the second optical coupling region 470. Each of the tab-shaped P-type doping regions 429T in the first and second sets of multiple tab-shaped P-type doping regions 429T is formed to project inward toward the center 440 of the ring shape of the first optical waveguide 407.

Positions of the first set of multiple tab-shaped N-type doping regions 427T alternate with positions of the first set of multiple tab-shaped P-type doping regions 429T along the first portion of the first optical waveguide 407, such that the first set of multiple tab-shaped N-type doping regions 427T and the first set of multiple tab-shaped P-type doping regions 429T collectively form a first interdigitated PN diode configuration within the first optical waveguide 407 within the first optical coupling region 420. Positions of the second set of multiple tab-shaped N-type doping regions 427T alternate with positions of the second set of multiple tab-shaped P-type doping regions 429T along the second portion of the first optical waveguide 407, such that the second set of multiple tab-shaped N-type doping regions 427T and the second set of multiple tab-shaped P-type doping regions 429T collectively form a second interdigitated PN diode configuration within the first optical waveguide 407 within the second optical coupling region 470.

The N-type doping region 427 includes a first connecting portion 427C1 that is formed within the first optical waveguide 407 through the first optical coupling region 420 and that is contiguously formed with each of the first set of multiple tab-shaped N-type doping regions 427T within the first optical coupling region 420. The P-type doping region 429 includes a first connecting portion 429C1 that is formed within the first optical waveguide 407 through the first optical coupling region 420 and that is contiguously formed with each of the first set of multiple tab-shaped P-type doping regions 429T within the first optical coupling region 420. The N-type doping region 427 includes a second connecting portion 427C2 that is formed within the first optical waveguide 407 through the second optical coupling region 470 and that is contiguously formed with each of the second set of multiple tab-shaped N-type doping regions 427T within the second optical coupling region 470. The P-type doping region 429 includes a second connecting portion 429C2 that is formed within the first optical waveguide 407 through the second optical coupling region 470 and that is contiguously formed with each of the second set of multiple tab-shaped P-type doping regions 429T within the second optical coupling region 470. Adjacently positioned ones of the first set of multiple tab-shaped N-type doping regions 427T and the first set of multiple tab-shaped P-type doping regions 429T are physically separated from each other within the first optical coupling region 420. Adjacently positioned ones of the second set of multiple tab-shaped N-type doping regions 427T and the second set of multiple tab-shaped P-type doping regions 429T are physically separated from each other within the second optical coupling region 470. The first connecting portion 427C1 of the N-type doping region 427 is in physical contact with the first connecting portion 429C1 of the P-type doping region 429 within the first optical waveguide 407. The second connecting portion 427C2 of the N-type doping region 427 is in physical contact with the second connecting portion 429C2 of the P-type doping region 429 within the first optical waveguide 407. In some embodiments, the first connecting portion 429C1 of the P-type doping region 429 extends below the first connecting portion 427C1 of the N-type doping region 427, and the second connecting portion 429C2 of the P-type doping region 429 extends below the second connecting portion 427C2 of the N-type doping region 427. In some embodiments, the first connecting portion 427C1 of the N-type doping region 427 is circumscribed by an annular segment of the first connecting portion 429C1 of the P-type doping region 429. Also, in some embodiments, the second connecting portion 427C2 of the N-type doping region 427 is circumscribed by an annular segment of the second connecting portion 429C2 of the P-type doping region 429.

The photonic integrated circuit also includes a first set of multiple inner electrical contacts 424 respectively physically connected to each of the first set of multiple tab-shaped N-type doping regions 427T and each of the first set of multiple tab-shaped P-type doping regions 429T within the first optical coupling region 420. The photonic integrated circuit also includes a second set of multiple inner electrical contacts 426 respectively physically connected to each of the second set of multiple tab-shaped N-type doping regions 427T and each of the second set of multiple tab-shaped P-type doping regions 429T within the second optical coupling region 470. Each of the first set of multiple inner electrical contacts 424 and each of the second set of multiple inner electrical contacts 426 is positioned at an inner edge of the inner silicon region 417 relative to the center 440 of the ring shape of the first optical waveguide 407. The first set of multiple tab-shaped N-type doping regions 427T within the first optical coupling region 420 are electrically connected to a first electrical node by way of corresponding ones of the first set of multiple inner electrical contacts 424. Also, the first set of multiple tab-shaped P-type doping regions 429T within the first optical coupling region 420 are electrically connected to a second electrical node by way of corresponding ones of the first set of multiple inner electrical contacts 424. The second electrical node is electrically separated from the first electrical node. The second set of multiple tab-shaped N-type doping regions 427T within the second optical coupling region 470 are electrically connected to a third electrical node by way of corresponding ones of the second set of multiple inner electrical contacts 426. Also, the second set of multiple tab-shaped P-type doping regions 429T within the second optical coupling region 470 are electrically connected to a fourth electrical node by way of corresponding ones of the second set of multiple inner electrical contacts 426. The fourth electrical node is electrically separated from the third electrical node. In some embodiments, the first electrical node is electrically connected to an anode of a first electrical voltage source, and the second electrical node is electrically connected to a cathode of the first electrical voltage source, such that the first interdigitated PN diode configuration is reverse-biased. Also, in some embodiments, the third electrical node is electrically connected to an anode of a second electrical voltage source, and the fourth electrical node is electrically connected to a cathode of the second electrical voltage source, such that the second interdigitated PN diode configuration is reverse-biased.

The photonic integrated circuit also includes an outer silicon region 419 formed circumferentially along the outer side of the first optical waveguide 407. In some embodiments, the outer silicon region 419 is not doped. The outer silicon region 419 is formed between the first optical waveguide 407 and the second optical waveguide 413. The outer silicon region 419 is also formed between the first optical waveguide 407 and the third optical waveguide 463. The outer silicon region 419 has a third vertical height that is less than the first vertical height of the first optical waveguide 407. In some embodiments, the third vertical height of the outer silicon region 419 is substantially equal to the second vertical height of the inner silicon region 417. In some embodiments, a vertical height of the second optical waveguide 413 is substantially equal to the first vertical height of the first optical waveguide 407. Also, in some embodiments, a vertical height of the third optical waveguide 463 is substantially equal to the first vertical height of the first optical waveguide 407.

In some embodiments, the first optical waveguide 407, the second optical waveguide 413, the third optical waveguide 463, the outer silicon region 419, and the inner silicon region 417 are respective parts of a contiguous silicon structure. The contiguous silicon structure has a planar bottom surface that forms a respective bottom surface of each of the first optical waveguide 407, the second optical waveguide 413, the third optical waveguide 463, the outer silicon region 419, and the inner silicon region 417. In some embodiments, the outer silicon region 419 and the inner silicon region 417 are etched regions of the contiguous silicon structure.

The N-type doping region 427 includes a first central portion 427L that is contiguously formed within the inner silicon region 417 along a first azimuthal angular span 430 about the center 440 of the ring shape of the first optical waveguide 407 between the first and second interdigitated PN diode configurations. The P-type doping region 429 includes a first central portion 429L that is contiguously formed within the outer silicon region 419 along the first azimuthal angular span 430. The N-type doping region 427 includes a second central portion 427R that is contiguously formed within the inner silicon region 417 along a second azimuthal angular span 428 about the center 440 of the ring shape of the first optical waveguide 407 between the first and second interdigitated PN diode configurations. The P-type doping region 429 includes a second central portion 429R that is contiguously formed within the outer silicon region 419 along the second azimuthal angular span 428. A location of the second azimuthal angular span 428 is diametrically opposed to a location of the first azimuthal angular span 430 with regard to the ring shape of the first optical waveguide 407. The first central portion 427L of the N-type doping region 427 and the first central portion 429L of the P-type doping region 429 interface with each other to form a first continuous PN diode configuration within the first optical waveguide 407 along the first azimuthal angular span 430. The second central portion 427R of the N-type doping region 427 and the second central portion 429R of the P-type doping region 429 interface with each other to form a second continuous PN diode configuration within the first optical waveguide 407 along the second azimuthal angular span 428. In some embodiments, an interface between the first central portion 427L of the N-type doping region 427 and the first central portion 429L of the P-type doping region 429 has a serpentine configuration along the first azimuthal angular span 430. In some embodiments, an interface between the second central portion 427R of the N-type doping region 427 and the second central portion 429R of the P-type doping region 429 has a serpentine configuration along the second azimuthal angular span 428.

A first set of multiple electrical contacts 424 are respectively physically connected to each of the first set of multiple tab-shaped N-type doping regions 427T and each of the first set of multiple tab-shaped P-type doping regions 429T within the first optical coupling region 420. Each electrical contact 424 of the first set of multiple electrical contacts 424 is positioned at an inner edge of the inner silicon region 417 relative to the center 440 of the ring shape of the first optical waveguide 407. The first set of multiple tab-shaped N-type doping regions 427T are electrically connected to a first electrical node by way of corresponding ones of the first set of multiple electrical contacts 424. The first set of multiple tab-shaped P-type doping regions 429T are electrically connected to a second electrical node by way of corresponding ones of the first set of multiple electrical contacts 424. The first electrical node is electrically connected to an anode of a first electrical voltage source, and the second electrical node is electrically connected to a cathode of the first electrical voltage source, such that the first interdigitated PN diode configuration is reverse-biased.

A second set of multiple electrical contacts 426 are respectively physically connected to each of the second set of multiple tab-shaped N-type doping regions 427T and each of the second set of multiple tab-shaped P-type doping regions 429T within the second optical coupling region 470. Each electrical contact 426 of the second set of multiple electrical contacts 426 is positioned at an inner edge of the inner silicon region 417 relative to the center 440 of the ring shape of the first optical waveguide 407. The second set of multiple tab-shaped N-type doping regions 427T are electrically connected to a third electrical node by way of corresponding ones of the second set of multiple electrical contacts 426. The second set of multiple tab-shaped P-type doping regions 429T are electrically connected to a fourth electrical node by way of corresponding ones of the second set of multiple electrical contacts 426. The third electrical node is electrically connected to an anode of a second electrical voltage source, and the fourth electrical node is electrically connected to a cathode of the second electrical voltage source, such that the second interdigitated PN diode configuration is reverse-biased.

A third set of multiple electrical contacts 423 are positioned in a spaced apart configuration along an inner edge of the inner silicon region 417 along the first azimuthal angular span 430 between the first and second interdigitated PN diode configurations. A fourth set of multiple electrical contacts 425 are positioned in a spaced apart configuration along an outer edge of the outer silicon region 419 along the first azimuthal angular span 430 between the first and second interdigitated PN diode configurations. A fifth set of multiple electrical contacts 423 are positioned in a spaced apart configuration along an inner edge of the inner silicon region 417 along the second azimuthal angular span 428 between the first and second interdigitated PN diode configurations. A sixth set of multiple electrical contacts 425 are positioned in a spaced apart configuration along an outer edge of the outer silicon region 419 along the second azimuthal angular span 428 between the first and second interdigitated PN diode configurations. In some embodiments, the third, fourth, fifth, and sixth sets of multiple electrical contacts 423, 425 are electrically connected to optical modulation circuitry.

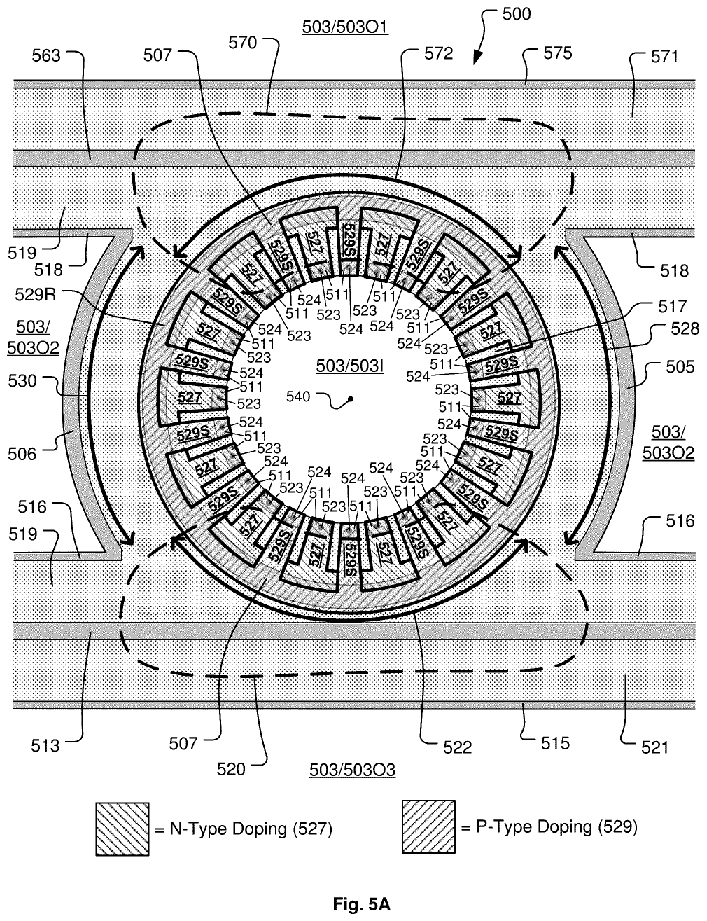

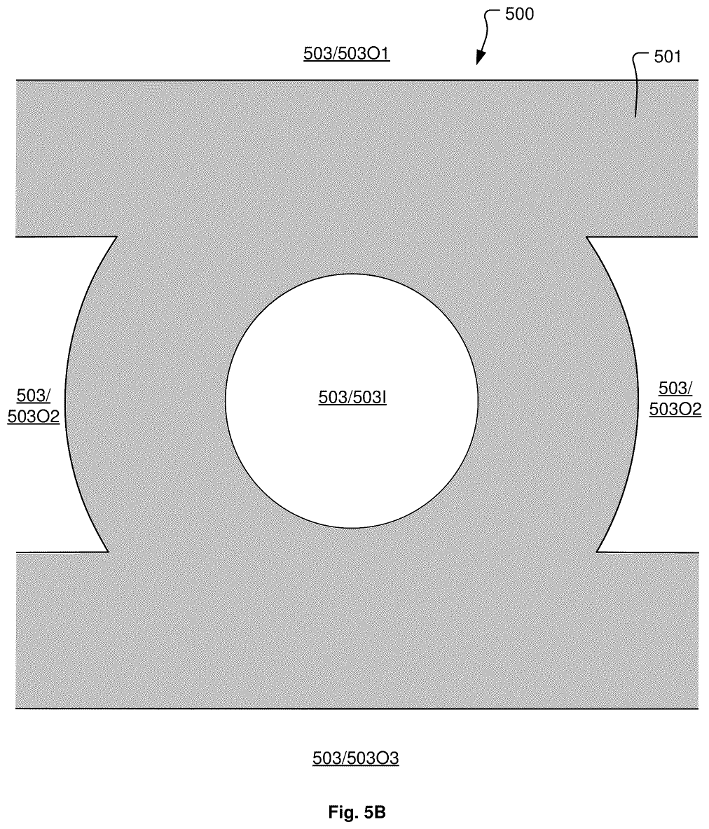

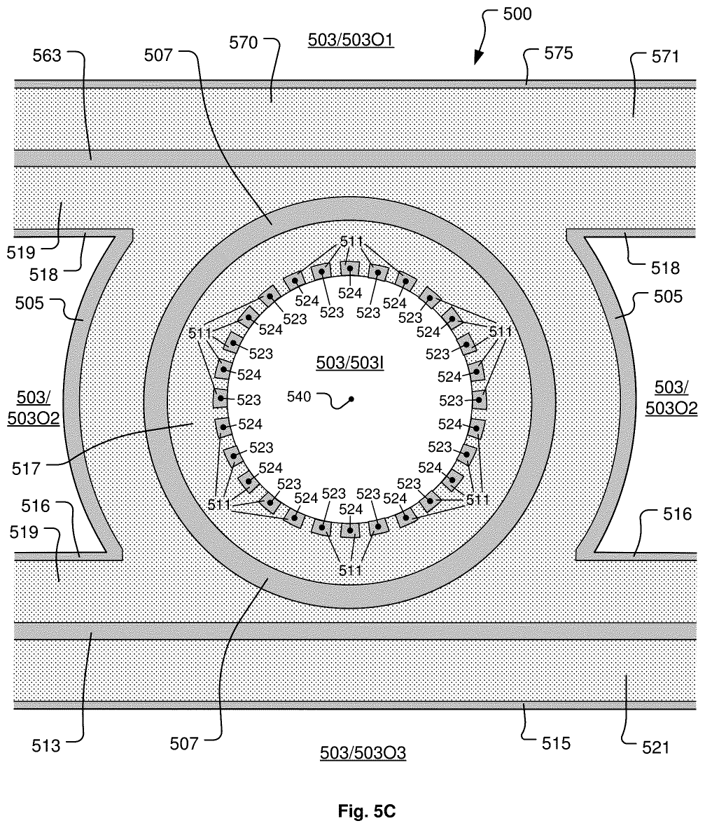

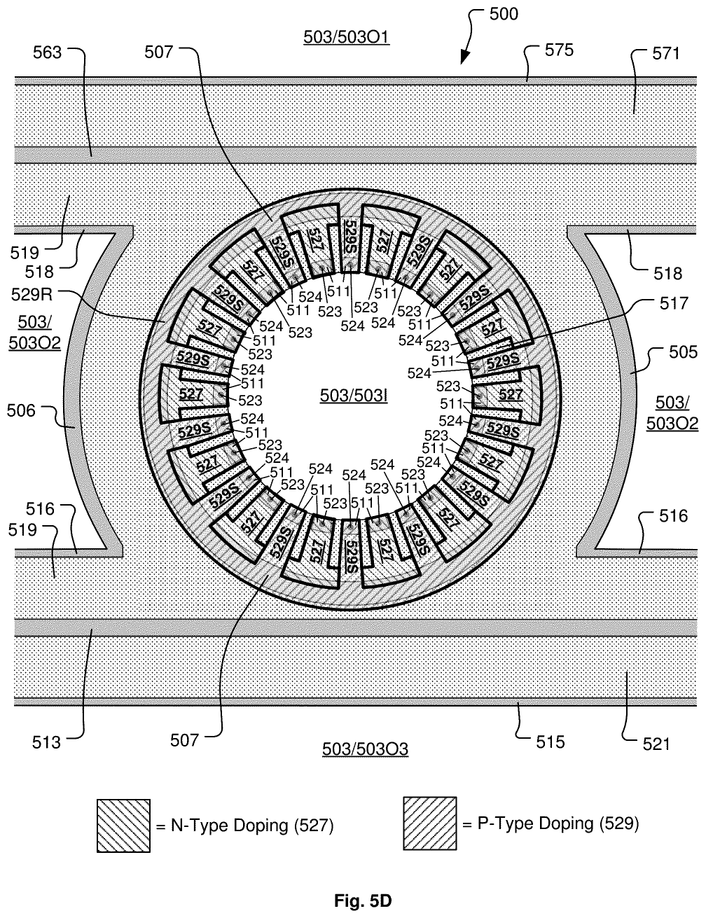

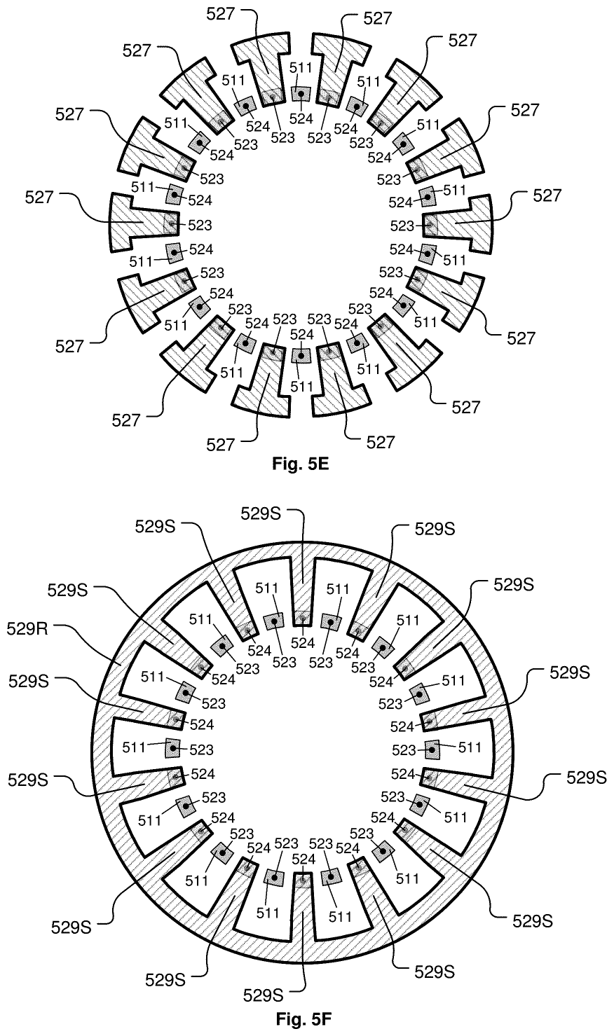

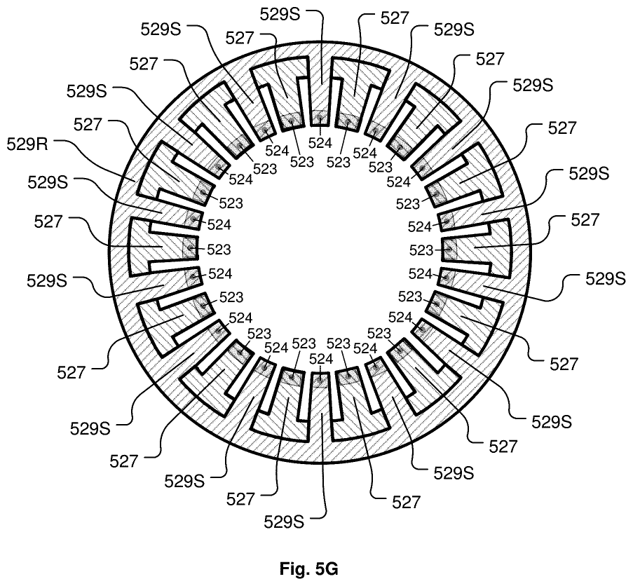

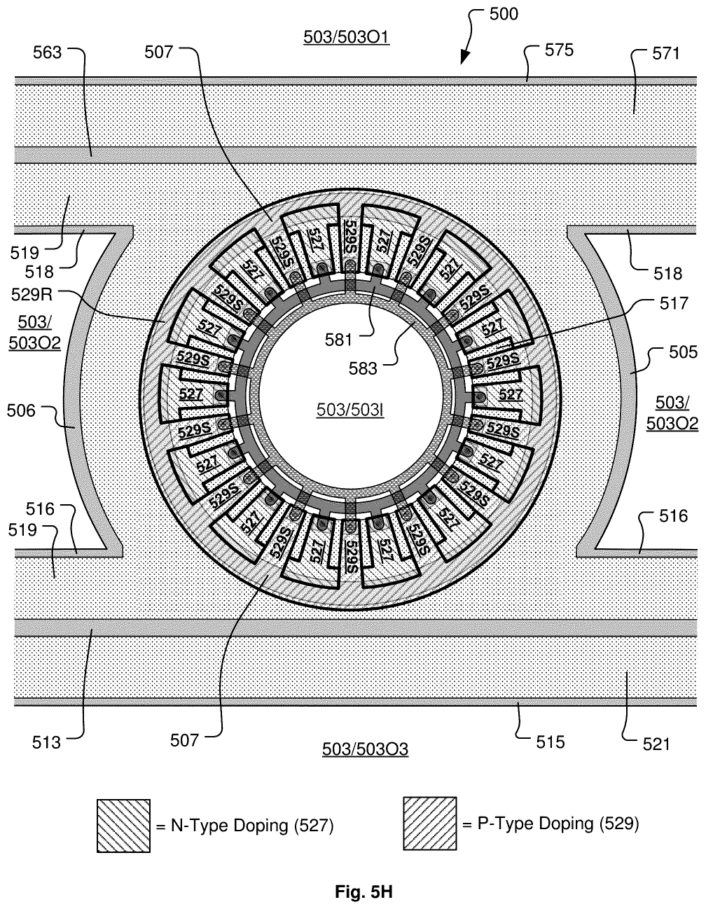

FIG. 5A shows a top view of a ring modulator 500 that implements a circuitous interdigitated diode configuration that extends through both a first optical coupling region 520 and a second optical coupling region 570, in accordance with some embodiments. The circuitous interdigitated diode configuration is formed in part by a P-type doped region 529 that includes a P-type doped outer rim region 529R and multiple P-type doped spoke regions 529S that extend inward from the P-type doped outer rim region 529R toward a center 540 of the ring modulator 500. Adjacently positioned ones of the multiple P-type doped spoke regions 529S are spaced apart from each other in an azimuthal direction about the center 540 of the ring modulator 500. The circuitous interdigitated diode configuration is also formed in part by multiple tab-shaped N-type doping regions 527, each of which is positioned within a space between two adjacently positioned ones of the multiple P-type doped spoke regions 529S. In this manner, the multiple P-type doped spoke regions 529S and the multiple tab-shaped N-type doping regions 527 are alternately positioned with respect to each other in the azimuthal direction about the center 540 of the ring modulator 500.

The first optical coupling region 520 is between a rib ring 507 of the ring modulator 500 and an optical waveguide 513. The rib ring 507 is a ring-shaped optical waveguide. The center 540 of the ring modulator 500 is also the center 540 of the ring shape of the rib ring 507. The second optical coupling region 570 is between the rib ring 507 of the ring modulator 500 and an optical waveguide 563. The rib ring 507 is formed as a rib optical waveguide that loops back into itself. A portion of the rib ring 507 extends through the optical coupling region 520. Another portion of the rib ring 507 extends through the optical coupling region 570. The ring modulator 500 is configured to optimize modulation efficiency while minimizing optical loss in each of the optical waveguide 513 and the optical waveguide 563. The ring modulator 500 is positioned so that the rib ring 507 is located within an evanescent optical coupling distance from the optical waveguide 513. The ring modulator 500 is also positioned so that the rib ring 507 is located within an evanescent optical coupling distance from the optical waveguide 563. In some embodiments, the ring modulator 500, the optical waveguide 513, and the optical waveguide 563 configuration of FIG. 5A is implemented within a PIC.

The rib ring 507 and each of the optical waveguide 513 and the optical waveguide 563 are formed as respective full-height (full-thickness) silicon regions. The rib ring 507 is surrounded by a partial-height (partial-thickness) silicon region 519. More specifically, the partial-height silicon region 519 extends around an outside wall of the rib ring 507. The rib ring 507 itself surrounds a partial-height (partial-thickness) silicon region 517. More specifically, the partial-height silicon region 517 extends around an inside wall of the rib ring 507. The optical waveguide 513 is bracketed by the partial-height (partial-thickness) silicon region 519 on a side of the optical waveguide 513 that faces toward the ring modulator 500, and is bracketed by a partial-height (partial-thickness) silicon region 521 on a side of the optical waveguide 513 that faces away from the ring modulator 500. The partial-height silicon region 519 also extends between the rib ring 507 and the optical waveguide 513. The optical waveguide 563 is bracketed by the partial-height (partial-thickness) silicon region 519 on a side of the optical waveguide 563 that faces toward the ring modulator 500, and is bracketed by a partial-height (partial-thickness) silicon region 571 on a side of the optical waveguide 563 that faces away from the ring modulator 500. The partial-height silicon region 519 also extends between the rib ring 507 and the optical waveguide 563.

A full-height (full-thickness) silicon region 505 extends along an outer radial periphery of a portion of the partial-height silicon region 519 that extends along an azimuthal angular span 528 about the center 540 of the ring modulator 500 radially outside of the rib ring 507. Also, a full-height (full-thickness) silicon region 506 extends along an outer radial periphery of a portion of the partial-height silicon region 519 that extends along an azimuthal angular span 530 about the center 540 of the ring modulator 500 radially outside of the rib ring 507. A full-height (full-thickness) silicon region 516 extends along the partial-height silicon region 519 on a side of the partial-height silicon region 519 that is located away from the optical waveguide 513. A full-height (full-thickness) silicon region 515 extends along the partial-height silicon region 521 on a side of the partial-height silicon region 521 that is located away from the optical waveguide 513. A full-height (full-thickness) silicon region 518 extends along the partial-height silicon region 519 on a side of the partial-height silicon region 519 that is located away from the optical waveguide 563. A full-height (full-thickness) silicon region 575 extends along the partial-height silicon region 571 on a side of the partial-height silicon region 571 that is located away from the optical waveguide 563. Full-height (full-thickness) silicon regions 511 are formed along an inner side of the partial-height silicon region 517 that is located away from the rib ring 507.

The ring modulator 500 is formed within an optical cladding material 503 that includes an inner optical cladding material 5031, a first outer optical cladding material 50301, a second outer optical cladding material 50302, and a third outer optical cladding material 50303. More specifically, in some embodiments, the inner optical cladding material 5031 is circumscribed by a combination of the full-height (full-thickness) silicon regions 511 and the partial-height silicon region 517. The first outer optical cladding material 50301 is present along a side of the full-height (full-thickness) silicon region 575 that is located away from the ring modulator 500. The second outer optical cladding material 50302 is present outside of the ring modulator 500 and between the full-height (full-thickness) silicon regions 516 and 518. The third outer optical cladding material 50303 is present along a side of the full-height (full-thickness) silicon region 515 that is located away from the ring modulator 500.

A number of inner electrical contacts 523 (shown as black dots) are formed in electrical connection with the full-height (full-thickness) silicon regions 511 over which the multiple tab-shaped N-type doping regions 527 are formed. A number of inner electrical contacts 524 (shown as black dots) are formed in electrical connection with the full-height (full-thickness) silicon regions 511 over which the multiple P-type doped spoke regions 529S are formed. The P-type doped outer rim region 529R includes a portion of the rib ring 507. Each of the multiple P-type doped spoke regions 529S includes a respective portion of the rib ring 507, a respective portion of the partial-height silicon region 517, and a respective one of the full-height (full-thickness) silicon regions 511. Each of the multiple tab-shaped N-type doping regions 527 includes a respective portion of the rib ring 507, a respective portion of the partial-height silicon region 517, and a respective one of the full-height (full-thickness) silicon regions 511. The tab-shaped N-type doping regions 527 and the P-type doped spoke regions 529S alternate in placement with respect to each other along the curvature of the rib ring 507 about the center 540 of the ring modulator 500. In this manner, the tab-shaped N-type doping regions 527, the P-type doped outer rim region 529R, and the multiple P-type doped spoke regions 529S collectively form the circuitous interdigitated diode configuration within the ring modulator 500 that extends through the optical coupling regions 520 and 570. In some embodiments, adjacently positioned ones of the tab-shaped N-type doping regions 527 and the P-type doped spoke regions 529S are separated from each other by a non-doped portion of the partial-height silicon region 517.

The N-type doping region 527 and the P-type doping region 529 interface with each other within the rib ring 507 to form a PN junction diode within the rib ring 507 that extends through both of the optical coupling regions 520 and 570. The tab-shaped N-type doping regions 527 provide respective electrically conductive pathways from the PN junction diode within the rib ring 507 to respective ones of the inner electrical contacts 523. The tab-shaped N-type doping regions 527 are collectively electrically connected through the inner electrical contacts 523 to a first node of an electrical circuit. The P-type doped spoke regions 529S provide respective electrically conductive pathways from the PN junction diode within the rib ring 507 to respective ones of the inner electrical contacts 524. The P-type doped outer rim region 529R and the P-type doped spoke regions 529S are collectively electrically connected through the inner electrical contacts 524 to a second node of an electrical circuit. In the ring modulator 500, the PN junction diode formed within the rib ring 507 extends through the optical coupling region 520 as indicated by arrow 522. Also, the PN junction diode formed within the rib ring 507 extends from the optical coupling region 520 to the optical coupling region 570 as indicated by arrow 528. Also, the PN junction diode formed within the rib ring 507 extends through the optical coupling region 570 as indicated by arrow 572. Also, the PN junction diode formed within the rib ring 507 extends from the optical coupling region 570 to the optical coupling region 520 as indicated by arrow 530.

FIGS. 5B through 5H show various states of fabrication to arrive at the example ring modulator 500 of FIG. 5A, in accordance with some embodiments. FIG. 5B shows a top view of a configuration of full-height (full-thickness) silicon 501 formed within the cladding material 503, in accordance with some embodiments. A portion of the configuration of full-height (full-thickness) silicon 501 is used to form the ring modulator 500. Another portion of the configuration of full-height (full-thickness) silicon 501 is used to form the optical waveguides 513 and 563 that extend past the ring modulator 500.

FIG. 5C shows a top view of the configuration of full-height (full-thickness) silicon 501 with portions of the full-height (full-thickness) silicon 501 etched away to form the partial-height (partial-thickness) silicon regions 517, 519, 521, and 571, in accordance with some embodiments. The thickness of the partial-height (partial-thickness) silicon regions 517, 519, 521, and 571 is less than the thickness of the full-height (full-thickness) silicon 501. The partial-height (partial-thickness) silicon regions 517, 519, 521, and 571 are configured and positioned such that a first remaining portion of the full-height (full-thickness) silicon 501 forms the rib ring 507, and such that a second remaining portion of the full-height (full-thickness) silicon 501 forms the outer silicon regions 505 and 506, and such that a third remaining portion of the full-height (full-thickness) silicon 501 forms the inner silicon regions 511, and such that a fourth remaining portion of the full-height (full-thickness) silicon 501 forms the optical waveguide 513, and such that a fifth remaining portion of the full-height (full-thickness) silicon 501 forms the full-height (full-thickness) silicon region 516, and such that a sixth remaining portion of the full-height (full-thickness) silicon 501 forms the full-height (full-thickness) silicon region 515, and such that a seventh remaining portion of the full-height (full-thickness) silicon 501 forms the optical waveguide 563, and such that a eighth remaining portion of the full-height (full-thickness) silicon 501 forms the full-height (full-thickness) silicon region 518, and such that a ninth remaining portion of the full-height (full-thickness) silicon 501 forms the full-height (full-thickness) silicon region 575. FIG. 5C also shows formation of the inner electrical contacts 523 and 524 in electrical connection with the full-height (full-thickness) silicon regions 511 positioned along the inner radius of the ring modulator 500. In some embodiments, the inner electrical contacts 523 and 524 are substantially uniformly azimuthally spaced about the center 540 of the ring modulator 500.

FIG. 5D shows a top view of the partially formed ring modulator 500 of FIG. 5C having the N-type doping region 527 and the P-type doping region 529 formed thereon, in accordance with some embodiments. The N-type doping regions 527 are electrically connected to respective ones of the inner electrical contacts 523 by way of respective ones of the inner full-height (full-thickness) silicon regions 511. The P-type doped spoke regions 529S are electrically connected to respective ones of the inner electrical contacts 524 by way of respective ones of the inner full-height (full-thickness) silicon regions 511.

FIG. 5E shows an isolated top view of the N-type doping regions 527, in accordance with some embodiments. FIG. 5F shows an isolated top view of the P-type doping region 529, including the P-type doped outer rim region 529R and multiple P-type doped spoke regions 529S, in accordance with some embodiments. The P-type doped outer rim region 529R and the multiple P-type doped spoke regions 529S are integrally formed with each other, so as to be electrically connected to each other. FIG. 5G shows an isolated view of the N-type doping regions 527 and the P-type doping region 529 positioned relative to each other as in the ring modulator 500, in accordance with some embodiments.

FIG. 5H shows the top view of the ring modulator 500 of FIG. 5D with the N-type doping regions 527 electrically connected to a first electrical node by way of an electrical conductor 581, in accordance with some embodiments. The electrical conductor 581 is electrically connected to the inner electrical contacts 523 that are electrically connected to one of N-type doping regions 527. FIG. 5H also shows the P-type doping region 529 electrically connected to a second electrical node by way of an electrical conductor 583 by way of the P-type doped spoke regions 529S and corresponding inner electrical contacts 524.

Each of the P-type doping region 529 and the N-type doping regions 527 is doped with impurity ions to form the lateral PN junction diode within the rib ring 507. In some embodiments, the P-type doping region 529 is doped with acceptor impurity atoms, and the N-type doping regions 527 are doped with donor impurity atoms. In this manner, the N-type doping regions 527 and the P-type doping region 529 are doped with opposite polarity. The interface between the N-type doping regions 527 and the P-type doping region 529 within the rib ring 507 is the PN junction of the lateral PN junction diode. At the PN junction within the rib ring 507, the free electrons diffuse into the P-type doping region 529, and the holes (electron vacancies) diffuse into the N-type doping regions 527, which causes a depletion region to form along the PN junction within the rib ring 507. It should be appreciated that in the ring modulator 500, the PN junction diode formed by the P-type doping region 529 and the N-type doping regions 527 extends through both the optical coupling region 520 and the optical coupling region 570. Within each of the optical coupling regions 520 and 570, the N-type doping regions 527 formed within the partial-height (partial-thickness) silicon region 517 provide respective electrically conductive paths between the inner electrical contacts 523 and the depletion region formed along the PN junction within the rib ring 507. Also, within each of the optical coupling regions 520 and 570, the P-type doped spoke regions 529S formed within the partial-height (partial-thickness) silicon region 517 provide respective electrically conductive paths between the inner electrical contacts 524 and the depletion region formed along the PN junction within the rib ring 507. Also, along the rib ring 507 between the optical coupling regions 520 and 570, the N-type doping regions 527 formed within the partial-height (partial-thickness) silicon region 517 provide electrically conductive paths between the inner electrical contacts 523 and the depletion region formed along the PN junction within the rib ring 507. Also, along the rib ring 507 between of the optical coupling regions 520 and 570, the P-type doped spoke regions 529S formed within the partial-height (partial-thickness) silicon region 517 provide electrically conductive paths between the inner electrical contacts 524 and the depletion region formed along the PN junction within the rib ring 507.

In some embodiments, with the lateral PN junction diode within the rib ring 507 electrically connected in a reverse-biased manner to an electrical voltage source, the inner electrical contacts 523 of the N-type doping regions 527 are electrically connected to the anode of the electrical voltage source by way of the electrical conductor 581. Also, in some embodiments, with the lateral PN junction diode within the rib ring 507 electrically connected in a reverse-biased manner to the electrical voltage source, the inner electrical contacts 524 of the P-type doping region 529 are electrically connected to the cathode of the electrical voltage source. The inner electrical contacts 523 and 524 are positioned far enough from the rib ring 507 to reduce optical absorption of the light traveling through the rib ring 507 by metal and silicided regions that form the inner electrical contacts 523 and 524.

In the ring modulator 500, the lateral PN junction diode extends into the optical coupling region 520 of the ring modulator 500 without adversely affecting optical absorption loss in the optical waveguide 513 to which the ring modulator 500 is optically coupled. Also, positioning of the N-type doping regions 527 and the P-type doped spoke regions 529S on the inside of the rib ring 507 so as to extend toward the center 540 of ring modulator 500 enables the lateral PN junction diode to extend through the optical coupling region 520 of the ring modulator 500 without adversely affecting optical absorption loss in the optical waveguide 513 to which the ring modulator 500 is optically coupled. Additionally, by having the N-type doping regions 527 and the P-type doped spoke regions 529S alternatively positioned along the arc of the rib ring 507 within the optical coupling region 520, the electrical series resistance in the lateral PN junction diode of the ring modulator 500 is not adversely increased by having the lateral PN junction diode extend through the optical coupling region 520.

In the ring modulator 500, the lateral PN junction diode extends into the optical coupling region 570 of the ring modulator 500 without adversely affecting optical absorption loss in the optical waveguide 563 to which the ring modulator 500 is optically coupled. Also, positioning of the N-type doping regions 527 and the P-type doped spoke regions 529S on the inside of the rib ring 507 so as to extend toward the center 540 of ring modulator 500 enables the lateral PN junction diode to extend through the optical coupling region 570 of the ring modulator 500 without adversely affecting optical absorption loss in the optical waveguide 563 to which the ring modulator 500 is optically coupled. Additionally, by having the N-type doping regions 527 and P-type doped spoke regions 529S alternatively positioned along the arc of the rib ring 507 within the optical coupling region 570, the electrical series resistance in the lateral PN junction diode of the ring modulator 500 is not adversely increased by having the lateral PN junction diode extend through the optical coupling region 570.

The ring modulator 500 uses the circuitous interdigitated PN junction diode design (interdigitation of the N-type doping regions 527 and P-type doped spoke regions 529S) around the entirety of the rib ring 507, including through portions of the rib ring 507 that pass through each of the optical coupling regions 520 and 570. Within the optical coupling region 520, the inner electrical contacts 523 and 524 are positioned along the inner region of the ring modulator 500, far from the rib ring 507 and even farther from the optical waveguide 513, so as to avoid optical absorption loss in the coupling optical waveguides 507 and 513. Similarly, within the optical coupling region 570, the inner electrical contacts 523 and 524 are positioned along the inner region of the ring modulator 500, far from the rib ring 507 and even farther from the optical waveguide 563, so as to avoid optical absorption loss in the coupling optical waveguides 507 and 563. The circuitous interdigitated N-type doping regions 527 and the P-type doped spoke regions 529S alternate polarity (alternate cathode and anode) around the rib ring 507, including through each of the optical coupling regions 520 and 570.

In various embodiments, electrically conductive structures, e.g., metal traces/wires, and electrically conductive via structures are formed in and/or through different levels of the semiconductor device in which the ring modulator 500 is formed in order to electrically connect all of the inner electrical contacts 523 that are electrically connected to the N-type doping regions 527 to the same first electrical node, such as exemplified by the electrical conductor 581. In various embodiments, electrically conductive structures, e.g., metal traces/wires, and electrically conductive via structures are formed in and/or through different levels of the semiconductor device in which the ring modulator 500 is formed in order to electrically connect all of the inner electrical contacts 524 that are electrically connected to the P-type doping region 529 to the same second electrical node, such as exemplified by the electrical conductor 583.

In accordance with the foregoing, the ring resonator 500 includes a built-in diode for modulating an optical signal propagating through the optical waveguide 513 and/or the optical waveguide 563. The optical mode supported by the ring resonator 500 has significant power density that overlaps the depletion region of the PN junction diode within the rib ring 507. By changing the voltage differential between the anode and cathode of the PN junction diode within the rib ring 507, charge carriers can be added to or removed from the depletion region of the PN junction within the rib ring 507 in a controlled manner, which provides for changing of the refractive index and optical absorption coefficient of the rib ring 507 in a controlled manner by way of the plasma effect, which in turn provides for changing of the amplitude and phase of the light that is transmitted on through the optical waveguide 513 and/or the optical waveguide 563 past the ring modulator 500 in a controlled manner. In some embodiments, the PN junction diode within the rib ring 507 of the ring modulator 500 is operated in a reversed bias manner to enable fast charge transport and correspondingly high optical modulation data rates.

In some embodiments, the optical waveguide 513 and/or the optical waveguide 563 carries multiple wavelength channels of light, where only one of the multiple wavelength channels of light is coupled into and modulated by the ring resonator 500 in a controlled and selectable manner. In some embodiments, such as in WDM systems, multiple instances of the ring resonator 500 are optically coupled to the same optical waveguide 513 and/or the optical waveguide 563, with each of the ring resonators 500 tuned to modulate a different one of the multiple wavelength channels of light propagating through the optical waveguide 513 and/or the optical waveguide 563. The metal of the inner electrical contacts 523 and 524 absorbs light across all wavelengths. Therefore, by having the inner electrical contacts 523 and 524 positioned away from the optical waveguides 513 and 563, e.g., by a distance greater than or equal to about one micrometer, within each instance of the ring modulator 500, it is possible to avoid introduction and accumulation of excess absorption loss of the light propagating through the optical waveguides 513 and 563, across every wavelength channel of light. Also, by having the contacts 523 and 524 positioned on the inner radius of the ring modulator 500, the area along the outer radius of the ring modulator 500 is available for positioning of one or more heating device(s), e.g., resistive heating device(s), to provide for thermal resonance wavelength tuning of the ring resonator 500. In some embodiments, doped or silicided silicon is used to form one or more resistive heating device(s) along the outer radius of the ring modulator 500, such as along the full-height (full-thickness) silicon regions 505 and 506.

FIGS. 5A through 5H show a portion of a photonic integrated circuit. The photonic integrated circuit includes a first optical waveguide 507 that has a ring shape. The first optical waveguide 507 is formed of silicon and has a first vertical height. The photonic integrated circuit also includes an inner silicon region 517 formed circumferentially along an inner side of the first optical waveguide 507. The inner silicon region 517 has a second vertical height that is less than the first vertical height of the first optical waveguide 507. The photonic integrated circuit also includes a second optical waveguide 513 configured to semi-tangentially approach an outer side of the first optical waveguide 507 and extend past the first optical waveguide 507 at a first location (of closest approach), such that a first optical coupling region 520 exists between a portion of the second optical waveguide 513 and a first portion of the first optical waveguide 507 about the first location (of closest approach). The photonic integrated circuit also includes a third optical waveguide 563 configured to semi-tangentially approach the outer side of the first optical waveguide 507 and extend past the first optical waveguide 507 at a second location (of closest approach) that is diametrically opposed to the first location (of closest approach) with regard to the ring shape of the first optical waveguide 507, such that a second optical coupling region 570 exists between a portion of the third optical waveguide 563 and a second portion of the first optical waveguide 507 about the second location (of closest approach).

The photonic integrated circuit also includes an N-type doping region 527 formed within the first optical waveguide 507 and the inner silicon region 517. The N-type doping region 527 includes multiple tab-shaped N-type doping regions 527 formed within the first optical waveguide 507 and the inner silicon region 517. The multiple tab-shaped N-type doping regions 527 are positioned in a spaced apart manner along a full circumferential path of the ring shape of the first optical waveguide 507. Each of the multiple tab-shaped N-type doping regions 527 is formed to project inward toward a center 540 of the ring shape of the first optical waveguide 507.

The photonic integrated circuit also includes a P-type doping region 529 formed within the first optical waveguide 507 and the inner silicon region 517. The P-type doping region 529 includes multiple tab-shaped P-type doping regions 529S formed within the first optical waveguide 507 and the inner silicon region 517. Each of the multiple tab-shaped P-type doping regions 529S is positioned between a different pair of the multiple tab-shaped N-type doping regions 527 along the full circumferential path of the ring shape of the first optical waveguide 507. Each of the multiple tab-shaped P-type doping regions 529S is formed to project inward toward the center 540 of the ring shape of the first optical waveguide 507. The multiple tab-shaped N-type doping regions 527 and the multiple tab-shaped P-type doping regions 529S collectively form an interdigitated PN diode configuration within the first optical waveguide 507 along the full circumferential path of the ring shape of the first optical waveguide 507. A first portion of the interdigitated PN diode configuration is positioned within the first optical coupling region 520. A second portion of the interdigitated PN diode configuration is positioned within the second optical coupling region 570. A third portion of the interdigitated PN diode configuration is positioned between the first optical coupling region 520 and the second optical coupling region 570 on a first side of the center 540 of the ring shape of the first optical waveguide 507. A fourth portion of the interdigitated PN diode configuration is positioned between the first optical coupling region 520 and the second optical coupling region 570 on a second side of the center 540 of the ring shape of the first optical waveguide 507.

The P-type doping region 529 includes a connecting portion 529R that is contiguously formed along the full circumferential path of the ring shape of the first optical waveguide 507. The connection portion 529R of the P-type doping region 529 is contiguously formed with each of the multiple tab-shaped P-type doping regions 529S. Adjacently positioned ones of the multiple tab-shaped N-type doping regions 527 and the multiple tab-shaped P-type doping regions 529S are physically separated from each other. Each of the multiple tab-shaped N-type doping regions 527 is in physical contact with the connecting portion 529R of the P-type doping region 529 within the first optical waveguide 507. The connecting portion 529R of the P-type doping region 529 extends along an outer side of each of the multiple tab-shaped N-type doping regions 527.

The photonic integrated circuit also includes multiple inner electrical contacts 523 respectively physically connected to each of the multiple tab-shaped N-type doping regions 527. The photonic integrated circuit also includes multiple inner electrical contacts 524 respectively physically connected to each of the multiple tab-shaped P-type doping regions 529S. Each of the multiple inner electrical contacts 523 and 524 is positioned at an inner edge of the inner silicon region 517 relative to the center 540 of the ring shape of the first optical waveguide 507. In some embodiments, the multiple tab-shaped N-type doping regions 527 are electrically connected to a first electrical node by way of corresponding ones of the multiple inner electrical contacts 523. Also, the multiple tab-shaped P-type doping regions 529S are electrically connected to a second electrical node by way of corresponding ones of the multiple inner electrical contacts 524. The second electrical node is electrically separated from the first electrical node. In some embodiments, the first electrical node is electrically connected to an anode of an electrical voltage source, and the second electrical node is electrically connected to a cathode of the electrical voltage source, such that the interdigitated PN diode configuration is reverse-biased.

The photonic integrated circuit also includes an outer silicon region 519 formed circumferentially along the outer side of the first optical waveguide 507. The outer silicon region 519 is not doped. The outer silicon region 519 is formed between the first optical waveguide 507 and the second optical waveguide 513. The outer silicon region 519 is also formed between the first optical waveguide 507 and the third optical waveguide 563. The outer silicon region 519 has a third vertical height that is less than the first vertical height of the first optical waveguide 507. In some embodiments, the third vertical height of the outer silicon region 519 is substantially equal to the second vertical height of the inner silicon region 517. In some embodiments, a vertical height of the second optical waveguide 513 is substantially equal to the first vertical height of the first optical waveguide 507.

In some embodiments, the first optical waveguide 507, the second optical waveguide 513, the third optical waveguide 563, the outer silicon region 519, and the inner silicon region 517 are respective parts of a contiguous silicon structure. In some embodiments, the contiguous silicon structure has a planar bottom surface that forms a respective bottom surface of each of the first optical waveguide 507, the second optical waveguide 513, the third optical waveguide 563, the outer silicon region 519, and the inner silicon region 517. In some embodiments, the outer silicon region 519 and the inner silicon region 517 are etched regions of the contiguous silicon structure.

In some embodiments, each of the multiple tab-shaped N-type doping regions 527 is substantially T-shaped, and wherein each of the multiple tab-shaped P-type doping regions 529S is substantially linear-shaped. In some embodiments, the multiple tab-shaped N-type doping regions 527 are substantially uniformly azimuthally spaced about the center 540 of the ring shape of the first optical waveguide 507, and the multiple tab-shaped P-type doping regions 529S are substantially uniformly azimuthally spaced about the center 540 of the ring shape of the first optical waveguide 507.

Various configurations of ring modulators are disclosed herein that include a rib ring optical waveguide and an interdigitated PN junction diode design that extend through an optical coupling region between the rib ring optical waveguides and a proximally positioned bus optical waveguide. The implementation of the interdigitated PN junction diode design in conjunction with the rib ring optical waveguide provides for optimization of the modulation efficiency of the ring modulator while minimizing loss in the rib ring optical waveguide and the bus optical waveguide that is coupled to the ring modulator. The interdigitated PN junction diode design has electrical contacts of alternating polarity along the inner ring radius of the ring modulator in those parts of the ring modulator that are within and/or near the optical coupling region between the ring modulator and the bus optical waveguide, which avoids placement of metal contacts and associated wiring of the ring modulator in positions that would contribute to excess optical absorption loss of light propagating through the bus optical waveguide that is optically coupled to the ring modulator. The various ring modulator embodiments disclosed herein provide for high modulation efficiency, which is particularly beneficial in systems that use wavelength division multiplexing (WDM), especially where multiple ring modulators are coupled to the same bus optical waveguide to enable optical data communication on multiple optical wavelength channels in a simultaneous manner.

The foregoing description of the embodiments has been provided for purposes of illustration and description, and is not intended to be exhaustive or limiting. Individual elements or features of a particular embodiment are generally not limited to that particular embodiment, but, where applicable, are interchangeable and can be used in a selected embodiment, even if not specifically shown or described. In this manner, one or more features from one or more embodiments disclosed herein can be combined with one or more features from one or more other embodiments disclosed herein to form another embodiment that is not explicitly disclosed herein, but rather that is implicitly disclosed herein. This other embodiment may also be varied in many ways. Such embodiment variations are not to be regarded as a departure from the disclosure herein, and all such embodiment variations and modifications are intended to be included within the scope of the disclosure provided herein.

Although some method operations may be described in a specific order herein, it should be understood that other operations may be performed in between method operations, and/or method operations may be adjusted so that they occur at slightly different times or simultaneously, or may be distributed in a system which allows the occurrence of the processing operations at various intervals associated with the processing, as long as the processing of the method operations are performed in a manner that provides for successful implementation of the method.

Although the foregoing embodiments have been described in some detail for purposes of clarity of understanding, it will be apparent that certain changes and modifications can be practiced within the scope of the appended claims. Accordingly, the embodiments disclosed herein are to be considered as illustrative and not restrictive, and are therefore not to be limited to just the details given herein, but may be modified within the scope and equivalents of the appended claims.

What is claimed is:

1. A photonic integrated circuit, comprising:
a first optical waveguide having a ring shape, the first optical waveguide formed of silicon and having a first vertical height;
an inner silicon region formed circumferentially along an inner side of the first optical waveguide, the inner silicon region having a second vertical height that is less than the first vertical height;
a second optical waveguide configured to semi-tangentially approach an outer side of the first optical waveguide and extend past the first optical waveguide at a first location, such that a first optical coupling region exists between a portion of the second optical waveguide and a first portion of the first optical waveguide about the first location;
a third optical waveguide configured to semi-tangentially approach the outer side of the first optical waveguide and extend past the first optical waveguide at a second location that is diametrically opposed to the first location with regard to the ring shape of the first optical waveguide, such that a second optical coupling region exists between a portion of the third optical waveguide and a second portion of the first optical waveguide about the second location;
an N-type doping region formed within the first optical waveguide and the inner silicon region, the N-type doping region including a first set of multiple tab-shaped N-type doping regions formed within the first optical coupling region, the N-type doping region including a second set of multiple tab-shaped N-type doping regions formed within the second optical coupling region, each of the tab-shaped N-type doping regions in the first and second sets of multiple tab-shaped N-type doping regions formed to project inward toward a center of the ring shape of the first optical waveguide; and
a P-type doping region formed within the first optical waveguide and the inner silicon region, the P-type doping region including a first set of multiple tab-shaped P-type doping regions formed within the first optical coupling region, the P-type doping region including a second set of multiple tab-shaped P-type doping regions formed within the second optical coupling region, each of the tab-shaped P-type doping regions in the first and second sets of multiple tab-shaped P-type doping regions formed to project inward toward the center of the ring shape of the first optical waveguide,
wherein positions of the first set of multiple tab-shaped N-type doping regions alternate with positions of the first set of multiple tab-shaped P-type doping regions along the first portion of the first optical waveguide, such that the first set of multiple tab-shaped N-type doping regions and the first set of multiple tab-shaped P-type doping regions collectively form a first interdigitated PN diode configuration within the first optical waveguide within the first optical coupling region,
wherein positions of the second set of multiple tab-shaped N-type doping regions alternate with positions of the second set of multiple tab-shaped P-type doping regions along the second portion of the first optical waveguide, such that the second set of multiple tab-shaped N-type doping regions and the second set of multiple tab-shaped P-type doping regions collectively form a second interdigitated PN diode configuration within the first optical waveguide within the second optical coupling region.

2. The photonic integrated circuit as recited in claim 1, wherein the N-type doping region includes a first connecting portion that is formed within the first optical waveguide through the first optical coupling region and that is contiguously formed with each of the first set of multiple tab-shaped N-type doping regions,
wherein the P-type doping region includes a first connecting portion that is formed within the first optical waveguide through the first optical coupling region and that is contiguously formed with each of the first set of multiple tab-shaped P-type doping regions,
wherein the N-type doping region includes a second connecting portion that is formed within the first optical waveguide through the second optical coupling region and that is contiguously formed with each of the second set of multiple tab-shaped N-type doping regions, and
wherein the P-type doping region includes a second connecting portion that is formed within the first optical waveguide through the second optical coupling region and that is contiguously formed with each of the second set of multiple tab-shaped P-type doping regions.

3. The photonic integrated circuit as recited in claim 2, wherein adjacently positioned ones of the first set of multiple tab-shaped N-type doping regions and the first set of multiple tab-shaped P-type doping regions are physically separated from each other, and wherein adjacently positioned ones of the second set of multiple tab-shaped N-type doping regions and the second set of multiple tab-shaped P-type doping regions are physically separated from each other.

4. The photonic integrated circuit as recited in claim 3, wherein the first connecting portion of the N-type doping region is in physical contact with the first connecting portion of the P-type doping region within the first optical waveguide, and wherein the second connecting portion of the N-type doping region is in physical contact with the second connecting portion of the P-type doping region within the first optical waveguide.

5. The photonic integrated circuit as recited in claim 4, wherein the first connecting portion of the P-type doping region extends below the first connecting portion of the N-type doping region, and wherein the second connecting portion of the P-type doping region extends below the second connecting portion of the N-type doping region.

6. The photonic integrated circuit as recited in claim 5, wherein the first connecting portion of the N-type doping region is circumscribed by an annular segment of the first connecting portion of the P-type doping region, and wherein the second connecting portion of the N-type doping region is circumscribed by an annular segment of the second connecting portion of the P-type doping region.

7. The photonic integrated circuit as recited in claim 4, further comprising:
a first set of multiple inner electrical contacts respectively physically connected to each of the first set of multiple tab-shaped N-type doping regions and each of the first set of multiple tab-shaped P-type doping regions; and
a second set of multiple inner electrical contacts respectively physically connected to each of the second set of multiple tab-shaped N-type doping regions and each of the second set of multiple tab-shaped P-type doping regions.

8. The photonic integrated circuit as recited in claim 7, wherein each of the first set of multiple inner electrical contacts and each of the second set of multiple inner electrical contacts is positioned at an inner edge of the inner silicon region relative to the center of the ring shape of the first optical waveguide.

9. The photonic integrated circuit as recited in claim 7, wherein the first set of multiple tab-shaped N-type doping regions are electrically connected to a first electrical node by way of corresponding ones of the first set of multiple inner electrical contacts, wherein the first set of multiple tab-shaped P-type doping regions are electrically connected to a second electrical node by way of corresponding ones of the first set of multiple inner electrical contacts, the second electrical node electrically separated from the first electrical node, and
wherein the second set of multiple tab-shaped N-type doping regions are electrically connected to a third electrical node by way of corresponding ones of the second set of multiple inner electrical contacts, wherein the second set of multiple tab-shaped P-type doping regions are electrically connected to a fourth electrical node by way of corresponding ones of the second set of multiple inner electrical contacts, the fourth electrical node electrically separated from the third electrical node.

10. The photonic integrated circuit as recited in claim 9, wherein the first electrical node is electrically connected to an anode of a first electrical voltage source, and wherein the second electrical node is electrically connected to a cathode of the first electrical voltage source, such that the first interdigitated PN diode configuration is reverse-biased, and
wherein the third electrical node is electrically connected to an anode of a second electrical voltage source, and wherein the fourth electrical node is electrically connected to a cathode of the second electrical voltage source, such that the second interdigitated PN diode configuration is reverse-biased.

11. The photonic integrated circuit as recited in claim 4, further comprising:
an outer silicon region formed circumferentially along the outer side of the first optical waveguide, the outer silicon region formed between the first optical waveguide and the second optical waveguide, the outer silicon region also formed between the first optical waveguide and the third optical waveguide, the outer silicon region having a third vertical height that is less than the first vertical height.

12. The photonic integrated circuit as recited in claim 11, wherein the third vertical height is substantially equal to the second vertical height.

13. The photonic integrated circuit as recited in claim 12, wherein a vertical height of the second optical waveguide is substantially equal to the first vertical height of the first optical waveguide, and wherein a vertical height of the third optical waveguide is substantially equal to the first vertical height of the first optical waveguide.

14. The photonic integrated circuit as recited in claim 11, wherein the outer silicon region is not doped.

15. The photonic integrated circuit as recited in claim 14, wherein the first optical waveguide, the second optical waveguide, the third optical waveguide, the outer silicon region, and the inner silicon region are respective parts of a contiguous silicon structure.

16. The photonic integrated circuit as recited in claim 15, wherein the contiguous silicon structure has a planar bottom surface that forms a respective bottom surface of each of the first optical waveguide, the second optical waveguide, the third optical waveguide, the outer silicon region, and the inner silicon region.

17. The photonic integrated circuit as recited in claim 16, wherein the outer silicon region and the inner silicon region are etched regions of the contiguous silicon structure.

18. The photonic integrated circuit as recited in claim 11, wherein the N-type doping region includes a first central portion that is contiguously formed within the inner silicon region along a first azimuthal angular span about the center of the ring shape of the first optical waveguide between the first and second interdigitated PN diode configurations, and wherein the P-type doping region includes a first central portion that is contiguously formed within the outer silicon region along the first azimuthal angular span,
wherein the N-type doping region includes a second central portion that is contiguously formed within the inner silicon region along a second azimuthal angular span about the center of the ring shape of the first optical waveguide between the first and second interdigitated PN diode configurations, and wherein the P-type doping region includes a second central portion that is contiguously formed within the outer silicon region along the second azimuthal angular span, wherein a location of the second azimuthal angular span is diametrically opposed to a location of the first azimuthal angular span with regard to the ring shape of the first optical waveguide.

19. The photonic integrated circuit as recited in claim 18, wherein the first central portion of the N-type doping region and the first central portion of the P-type doping region interface with each other to form a first continuous PN diode configuration within the first optical waveguide along the first azimuthal angular span, and
wherein the second central portion of the N-type doping region and the second central portion of the P-type doping region interface with each other to form a second continuous PN diode configuration within the first optical waveguide along the second azimuthal angular span.

20. The photonic integrated circuit as recited in claim 19, wherein an interface between the first central portion of the N-type doping region and the first central portion of the P-type doping region has a serpentine configuration along the first azimuthal angular span, and wherein an interface between the second central portion of the N-type doping region and the second central portion of the P-type doping region has a serpentine configuration along the second azimuthal angular span.

21. The photonic integrated circuit as recited in claim 19, further comprising:
a first set of multiple electrical contacts respectively physically connected to each of the first set of multiple tab-shaped N-type doping regions and each of the first set of multiple tab-shaped P-type doping regions, wherein each electrical contact of the first set of multiple electrical contacts is positioned at an inner edge of the inner silicon region relative to the center of the ring shape of the first optical waveguide, wherein the first set of multiple tab-shaped N-type doping regions are electrically connected to a first electrical node by way of corresponding ones of the first set of multiple electrical contacts, wherein the first set of multiple tab-shaped P-type doping regions are electrically connected to a second electrical node by way of corresponding ones of the first set of multiple electrical contacts, wherein the first electrical node is electrically connected to an anode of a first electrical voltage source, and wherein the second electrical node is electrically connected to a cathode of the first electrical voltage source, such that the first interdigitated PN diode configuration is reverse-biased;
a second set of multiple electrical contacts respectively physically connected to each of the second set of multiple tab-shaped N-type doping regions and each of the second set of multiple tab-shaped P-type doping regions, wherein each electrical contact of the second set of multiple electrical contacts is positioned at an inner edge of the inner silicon region relative to the center of the ring shape of the first optical waveguide, wherein the second set of multiple tab-shaped N-type doping regions are electrically connected to a third electrical node by way of corresponding ones of the second set of multiple electrical contacts, wherein the second set of multiple tab-shaped P-type doping regions are electrically connected to a fourth electrical node by way of corresponding ones of the second set of multiple electrical contacts, wherein the third electrical node is electrically connected to an anode of a second electrical voltage source, and wherein the fourth electrical node is electrically connected to a cathode of the second electrical voltage source, such that the second interdigitated PN diode configuration is reverse-biased;
a third set of multiple electrical contacts positioned in a spaced apart configuration along an inner edge of the inner silicon region along the first azimuthal angular span between the first and second interdigitated PN diode configurations;
a fourth set of multiple electrical contacts positioned in a spaced apart configuration along an outer edge of the outer silicon region along the first azimuthal angular span between the first and second interdigitated PN diode configurations;
a fifth set of multiple electrical contacts positioned in a spaced apart configuration along an inner edge of the inner silicon region along the second azimuthal angular span between the first and second interdigitated PN diode configurations; and
a sixth set of multiple electrical contacts positioned in a spaced apart configuration along an outer edge of the outer silicon region along the second azimuthal angular span between the first and second interdigitated PN diode configurations.

22. The photonic integrated circuit as recited in claim 21, wherein the third, fourth, fifth, and sixth sets of multiple electrical contacts are electrically connected to optical modulation circuitry.
